(19) United States
(12) Patent Application Publication
(10) Pub. No.: US 2004/0161064 A1
(43) Pub. Date: Aug. 19, 2004

(54) System and method for processing signals in UWB communications

(76) Inventors: Vernon R. Brethour, Owens Cross Roads, AL (US); Brandon S. Dewberry, Huntsville, AL (US); Michael J. Balducci, Harvest, AL (US); David R. Lakin II, Harvest, AL (US); Michael L. Potter, Huntsville, AL (US)

Correspondence Address: VENABLE, BAETJER, HOWARD AND CIVILETTI, LLP, P.O. BOX 34385, WASHINGTON, DC, 20043-9998, US

(21) Appl. No.: 10/712,269

(22) Filed: Nov. 14, 2003

Related U.S. Application Data
(60) Provisional application No. 60/426,857, filed on Nov. 15, 2002.

(51) Int. Cl. H04L 1/02

(52) U.S. Cl. 375/347

(57) ABSTRACT

A system and method for processing UWB signals is implemented on an integrated circuit. The system and method of the present invention can be applied to a wide variety of communication needs including data communications, radar, locating, positioning and tracking, with each application meeting a corresponding set of rules defined by spectrum, emission, correlation, coding, etc. The system and method of the invention efficiently and flexibly processes signals in a UWB communication system in terms of receiving, transmitting, coding, acquiring, locking, tracking, timing, correlating, controlling, or calibrating such signals.

### PRIORITY APPLICATIONS

This application claims priority to U.S. Provisional Application No.60/426,857, titled “METHOD AND APPARATUS FOR ULTRA WIDEBAND SIGNALING AND MODULATION,” filed Nov. 15, 2002 which is incorporated herein by reference.

### RELATED APPLICATIONS

This application is related to a commonly owned patent application titled “METHODS AND SYSTEMS ACQUIRING IMPULSE SIGNALS (Atty. Docket No. JSF04-003),” which is being filed concurrently with this application, and which is hereby incorporated by reference.

### FIELD OF THE INVENTION

The present invention generally relates to the field of communication systems and more particularly to communicating Ultra Wideband (UWB) signals, including receiving, transmitting, coding, acquiring, locking, tracking, timing, correlating, controlling, calibrating or otherwise processing signals in a UWB communication system.

### BACKGROUND OF THE INVENTION

As the availability of communication bandwidth in the increasingly crowded frequency spectrum is becoming a scarce and valuable commodity, UWB technology provides an excellent alternative for offering significant communication bandwidth, particularly, for various wireless communications applications, such as data communications, radar, positioning and sensing applications. Because of the significant benefits offered by UWB technology, the Federal Communications Commission (FCC) recently issued the first rulemaking that enables the commercial sale and use of UWB products in the United States. The FCC adopted a definition of UWB is a signal that occupies a fractional bandwidth of at least 0.25, or 1.5 GHz bandwidth at any center frequency. The 0.25 fractional bandwidth is more precisely defined as:

$$FBW = \frac{2 ( {f}_{h} - {f}_{l} )}{{f}_{h} + {f}_{l}} ,$$

where FBW is the fractional bandwidth, fₕ is the upper band edge and f₁ is the lower band edge, the band edges being defined as the 10 dB down point in spectral density.

One type of UWB communication system that meets the FCC rules is based on communicating extremely short-duration pulses (e.g., pico-seconds in duration). As such, these UWB systems are also known as impulse radio systems.

Impulse radio systems are radically different from conventional communication systems, such as FM, AM, Code Division Multiple Access (CDMA), Time Division Multiple Access (TDMA) and Frequency Division Multiple Access (FDMA) systems. Conventional systems use continuous sinusoidal waveforms for transmitting information. In multiple access arrangements, channelization in such systems is based on frequency, time or code parameters. For example, conventional direct sequence code division multiple access (DS-CDMA) techniques accommodate multiple users by permitting them to use the same frequency bandwidth at the same time. DS-CDMA systems employ pseudo-noise (PN) codewords generated at a transmitter to “spread” the bandwidth occupied by transmitted data beyond the minimum required by the data. The conventional DS-CDMA systems employ a family of orthogonal or quasi-orthogonal spreading codes, with a pilot spreading code sequence synchronized to the family of codes. Each user is assigned one of the spreading codes as a spreading function. One such spread-spectrum system is described in U.S. Pat. No. 4,901,307 entitled SPREAD-SPECTRUM MULTIPLE ACCESS COMMUNICATION SYSTEM USING SATELLITE OR TERRESTRIAL REPEATERS by Gilhousen et al.

Instead of using continuous sinusoidal waveforms, an impulse radio transmitter emits a low power electromagnetic train of short pulses, which are shaped to approach a Gaussian monocycle. As a result, the impulse radio transmitter uses very little power to generate noise-like communication signals for use in multiple-access communications, radar and positioning applications, among other things. In the multi-access communication applications, the impulse radio systems depend, in part, on processing gain to achieve rejection of unwanted signals.

Impulse radio systems have exceptional processing gain due to their wide spreading bandwidth. For typical spread spectrum systems, the definition of processing gain, which quantifies the decrease in channel interference when wide-band communications are used, is the ratio of the bandwidth of the channel to the bit rate of the information signal. For example, a conventional narrow band direct sequence spread spectrum system with a 10 kbps data rate and a 10 MHz spread bandwidth yields a processing gain of 1000, or 30 dB. However, far greater processing gains are achieved by impulse radio systems, where the same 10 kbps data rate is spread across a much greater 2 GHz spread bandwidth, resulting in a theoretical processing gain of 200,000, or 53 dB.

Because of the extremely high achievable processing gains, the impulse radio systems are relatively immune to unwanted signals and interference, which limit the performance of systems that use continuous sinusoidal waveforms. The high processing gains of the impulse radio systems also provide much higher dynamic ranges than those commonly achieved by the processing gains of other known spread-spectrum systems.

One type of UWB communication system transmits and receives pulses at precisely controlled time intervals, in accordance with a time-hopping code. As such, the time-hopping code defines a communication channel that can be considered as a unidirectional data path for communicating information at high speed. In order to communicate the information over such channels, typical impulse radio transmitters use position modulation, which is a form of time modulation, to position the pulses in time, based on instantaneous samples of a modulating information signal. The modulating information signal may for example be a multi-state information signal, such as a binary signal. Under this arrangement, a modulator varies relative positions of a plurality of pulses on a pulse-by-pulse basis, in accordance with the modulating information signal and a specific time-hopping code that defines the communication channel.

The following section provides an overview of impulse radio technology and relevant aspects of UWB communications theory. It is provided to assist the reader with understanding the present invention and should not be used to limit the scope of the present invention. It should be understood that the terminology ‘impulse radio’ is used primarily for historical convenience and that the terminology can be generally interchanged with the terminology ‘impulse communications system, ultra-wideband system, or ultra-wideband communication systems’. Furthermore, it should be understood that the described impulse radio technology is generally applicable to various other impulse system applications including but not limited to impulse radar systems and impulse positioning systems. Accordingly, the terminology ‘impulse radio’ can be generally interchanged with the terminology ‘impulse transmission system and impulse reception system.’

Ultra Wideband Technology Overview

Prior art UWB radio systems, including impulse radio, have been described in a series of patents, including U.S. Pat. No. 4,641,317 (issued Feb. 3, 1987), U.S. Pat. No. 4,813,057 (issued Mar. 14, 1989), U.S. Pat. No.4,979,186 (issued Dec. 18, 1990), and U.S. Pat. No. 5,363,108 (issued Nov. 8, 1994) to Larry W. Fullerton. A second generation of impulse radio patents includes U.S. Pat. No. 5,677,927 (issued Oct. 14, 1997), U.S. Pat. No. 5,687,169 (issued Nov. 11, 1997), U.S. Pat. No. 5,764,696 (issued Jun. 9, 1998), U.S. Pat. No. 5,832,035 (issued Nov. 3, 1998), and U.S. Pat. No. 5,969,663 (issued Oct. 19, 1999) to Fullerton et al, and U.S. Pat. No. 5,812,081 (issued Sep. 22, 1998), and U.S. Pat. No. 5,952,956 (issued Sep. 14, 1999) to Fullerton, which are incorporated herein by reference.

Uses of impulse radio systems are described in U.S. Pat. No. 6,177,903 (issued Jan. 23, 2001) titled, “System and Method for Intrusion Detection using a Time Domain Radar Array” and U.S. Pat. No. 6,218,979 (issued Apr. 17, 2001) titled “Wide Area Time Domain Radar Array”, which are incorporated herein by reference.

As explained above, impulse radio refers to a radio system based on short, wide bandwidth pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Many waveforms having very broad, or wide, spectral bandwidth approximate a Gaussian shape to a useful degree.

Impulse radio can use many types of modulation, including amplitude modulation, phase modulation, frequency modulation (including frequency shape and wave shape modulation), time-shift modulation (also referred to as pulse-position modulation (PPM) or pulse-interval modulation) and M-ary versions of these. In this document, the time-shift modulation method is often used as an illustrative example. However, someone skilled in the art would recognize that alternative modulation approaches may, in some instances, be used instead of or in combination with the time-shift modulation approach.

In impulse radio communications, inter-pulse spacing may be held constant or may be varied on a pulse-by-pulse basis by information, a code, or both. Generally, conventional spread spectrum systems employ codes to spread the normally narrow band information signal over a relatively wide band of frequencies. A conventional spread spectrum receiver correlates these signals to retrieve the original information signal. In impulse radio communications, codes are not typically used for energy spreading because the monocycle pulses themselves have an inherently wide bandwidth. Codes are more commonly used for channelization, energy smoothing in the frequency domain, resistance to interference, and reducing the interference potential to nearby receivers. Such codes are commonly referred to as time-hopping codes or pseudo-noise (PN) codes since their use typically causes inter-pulse spacing to have a seemingly random nature. PN codes may be generated by techniques other than pseudorandom code generation. Additionally, pulse trains having constant, or uniform, pulse spacing are commonly referred to as uncoded pulse trains. A pulse train with uniform pulse spacing, however, may be described by a code that specifies non-temporal, i.e., non-time related, pulse characteristics.

In impulse radio communications utilizing time-shift modulation, information comprising one or more bits of data typically time-position modulates a sequence of pulses. This yields a modulated, coded timing signal that comprises a train of pulses from which a typical impulse radio receiver employing the same code may demodulate and, if necessary, coherently integrate pulses to recover the transmitted information.

The impulse radio receiver is typically a direct conversion receiver with a cross correlator front-end that coherently converts an electromagnetic pulse train of monocycle pulses to a baseband signal in a single stage. The baseband signal is the basic information signal for the impulse radio communications system. A subcarrier may also be included with the baseband signal to reduce the effects of amplifier drift and low frequency noise. Typically, the subcarrier alternately reverses modulation according to a known pattern at a rate faster than the data rate. This same pattern is used to reverse the process and restore the original data pattern just before detection. This method permits alternating current (AC) coupling of stages, or equivalent signal processing, to eliminate direct current (DC) drift and errors from the detection process. This method is described in more detail in U.S. Pat. No. 5,677,927 to Fullerton et al.

Waveforms

Impulse transmission systems are based on short, wide band pulses. Different pulse waveforms, or pulse types, may be employed to accommodate requirements of various applications. Typical ideal pulse types used in analysis include a Gaussian pulse doublet (also referred to as a Gaussian monocycle), pulse triplet, and pulse quadlet as depicted in FIGS. 1A through 1D. An actual received waveform that closely resembles the theoretical pulse quadlet is shown in FIG. 1E. A pulse type may also be a wavelet set produced by combining two or more pulse waveforms (e.g., a doublet/triplet wavelet set), or families of orthogonal wavelets. Additional pulse designs include chirped pulses and pulses with multiple zero crossings, or bursts of cycles. These different pulse types may be produced by methods described in the patent documents referenced above or by other methods understood by one skilled in the art.

For analysis purposes, it is convenient to model pulse waveforms in an ideal manner. For example, the transmitted waveform produced by supplying a step function into an ultra-wideband antenna may be modeled as a Gaussian monocycle. A Gaussian monocycle (normalized to a peak value of 1) may be described by:

$${f}_{mono} ( t ) = \sqrt{ⅇ} ( \frac{t}{σ} ) {ⅇ}^{\frac{- {t}^{2}}{2 {σ}^{2}}}$$

where σ is a time scaling parameter, t is time, and e is the natural logarithm base.

FIG. 1F shows the power spectral density of the Gaussian pulse, doublet, triplet, and quadlet normalized to a peak density of 1. The normalized doublet (monocycle) is as follows:

Fₘₒₙₒ(f)=j(2π)\sqrt{e}σfe^{-2(πσf)}^{²}

Where Fₘₒₙₒ( ) is the Fourier transform of fₘₒₙₒ( ),f is frequency, and j is the imaginary unit. The center frequency (f_{c}), or frequency of peak spectral density, of the Gaussian monocycle is:

$${f}_{c} = \frac{1}{2 π σ}$$

Pulse Trains

Impulse transmission systems may communicate one or more data bits with a single pulse; however, typically each data bit is communicated using a sequence of pulses, known as a pulse train. As described in detail in the following example system, the impulse radio transmitter produces and outputs a train of pulses for each bit of information. FIGS. 2A and 2B are illustrations of the output of a typical 10 megapulses per second (Mpps) system with uncoded, unmodulated pulses, each having a width of 0.5 nanoseconds (ns). FIG. 2A shows a time domain representation of the pulse train output. FIG. 2B illustrates that the result of the pulse train in the frequency domain is to produce a spectrum comprising a set of comb lines spaced at the frequency of the 10 Mpps pulse repetition rate. When the full spectrum is shown, as in FIG. 2C, the envelope of the comb line spectrum corresponds to the curve of the single Gaussian monocycle spectrum in FIG. 1F. For this simple uncoded case, the power of the pulse train is spread among roughly two hundred comb lines. Each comb line thus has a small fraction of the total power and presents much less of an interference problem to a receiver sharing the band. It can also be observed from FIG. 2A that impulse transmission systems may have very low average duty cycles, resulting in average power lower than peak power. The duty cycle of the signal in FIG. 2A is 0.5%, based on a 0.5 ns pulse duration in a 100 ns interval.

The signal of an uncoded, umnodulated pulse train may be expressed:

$$s ( t ) = a {\sum }_{i = 1}^{n} w ( c ( t - {iT}_{f} ) , b )$$

where i is the index of a pulse within a pulse train of n pulses, a is pulse amplitude, b is pulse type, c is a pulse width scaling parameter, w(t, b) is the normalized pulse waveform, and T_{f} is pulse repetition time, also referred to as frame time.

The Fourier transform of a pulse train signal over a frequency bandwidth of interest may be determined by summing the phasors of the pulses for each code time shift, and multiplying by the Fourier transform of the pulse function:

$$S ( f ) = a \vert {\sum }_{i = 1}^{n} {ⅇ}^{- {j2πfiT}_{f}} \vert W ( f )$$

where S(f) is the amplitude of the spectral response at a given frequency, f is the frequency being analyzed, T_{f} is the relative time delay of each pulse from the start of time period, W(f) is the Fourier transform of the pulse, w(t,b), and n is the total number of pulses in the pulse train.

A pulse train can also be characterized by its autocorrelation and cross-correlation properties. Autocorrelation properties pertain to the number of pulse coincidences (i.e., simultaneous arrival of pulses) that occur when a pulse train is correlated against an instance of itself that is offset in time. Of primary importance is the ratio of the number of pulses in the pulse train to the maximum number of coincidences that occur for any time offset across the period of the pulse train. This ratio is commonly referred to as the main-lobe-to-peak-side-lobe ratio, where the greater the ratio, the easier it is to acquire and track a signal.

Cross-correlation properties involve the potential for pulses from two different signals simultaneously arriving, or coinciding, at a receiver. Of primary importance are the maximum and average numbers of pulse coincidences that may occur between two pulse trains. As the number of coincidences increases, the propensity for data errors increases. Accordingly, pulse train cross-correlation properties are used in determining channelization capabilities of impulse transmission systems (i.e., the ability to simultaneously operate within close proximity).

Coding

Various coding schemes with known correlation characteristics are available. For example, algebraic codes, Quadratic Congruential (QC) codes, Hyperbolic Congruential (HC) codes and optical codes have been suggested in the past for coding in impulse radio systems. Generally, based on known assumptions, the coding schemes guarantee a maximum number of pulse coincidences, i.e., hits, for any defined time frame or time frame shift during which the codes are repeated. For example, HC codes are guaranteed a maximum of two hits for any sub-frame or frame shift.

McCorkle in U.S. Pat. No. 5,847,677 discloses a random number generator for generating a pseudo-random code for use with jittered pulse repetition interval radar systems. The code is generated by a random number generator that possesses certain attributes desirable for a jittered radar. As disclosed, the attributes related to a flat frequency spectrum, a nearly perfect spike for an autocorrelation function, a controllable absolute minimum and maximum interval, long sequences that do not repeat, and a reasonable average pulse rate.

Another known coding technique for an impulse radio is disclosed by Barrett in U.S. Pat. No. 5,610,907, entitled “Ultrafast Time Hopping CDMA-RF Communications: Code-As-Carrier, Multichannel Operation, High data Rate Operation and Data Rate on Demand.” According to the disclosed techniques, two levels of coding are used: major orthogonal codes are applied to provide multiple channels, and forward error correction (FEC) codes are applied to information data before transmission. The disclosed system relies on dividing time into repetitive super-frames, frames and sub-frames. As disclosed, a super-frame corresponds to a time interval of about 1 millisecond, representing one repetition of a code pattern, where as a frame is defined as a time interval of about 1 microsecond divided according to a code length. A sub-frame corresponds to a short time interval of about 1 nano second during which a pulse is time positioned.

Specialized coding techniques can be employed to specify temporal and/or non-temporal pulse characteristics to produce a pulse train having certain spectral and/or correlation properties. For example, by employing a Pseudo-Noise (PN) code to vary inter-pulse spacing, the energy in the uncoded comb lines presented in FIGS. 2B and 2C can be distributed to other frequencies as depicted in FIG. 2D, thereby decreasing the peak spectral density within a bandwidth of interest. Note that the spectrum retains certain properties that depend on the specific (temporal) PN code used. Spectral properties can be similarly affected by using non-temporal coding (e.g., inverting certain pulses).

In some applications, coding provides a method of establishing independent communication channels. Specifically, families of codes can be designed such that the number of pulse coincidences between pulse trains produced by any two codes would be minimal. For example, FIG. 3 depicts cross-correlation properties of two codes that have no more than four coincidences for any time offset. Generally, keeping the number of pulse collisions minimal represents a substantial attenuation of the unwanted signal.

Coding can also be used to facilitate signal acquisition. For example, coding techniques can be used to produce pulse trains with a desirable main-lobe-to-side-lobe ratio. In addition, coding can be used to reduce acquisition algorithm search space.

Coding methods for specifying temporal and non-temporal pulse characteristics are described in commonly owned, co-pending applications titled “A Method and Apparatus for Positioning Pulses in Time,⇄ application Ser. No. 09/592,249, and “A Method for Specifying Non-Temporal Pulse Characteristics,” application Ser. No. 09/592,250, both filed Jun. 12, 2000, and both of which are incorporated herein by reference.

Typically, a code consists of a number of code elements having integer or floating-point values. A code element value may specify a single pulse characteristic or may be subdivided into multiple components, each specifying a different pulse characteristic. Code element or code component values typically map to a pulse characteristic value layout that may be fixed or non-fixed and may involve value ranges, discrete values, or a combination of value ranges and discrete values. A value range layout specifies a range of values that is divided into components that are each subdivided into subcomponents, which can be further subdivided, as desired. In contrast, a discrete value layout involves uniformly or non-uniformly distributed discrete values. A non-fixed layout (also referred to as a delta layout) involves delta values relative to some reference value. Fixed and non-fixed layouts, and approaches for mapping code element/component values, are described in co-owned, co-pending applications, titled “Method for Specifying Pulse Characteristics using Codes,” application Ser. No. 09/592,290 and “A Method and Apparatus for Mapping Pulses to a Non-Fixed Layout,” application Ser. No. 09/591,691, both filed on Jun. 12, 2000, both of which are incorporated herein by reference.

A fixed or non-fixed characteristic value layout may include a non-allowable region within which a pulse characteristic value is disallowed. A method for specifying non-allowable regions is described in co-owned U.S. Pat. No. 6,636,567 (issued Oct. 21, 2003). titled “A Method for Specifying Non-Allowable Pulse Characteristics,” and incorporated herein by reference. A related method that conditionally positions pulses depending on whether code elements map to non-allowable regions is described in co-owned, co-pending application, titled “A Method and Apparatus for Positioning Pulses Using a Layout having Non-Allowable Regions,” application Ser. No. 09/592,248 filed Jun. 12, 2000, and incorporated herein by reference.

The signal of a coded pulse train can be generally expressed by:

$${s}_{tr} ( t ) = {\sum }_{i} {( - 1 )}^{{f}_{i}} {a}_{i} w ( {c}_{i} ( t - {T}_{i} ) , {b}_{i} )$$

where Sₜᵣ(t) is the coded pulse train signal, i is the index of a pulse within the pulse train, (−1)^{fi}, aᵢ, bᵢ, cᵢ, and ω(t,bᵢ) are the coded polarity, pulse amplitude, pulse type, pulse width, and normalized pulse waveform of the i'th pulse, and Tᵢ is the coded time shift of the i^{th} pulse. Various numerical code generation methods can be employed to produce codes having certain correlation and spectral properties. Detailed descriptions of numerical code generation techniques are included in a co-owned, co-pending patent application titled “A Method and Apparatus for Positioning Pulses in Time,” application Ser. No. 09/592,248, filed Jun. 12, 2000, and incorporated herein by reference.

It may be necessary to apply predefined criteria to determine whether a generated code, code family, or a subset of a code is acceptable for use with a given UWB application. Criteria may include correlation properties, spectral properties, code length, non-allowable regions, number of code family members, or other pulse characteristics. A method for applying predefined criteria to codes is described in co-owned U.S. Pat. No. 6,636,566 (issued Oct. 21, 2003), titled “A Method and Apparatus for Specifying Pulse Characteristics using a Code that Satisfies Predefined Criteria,” and incorporated herein by reference.

In some applications, it may be desirable to employ a combination of codes. Codes may be combined sequentially, nested, or sequentially nested, and code combinations may be repeated. Sequential code combinations typically involve switching from one code to the next after the occurrence of some event and may also be used to support multicast communications. Nested code combinations may be employed to produce pulse trains having desirable correlation and spectral properties. For example, a designed code may be used to specify value range components within a layout and a nested pseudorandom code may be used to randomly position pulses within the value range components. With this approach, correlation properties of the designed code are maintained since the pulse positions specified by the nested code reside within the value range components specified by the designed code, while the random positioning of the pulses within the components results in particular spectral properties. A method for applying code combinations is described in co-owned, co-pending application, titled “A Method and Apparatus for Applying Codes Having Pre-Defined Properties,” application Ser. No. 09/591,690, filed Jun. 12, 2000, and incorporated herein by reference.

Modulation

Various aspects of a pulse waveform may be modulated to convey information and to further minimize structure in the resulting spectrum. Amplitude modulation, phase modulation, frequency modulation, time-shift modulation and M-ary versions of these were proposed in U.S. Pat. No. 5,677,927 to Fullerton et al., previously incorporated by reference. Time-shift modulation can be described as shifting the position of a pulse either forward or backward in time relative to a nominal coded (or uncoded) time position in response to an information signal. Thus, each pulse in a train of pulses is typically delayed a different amount from its respective time base clock position by an individual code delay amount plus a modulation time shift. This modulation time shift is normally very small relative to the code shift. In a 10 Mpps system with a center frequency of 2 GHz, for example, the code may command pulse position variations over a range of 100 ns, whereas, the information modulation may shift the pulse position by 150 ps. This two-state ‘early-late’ form of time shift modulation is depicted in FIG. 4A.

A generalized expression for a pulse train with ‘early-late’ time-shift modulation over a data symbol time is:

$${s}_{tr} ( t ) = {\sum }_{i = 1}^{{N}_{s}} {( - 1 )}^{{f}_{i}} {a}_{i} w ( {c}_{i} ( t - {T}_{i} - δ {d}_{k} ) , {b}_{i} )$$

where k is the index of a data symbol (e.g., bit), i is the index of a pulse within the data symbol, Nₛ is the number of pulses per symbol, (−1)^{fi} is a coded polarity (flipping) pattern (sequence), aᵢ is a coded amplitude pattern, bᵢ is a coded pulse type (shape) pattern, cᵢ is a coded pulse width pattern, and w(t, bᵢ) is a normalized pulse waveform of the i^{th} pulse, Tⱼ⁾ is the coded time shift of the i'th pulse, δ is the time shift added when the transmitted symbol is 1 (instead of 0), dₖ is the data (i.e., 0 or 1) transmitted by the transmitter. In this example, the data value is held constant over the symbol interval. Similar expressions can be derived to accommodate other proposed forms of modulation.

An alternative form of time-shift modulation can be described as One-of-Many Position Modulation (OMPM). The OMPM approach, shown in FIG. 4B, involves shifting a pulse to one of N possible modulation positions about a nominal coded (or uncoded) time position in response to an information signal, where N represents the number of possible states. For example, if N were four (4), two data bits of information could be conveyed. For further details regarding OMPM, see “Apparatus, System and Method for One-of-Many Position Modulation in an Impulse Radio Communication System,” Attorney Docket No. 1659.0860000, filed Jun. 7, 2000, which is incorporated herein by reference.

An impulse radio communications system can employ flip modulation techniques to convey information. The simplest flip modulation technique involves transmission of a pulse or an inverted (or flipped) pulse to represent a data bit of information, as depicted in FIG. 4C. Flip modulation techniques may also be combined with time-shift modulation techniques to create two, four, or more different data states. One such flip with shift modulation technique is referred to as Quadrature Flip Time Modulation (QFTM). The QFTM approach is illustrated in FIG. 4D. Flip modulation techniques are further described in patent application titled “Apparatus, System and Method for Flip Modulation in an Impulse Radio Communication System,” application Ser. No. 09/537,692, filed Mar. 29, 2000, which is incorporated herein by reference.

Vector modulation techniques may also be used to convey information. Vector modulation includes the steps of generating and transmitting a series of time-modulated pulses, each pulse delayed by one of at least four pre-determined time delay periods and representative of at least two data bits of information, and receiving and demodulating the series of time-modulated pulses to estimate the data bits associated with each pulse. Vector modulation is shown in FIG. 4E. Vector modulation techniques are further described in patent application titled “Vector Modulation System and Method for Wideband Impulse Radio Communications,” application Ser. No. 09/169,765, filed Dec. 9, 1999, which is incorporated herein by reference.

Reception and Demodulation

Impulse radio systems operating within close proximity to each other may cause mutual interference. While coding minimizes mutual interference, the probability of pulse collisions increases as the number of coexisting impulse radio systems rises. Additionally, various other signals may be present that cause interference. Impulse radios can operate in the presence of mutual interference and other interfering signals, in part because they typically do not depend on receiving every transmitted pulse. Except for single pulse per bit systems, impulse radio receivers perform a correlating, synchronous receiving function (at the RF level) that uses sampling and combining, or integration, of many pulses to recover transmitted information. Typically, 1 to 1000 or more pulses are integrated to yield a single data bit thus diminishing the impact of individual pulse collisions, where the number of pulses that are integrated to successfully recover transmitted information depends on a number of variables including pulse rate, bit rate, range and interference levels. The number of integrated pulses is referred to herein as the (pulse) integration length.

Interference Resistance

Besides providing channelization and energy smoothing, coding makes impulse radios highly resistant to interference by enabling discrimination between intended impulse transmissions and interfering transmissions. This property is desirable since impulse radio systems share the energy spectrum with conventional radio systems and with other impulse radio systems.

FIG. 5A illustrates the result of a narrow band sinusoidal interference signal 502 overlaying an impulse radio signal 504. At the impulse radio receiver, the input to the cross correlation would include the narrow band signal 502 and the received ultrawide-band impulse radio signal 504. The input is sampled by the cross correlator using a template signal 506 positioned in accordance with a code. Without coding, the cross correlation would sample the interfering signal 502 with such regularity that the interfering signals could cause interference to the impulse radio receiver. However, when the transmitted impulse signal is coded and the impulse radio receiver template signal 506 is synchronized using the identical code, the receiver samples the interfering signals non-uniformly. The samples from the interfering signal add incoherently, increasing roughly according to the square root of the number of samples integrated. The impulse radio signal samples, however, add coherently, increasing directly according to the number of samples integrated. Thus, integrating over many pulses overcomes the impact of interference.

Multipath and Propagation

One of the advantages of impulse radio is its resistance to multipath fading effects. Conventional narrow band systems are subject to multipath through the Rayleigh fading process, where the signals from many delayed reflections combine at the receiver antenna according to their seemingly random relative phases resulting in possible summation or possible cancellation, depending on the specific propagation to a given location. Multipath fading effects are most adverse where a direct path signal is weak relative to multipath signals, which represents a substantial portion of the potential coverage area of a typical radio system. In a mobile system, received signal strength fluctuates due to the changing mix of multipath signals that vary as the mobile units position varies relative to fixed transmitters, other mobile transmitters and signal-reflecting surfaces in the environment.

Impulse radios, however, can be substantially resistant to multipath effects. Impulses arriving from delayed multipath reflections typically arrive outside of the correlation time and, thus, may be ignored. This process is described in detail with reference to FIGS. 5B and 5C. FIG. 5B illustrates a typical multipath situation, such as in a building, where there are many reflectors 504B, 505B. In this figure, a transmitter 506B transmits a signal that propagates along three paths, the direct path 501B, path 1 502B, and path2 503B, to a receiver 508B, where the multiple reflected signals are combined at the antenna. The direct path 501B, representing the straight-line distance between the transmitter and receiver, is the shortest. Path 1 502B represents a multipath reflection with a distance very close to that of the direct path. Path 2 503B represents a multipath reflection with a much longer distance. Also shown are elliptical (or, in space, ellipsoidal) traces that represent other possible locations for reflectors that would produce paths having the same distance and thus the same time delay.

FIG. 5C illustrates the received composite pulse waveform resulting from the three propagation paths 501B, 502B, and 503B shown in FIG. 5B. In this figure, the direct path signal 501B is shown as the first pulse signal received. The path 1 and path 2 signals 502B, 503B comprise the remaining multipath signals, or multipath response, as illustrated. The direct path signal is the reference signal and represents the shortest propagation time. The path 1 signal is delayed slightly and overlaps and enhances the signal strength at this delay value. The path 2 signal is delayed sufficiently that the waveform is completely separated from the direct path signal. Note that the reflected waves are reversed in polarity. If the correlator template signal is positioned such that it samples the direct path signal, the path 2 signal is not sampled and thus produces no response. However, it can be seen that the path 1 signal has an effect on the reception of the direct path signal since a portion of it would also be sampled by the template signal. Generally, multipath signals delayed less than one quarter wave (one quarter wave is about 1.5 inches, or 3.5 cm at 2 GHz center frequency) may attenuate the direct path signal. This region is equivalent to the first Fresnel zone in narrow band systems. Impulse radio, however, has no further nulls in the higher Fresnel zones. This ability to avoid the highly variable attenuation from multipath gives impulse radio significant performance advantages.

FIGS. 5D, 5E, and 5F represent the received signal from a TM-UWB transmitter in three different multipath environments. These figures are approximations of typical signal plots. FIG. 5D illustrates the received signal in a very low multipath environment. This may occur in a building where the receiver antenna is in the middle of a room and is a relatively short, distance, for example, one meter, from the transmitter. This may also represent signals received from a larger distance, such as 100 meters, in an open field where there are no objects to produce reflections. In this situation, the predominant pulse is the first received pulse and the multipath reflections are too weak to be significant. FIG. 5E illustrates an intermediate multipath environment. This approximates the response from one room to the next in a building. The amplitude of the direct path signal is less than in FIG. 5D and several reflected signals are of significant amplitude. FIG. 5F approximates the response in a severe multipath environment such as propagation through many rooms, from corner to corner in a building, within a metal cargo hold of a ship, within a metal truck trailer, or within an intermodal shipping container. In this scenario, the main path signal is weaker than in FIG. 5E. In this situation, the direct path signal power is small relative to the total signal power from the reflections.

An impulse radio receiver can receive the signal and demodulate the information using either the direct path signal or any multipath signal peak having sufficient signal-to-noise ratio. Thus, the impulse radio receiver can select the strongest response from among the many arriving signals. In order for the multipath signals to cancel and produce a null at a given location, dozens of reflections would have to be cancelled simultaneously and precisely while blocking the direct path, which is a highly unlikely scenario. This time separation of multipath signals together with time resolution and selection by the receiver permit a type of time diversity that virtually eliminates cancellation of the signal. In a multiple correlator rake receiver, performance is further improved by collecting the signal power from multiple signal peaks for additional signal-to-noise performance.

In a narrow band system subject to a large number of multipath reflections within a symbol (bit) time, the received signal is essentially a sum of a large number of sine waves of random amplitude and phase. In the idealized limit, the resulting envelope amplitude has been shown to follow a Rayleigh probability density as follows:

$$p ( r ) = \frac{r}{{σ}^{2}} exp ( \frac{- {r}^{2}}{2 {σ}^{2}} )$$

where r is the envelope amplitude of the combined multipath signals, and 2σ² is the expected value of the envelope power of the combined multipath signals. The Rayleigh distribution curve in FIG. 5G shows that 10% of the time, the signal is more than 10 dB attenuated. This suggests that a 10 dB fade margin is needed to provide 90% link reliability. Values of fade margin from 10 dB to 40 dB have been suggested for various narrow band systems, depending on the required reliability. Although multipath fading can be partially improved by such techniques as antenna and frequency diversity, these techniques result in additional complexity and cost.

In a high multipath environment such as inside homes, offices, warehouses, automobiles, trailers, shipping containers, or outside in an urban canyon or in other situations where the propagation is such that the received signal is primarily scattered energy, impulse radio systems can avoid the Rayleigh fading mechanism that limits performance of narrow band systems, as illustrated in FIG. 5H and 51. FIG. 5H depicts an impulse radio system in a high multipath environment 500H consisting of a transmitter 506H and a receiver 508H. A transmitted signal follows a direct path 501H and reflects off of reflectors 503H via multiple paths 502H. FIG. 5I illustrates the combined signal received by the receiver 508H over time with the vertical axis being signal strength in volts and the horizontal axis representing time in nanoseconds. The direct path 501H results in the direct path signal 5021 while the multiple paths 502H result in multipath signals 5041. UWB system can thus resolve the reflections into separate time intervals, which can be received separately. Thus, the UWB system can select the strongest or otherwise most desirable reflection from among the numerous reflections. This yields a multipath diversity mechanism with numerous paths making it highly resistant to Rayleigh fading. Whereas, in a narrow band systems, the reflections arrive within the minimum time resolution of one bit or symbol time which results in a single vector summation of the delayed signals with no inherent diversity.

Similarly, when multipath time dispersion is present in a CDMA system, the receiver receives a composite signal of multiple versions of the transmitted symbol that have propagated along different paths. Among the techniques used to mitigate the effects of fading in DS-CDMA communication systems is the path diversity technique. Path diversity in DS-CDMA systems entails estimation of the delay introduced by each of one or more multipaths (in comparison with some reference, such as line-of-sight delay), and then using this delay in a receiver structure to separate (or resolve) the received multipath signals. A receiver structure often employed to provide path diversity is the so-called rake receiver, which is well known in the art. See. e.g., R. Price and P. E. Green, Jr., A Communication Technique for Multipath Channels, 46 Proc. Inst. Rad. Eng. 555-70 (March 1958).

Distance Measurement and Positioning

Impulse systems can measure distances to relatively fine resolution because of the absence of ambiguous cycles in the received waveform. Narrow band systems, on the other hand, are limited to the modulation envelope and cannot easily distinguish precisely which RF cycle is associated with each data bit because the cycle-to-cycle amplitude differences are so small they are masked by link or system noise. Since an impulse radio waveform has minimal multi-cycle ambiguity, it is feasible to determine waveform position to less than a wavelength in the presence of noise. This time position measurement can be used to measure propagation delay to determine link distance to a high degree of precision. For example, 30 ps of time transfer resolution corresponds to approximately centimeter distance resolution. See, for example, U.S. Pat. No. 6,133,876, issued Oct. 17, 2000, titled “System and Method for Position Determination by Impulse Radio,” and U.S. Pat. No. 6,111,536, issued Aug. 29, 2000, titled “System and Method for Distance Measurement by Inphase and Quadrature Signals in a Radio System,” both of which are incorporated herein by reference.

In addition to the methods articulated above, impulse radio technology in a Time Division Multiple Access (TDMA) radio system can achieve geo-positioning capabilities to high accuracy and fine resolution. This geo-positioning method is described in U.S. Pat. No. 6,300,903, issued Oct. 9, 2001, titled “System and Method for Person or Object Position Location Utilizing Impulse Radio,” which is incorporated herein by reference.

Exemplary Transceiver Implementation Transmitter

An exemplary embodiment of an impulse radio transmitter 602 of an impulse radio communication system having an optional subcarrier channel is described with reference to FIG. 6.

The transmitter 602 comprises a time base 604 that generates a periodic timing signal 606. The time base 604 typically comprises a voltage controlled oscillator (VCO), or the like, having a high timing accuracy and low jitter. The control voltage to adjust the VCO center frequency is set at calibration to the desired center frequency used to define the transmitter's nominal pulse repetition rate. The periodic timing signal 606 is supplied to a precision timing generator 608.

The precision timing generator 608 supplies synchronizing signals 610 to the code source 612 and utilizes the code source output 614, together with an optional, internally generated subcarrier signal, and an information signal 616, to generate a modulated, coded timing signal 618.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger signal to generate output pulses. The output pulses are provided to a transmit antenna 624 via a transmission line 626 coupled thereto. The output pulses are converted into propagating electromagnetic pulses by the transmit antenna 624. The electromagnetic pulses (also called the emitted signal) propagate to an impulse radio receiver 702, such as shown in FIG. 7, through a propagation medium. In a preferred embodiment, the emitted signal is wide-band or ultrawide-band, approaching a monocycle pulse as in FIG. 1B. However, the emitted signal may be spectrally modified by filtering of the pulses, which may cause them to have more zero crossings (more cycles) in the time domain, requiring the radio receiver to use a similar waveform as the template signal for efficient conversion.

Receiver

An exemplary embodiment of an impulse radio receiver (hereinafter called the receiver) for the impulse radio communication system is now described with reference to FIG. 7.

The receiver 702 comprises a receive antenna 704 for receiving a propagated impulse radio signal 706. A received signal 708 is input to a cross correlator or sampler 710, via a receiver transmission line, coupled to the receive antenna 704. The cross correlation 710 produces a baseband output 712.

The receiver 702 also includes a precision timing generator 714, which receives a periodic timing signal 716 from a receiver time base 718. This time base 718 may be adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter to generate the propagated signal. Thus, the timing of the template pulse train matches the timing of the received signal pulse train, allowing the received signal 708 to be synchronously sampled in the correlator 710. The correlator 710 preferably comprises a multiplier followed by a short-term integrator to sum the multiplier product over the pulse interval.

The output of the correlator 710 may be coupled to an optional subcarrier demodulator 732, which demodulates the subcarrier information signal from the optional subcarrier, when used. The purpose of the optional subcarrier process, when used, is to move the information signal away from DC (zero frequency) to improve immunity to low frequency noise and offsets. The output of the subcarrier demodulator is then filtered or integrated in the pulse summation stage 734. A digital system embodiment is shown in FIG. 7. In this digital system, a sample and hold 736 samples the output 735 of the pulse summation stage 734 synchronously with the completion of the summation of a digital bit or symbol. The output of sample and hold 736 is then compared with a nominal zero (or reference) signal output in a detector stage 738 to provide an output signal 739 representing the digital state of the output voltage of sample and hold 736.

The baseband signal 712 is also input to a lowpass filter 742 (also referred to as lock loop filter 742). A control loop comprising the lowpass filter 742, time base 718, precision timing generator 714, template generator 728, and correlator 710 is used to maintain proper timing between the received signal 708 and the template. The loop error signal 744 is processed by the loop filter to provide adjustments to the adjustable time base 718 to correct the relative time position. of the periodic timing signal 726 for best reception of the received signal 708.

In a transceiver embodiment, substantial economy can be achieved by sharing part or all of several of the functions of the transmitter 602 and receiver 702. Some of these include the time base 718, precision timing generator 714, code source 722, antenna 704, and the like.

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the cross correlator for each of the time offsets of FIG. 8B. For any given pulse received, there is a corresponding point that is applicable on this graph. This is the point corresponding to the time offset of the template signal used to receive that pulse. Further examples and details of precision timing can be found described in U.S. Pat. No. 5,677,927 and U.S. Pat. No. 6,304,623, issued Oct. 16, 2001, titled “Precision Timing Generator System and Method,” both of which are incorporated herein by reference.

Because of the unique nature of impulse radio receivers, several modifications have been recently made to enhance system capabilities. Modifications include the utilization of multiple correlators to measure the impulse response of a channel to the maximum communications range of the system and to capture information on data symbol statistics. Further, multiple correlators enable rake pulse correlation techniques, more efficient acquisition and tracking implementations, various modulation schemes, and collection of time-calibrated pictures of received waveforms. For greater elaboration of multiple correlator techniques, see patent application titled “System and Method of using Multiple Correlator Receivers in an Impulse Radio System”, application Ser. No. 09/537,264, filed Mar. 29, 2000, which is incorporated herein by reference.

Methods to improve the speed at which a receiver can acquire and lock onto an incoming impulse radio signal have been developed. In one approach, a receiver includes an adjustable time base to output a sliding periodic timing signal having an adjustable repetition rate and a decode timing modulator to output a decode signal in response to the periodic timing signal. The impulse radio signal is cross-correlated with the decode signal to output a baseband signal. The receiver integrates T samples of the baseband signal and a threshold detector uses the integration results to detect channel coincidence. A receiver controller stops sliding the time base when channel coincidence is detected. A counter and extra count logic, coupled to the controller, are configured to increment or decrement the address counter by one or more extra counts after each T pulses is reached in order to shift the code modulo for proper phase alignment of the periodic timing signal and the received impulse radio signal. This method is described in more detail in U.S. Pat. No. 5,832,035 to Fullerton, which is incorporated herein by reference.

In another approach, a receiver obtains a template pulse train and a received impulse radio signal. The receiver compares the template pulse train and the received impulse radio signal. The system performs a threshold check on the comparison result. If the comparison result passes the threshold check, the system locks on the received impulse radio signal. The system may also perform a quick check, a synchronization check, and/or a command check of the impulse radio signal. For greater elaboration of this approach, see U.S. Pat. No. 6,556,621, issued Apr. 29, 2003, titled “Method and System for Fast Acquisition of Ultra Wideband Signals,” which is incorporated herein by reference.

A receiver has been developed that includes a baseband signal converter device and combines multiple converter circuits and an RF amplifier in a single integrated circuit package. For greater elaboration of this receiver, see U.S. Pat. No. 6,421,389, issued Jul. 16, 2002, titled “Baseband Signal Converter for a Wideband Impulse Radio Receiver,” which is incorporated herein by reference.

Complex devices like a UWB radio use a central control state machine for controlling various radio functions at every state. For controlling such complex devices, the state machine should be able to move from a present state to several other states in one clock. The state machine should also be able to respond to multiple inputs that might affect a state transition, while being highly configurable even after it is integrated on an ASIC.

A traditional hardwired controller for a floating-point engine in a general-purpose processor is used in a controller known as Fairchild CLIPPER. Programmable general-purpose processors (like SPARC cores, MIPS cores, ARM cores, Power PC cores) have also been used for controlling device functions. Conventionally, special purpose processors are used to control complex devices. One such processor uses a program counter to track the “state” of the machine. U.S. Pat. No. 4,831,573 discloses a programmable integrated circuit micro-sequencer apparatus that includes a dynamically programmable logic device (DPLD) combined with an EPROM look-up table to form a look-up table programmable logic device (LTPLD) which is combined with a register to form a stand alone micro-sequencer (SAM) that may be used to implement state machines and microcoded controller devices. Also, U.S. Pat. No. 6,577,316 discloses a graphics accelerator that includes a processor that is responsive to wide word instructions for data processing. Such processors, however, are usually too slow and have too little control bandwidth to handle complex devices such as UWB radios.

As described above, UWB technology can be applied to a wide variety of communication needs including data communications, radar, locating, positioning and tracking. Each application may require meeting a corresponding set of rules defined by spectrum, emission, correlation, coding, etc. Therefore, there exists a need for a system and method that efficiently and flexibly processes signals in a UWB communication system in terms of receiving, transmitting, coding, acquiring, locking, tracking, timing, correlating, controlling, or calibrating such signals.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A illustrates a representative Gaussian Monocycle waveform in the time domain, which is the first derivative of a Gaussian pulse.

FIG. 1B illustrates the frequency domain amplitude of the Gaussian Monocycle of FIG. 1A.

FIG. 1C represents the second derivative of a Gaussian pulse.

FIG. 1D represents the third derivative of the Gaussian pulse.

FIG. 1E represents the Correlator Output vs. the Relative Delay of a measured pulse signal.

FIG. 1F depicts the frequency domain amplitude of the Gaussian family of the Gaussian Pulse and the first, second, and third derivative.

FIG. 2A illustrates a pulse train comprising pulses as in FIG. 1A.

FIG. 2B illustrates the frequency domain amplitude of the waveform of FIG. 2A.

FIG. 2C illustrates the pulse train spectrum.

FIG. 2D is a plot of the Frequency vs. Energy.

FIG. 3 illustrates the cross-correlation of two codes graphically as Coincidences vs. Time Offset.

FIGS. 4A-4E illustrate five modulation techniques to include: Early-Late Modulation; One of Many Modulation; Flip Modulation; Quad Flip Modulation; and Vector Modulation.

FIG. 5A illustrates representative signals of an interfering signal, a coded received pulse train and a coded reference pulse train.

FIG. 5B depicts a typical geometrical configuration giving rise to multipath received signals.

FIG. 5C illustrates exemplary multipath signals in the time domain.

FIG. 5D represents a signal plot of an idealized UWB received pulse with no multipath.

FIG. 5E represents a signal plot of an idealized UWB received pulse in moderate multipath.

FIG. 5F represents a signal plot of an idealized UWB received pulse in severe multipath.

FIG. 5G illustrates the Rayleigh fading curve associated with non-impulse radio transmissions in a multipath environment.

FIG. 5H illustrates a plurality of multipaths with a plurality of reflectors from a transmitter to a receiver.

FIG. 5I graphically represents signal strength as volts vs. time in a direct path and multipath environment.

FIG. 6 illustrates a representative impulse radio transmitter functional diagram.

FIG. 7 illustrates a representative impulse radio receiver functional diagram.

FIG. 8A illustrates a representative received pulse signal at the input to the correlator.

FIG. 8B illustrates a sequence of representative impulse signals in the correlation process.

FIG. 8C illustrates the output of the correlator for each of the time offsets of FIG. 8B.

FIG. 9 depicts the PulsON® 200 chipset block diagram.

FIG. 10 illustrates the Tx/Rx flow diagram.

FIG. 11 presents an exemplary PulsON® 200 chipset transmission.

FIG. 12 shows a synchronous timer interface load diagram.

FIG. 13 illustrates placement of trigger signals within a frame.

FIG. 14 provides the Greenwich internal block diagram.

FIG. 15 presents the Master Sequencer overview diagram.

FIG. 16 provides the Master Sequencer block overview.

FIG. 17 illustrates the mseq_state_select logic design.

FIG. 18 shows the Master Sequencer transition select logic.

FIG. 19 depicts the Master Sequencer counter logic.

FIG. 20 shows the General Purpose I/O structure.

FIG. 21 presents the Tx (FEC) logic diagram.

FIG. 22 depicts flip modulation states.

FIG. 23 illustrates fine-shift modulation states.

FIG. 24 shows Quadrature-Flip Time Modulation (QFTM) states.

FIG. 25 provides 4-position Multiple Position Modulation (MPM) with QFTM states.

FIG. 26 presents a modulation logic diagram.

FIG. 27 provides example data ramps.

FIG. 28 illustrates whitener logic.

FIG. 29 presents a comparison of Non-NRZ and NRZ

FIG. 30 provides a simplified block diagram of the timer control logic.

FIG. 31 and FIG. 32 illustrate the ScanEngineMsWord and ScanEngineLsWord structures, respectively.

FIG. 33 presents context save/restore muxing.

FIG. 34 and FIG. 35 illustrate the Code Memory and IQ LUT structures, respectively.

FIG. 36 provides the length 16 code acquisition frame format.

FIG. 37 depicts the length 32 code acquisition frame format.

FIG. 38 shows the short acquisition code format.

FIG. 39 illustrates deriving longer codes from a length 16 code.

FIG. 40 illustrates deriving longer codes from a length 32 code.

FIG. 41 presents an acquisition header for code length 16 integration lengths 16-256.

FIG. 42 depicts an acquisition header for code length 16 integration lengths 512-4096.

FIG. 43 provides an acquisition header for integration 512-4096 with radio mode byte.

FIG. 44 presents the first stage acquire threshold logic.

FIG. 45 depicts acquisition logic.

FIG. 46 shows the acquisition ramp builder.

FIG. 47 illustrates phase measurement.

FIG. 48 provides an example tracking misalignment.

FIG. 49 presents noise impact on phase angle.

FIG. 50 shows the relationship of delays to integration length.

FIG. 51 illustrates a history loop.

FIG. 52 provides phase and frequency adjustment logic.

FIG. 53 depicts signal optimization.

FIG. 54 shows rake tooth placement.

FIG. 55 presents total gain response.

FIG. 56 provides gain control logic.

FIG. 57 illustrates ramp building with pulse integration=8.

FIG. 58 presents first and second stage acquisition frame format.

FIG. 59 depicts variance dataflow through the variance processor.

FIG. 60 shows moving average logic.

FIG. 61 depicts one combiner channel.

FIG. 62 illustrates dynamic rake operation.

FIG. 63 shows nulling operation.

FIG. 64 depicts demodulated ramps.

FIG. 65 presents the Rx (FEC) logic diagram.

FIG. 66 illustrates data sampling.

FIG. 67 presents sampling strategy.

FIG. 68 shows ADC sampling.

FIG. 69 presents VGA gain control.

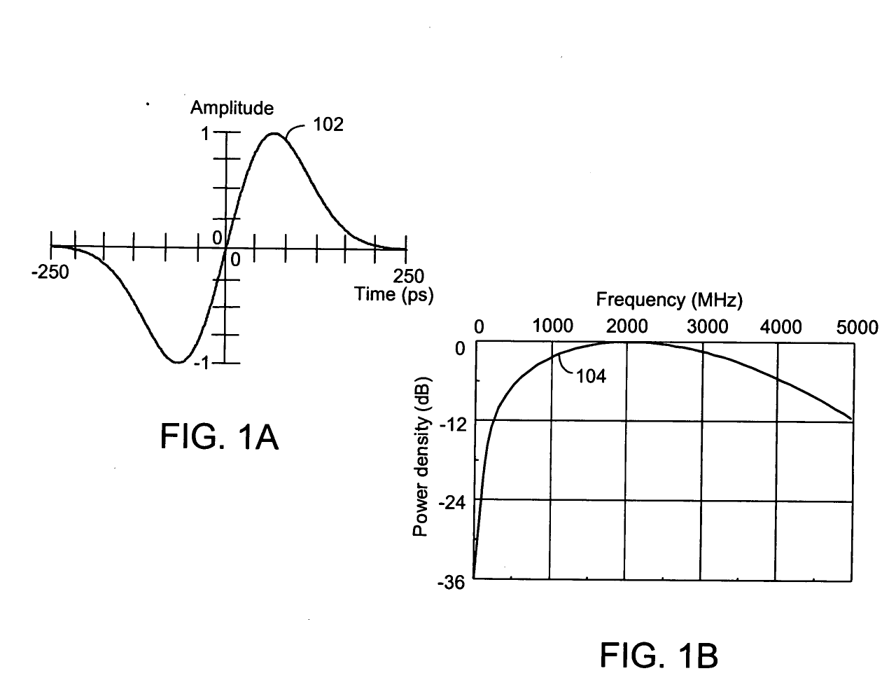

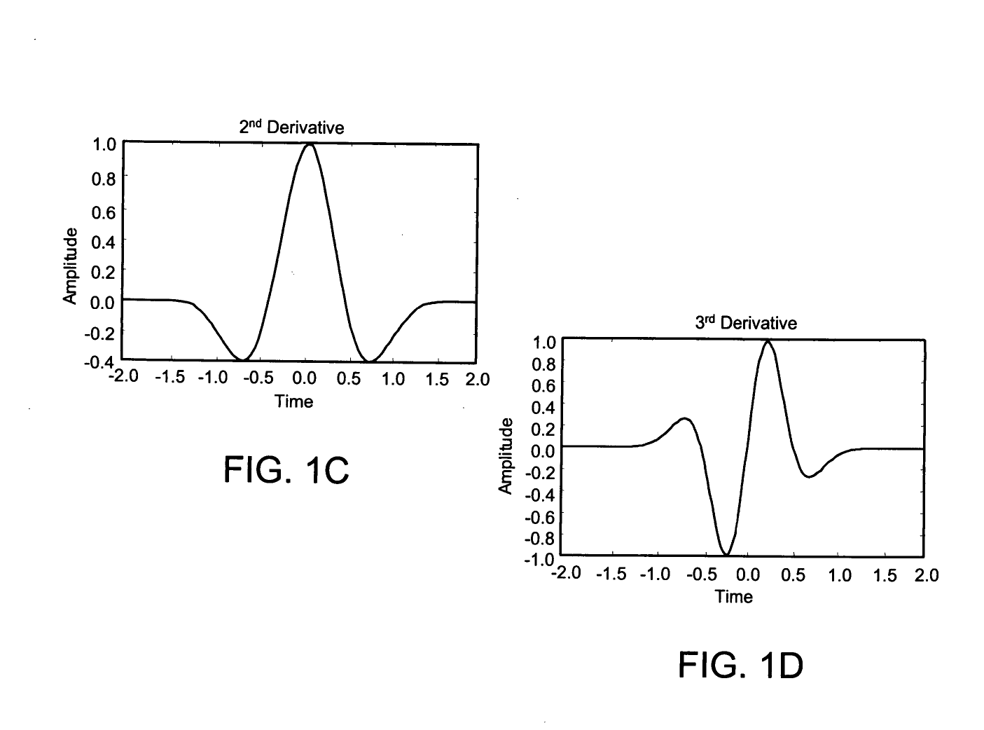

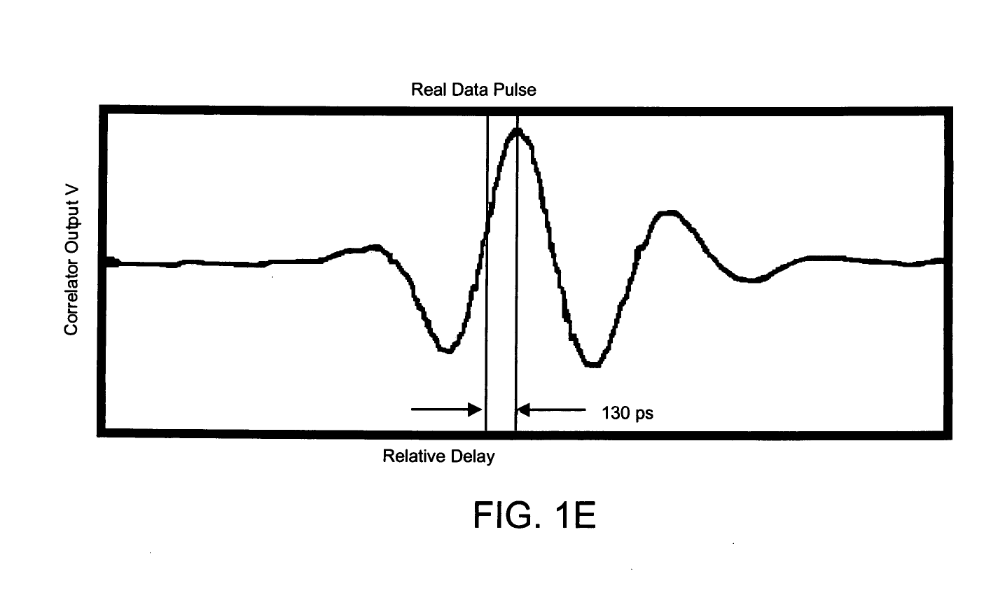

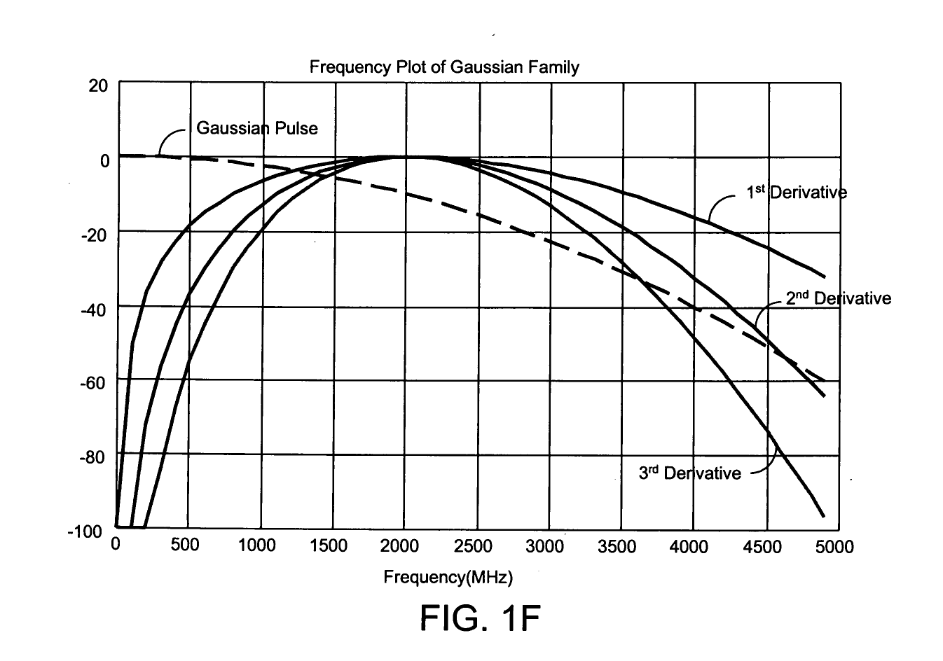

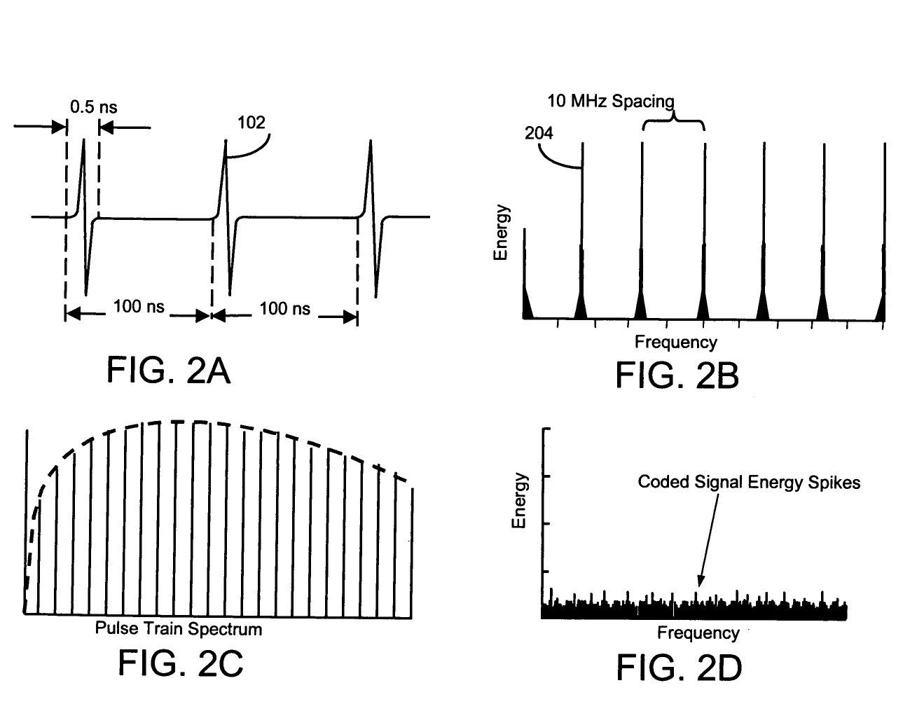

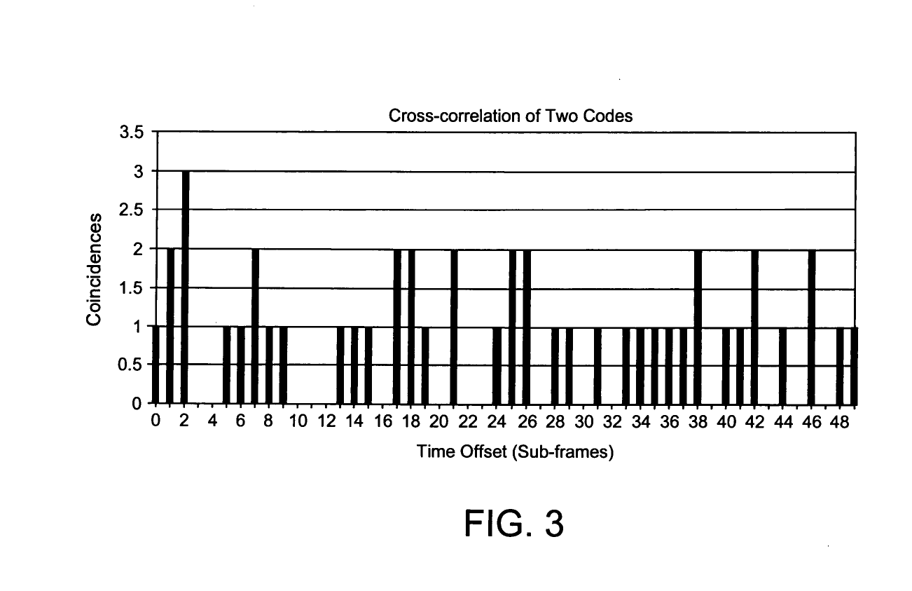

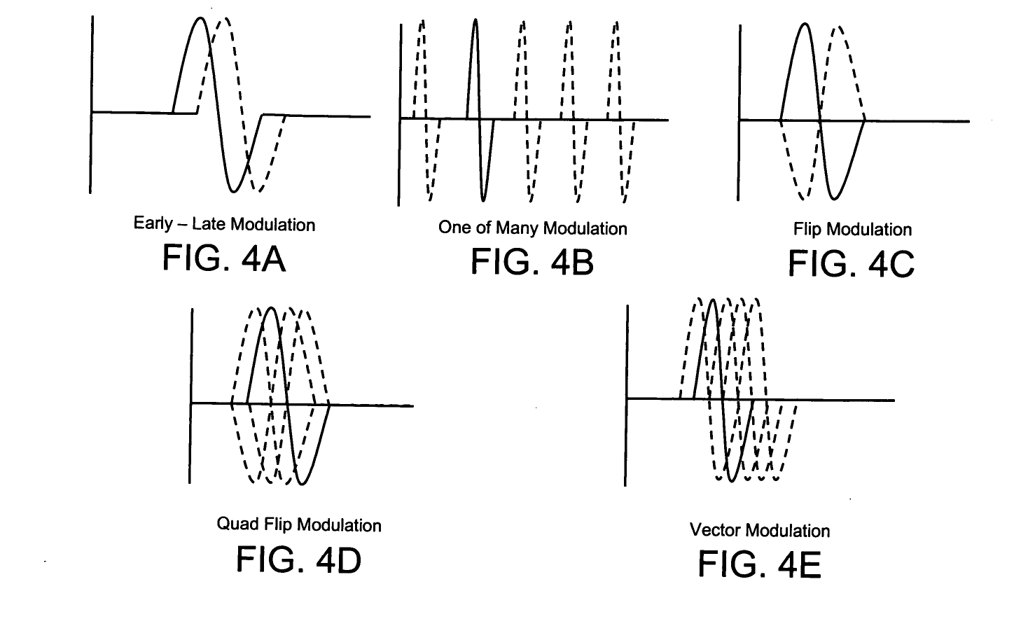

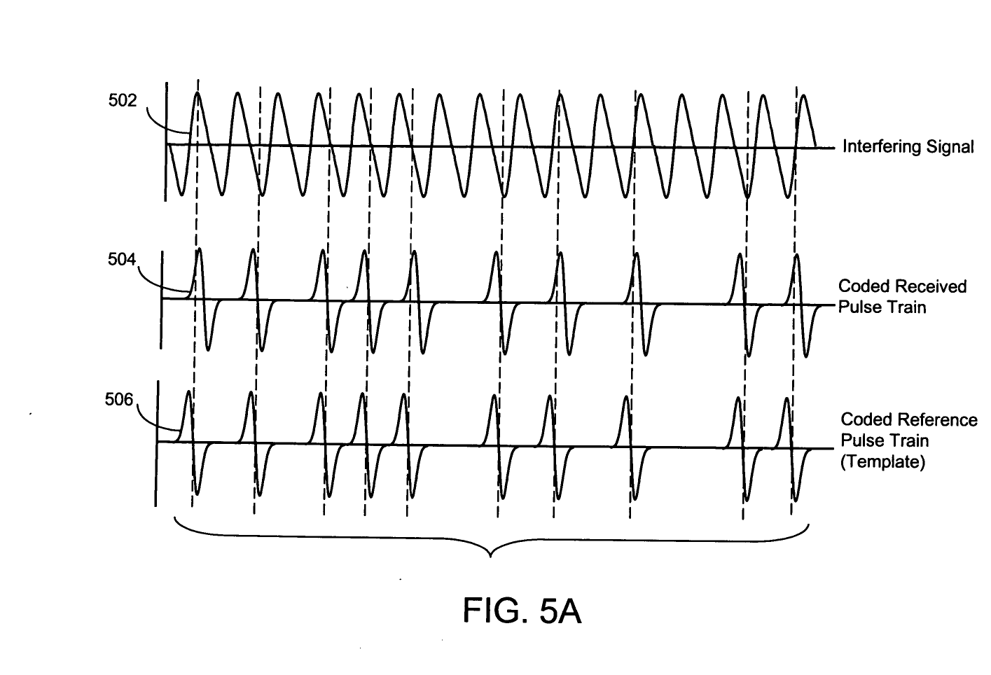

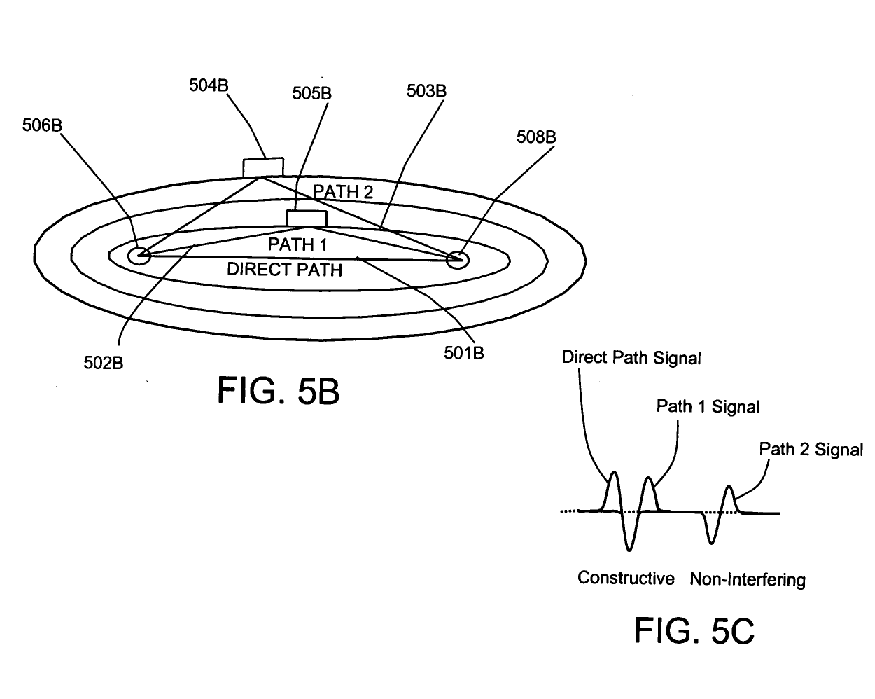

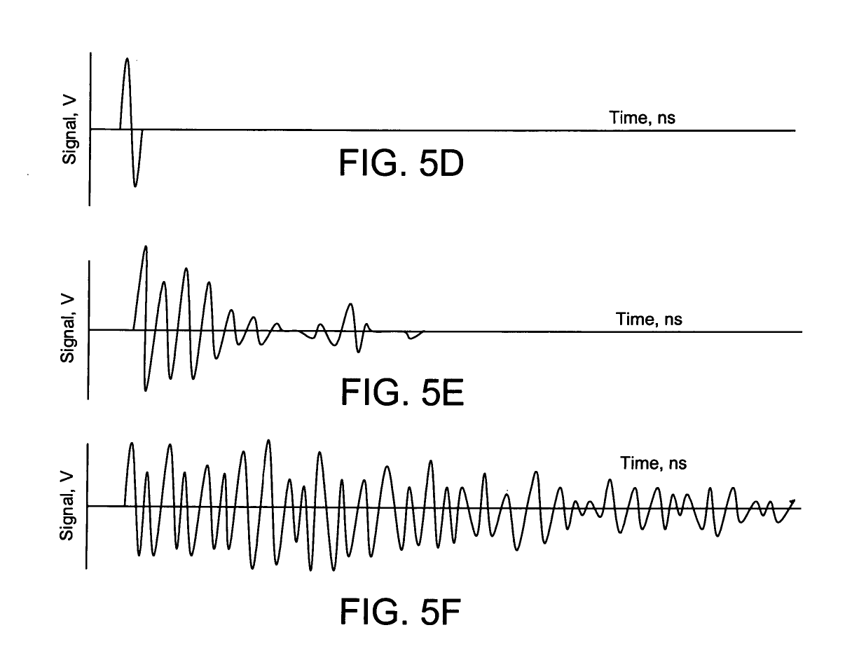

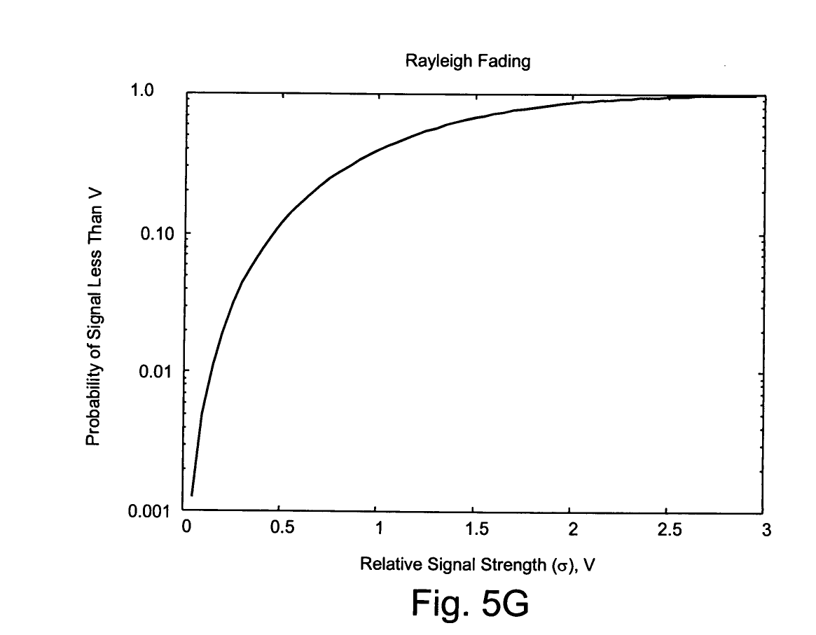

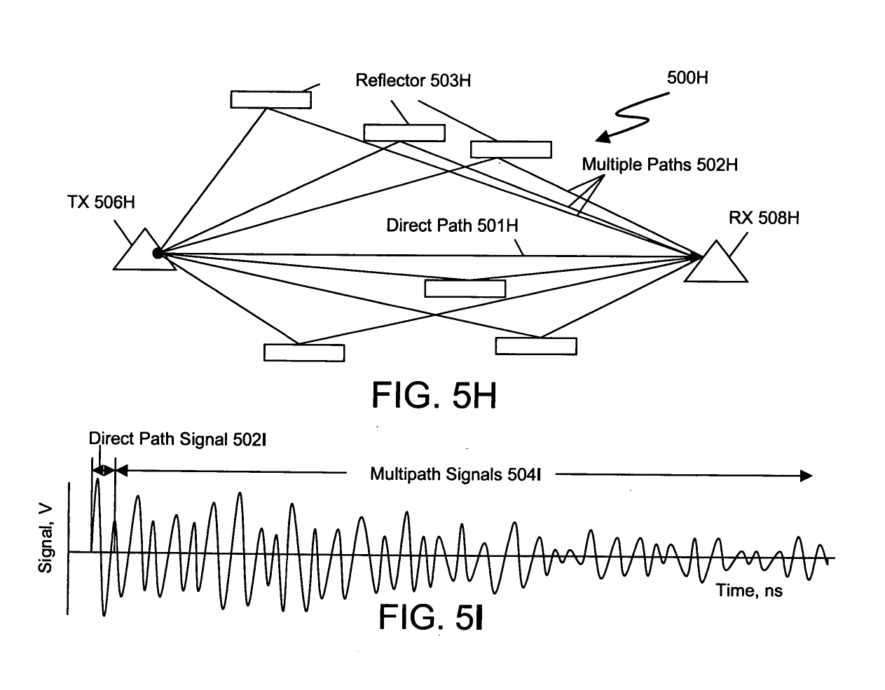

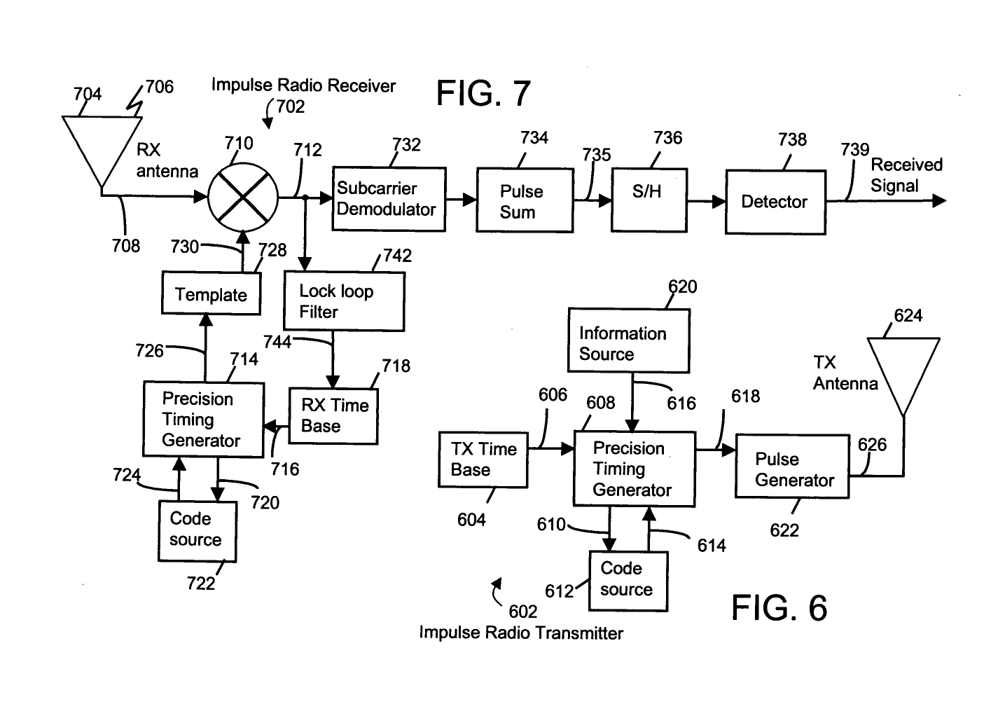

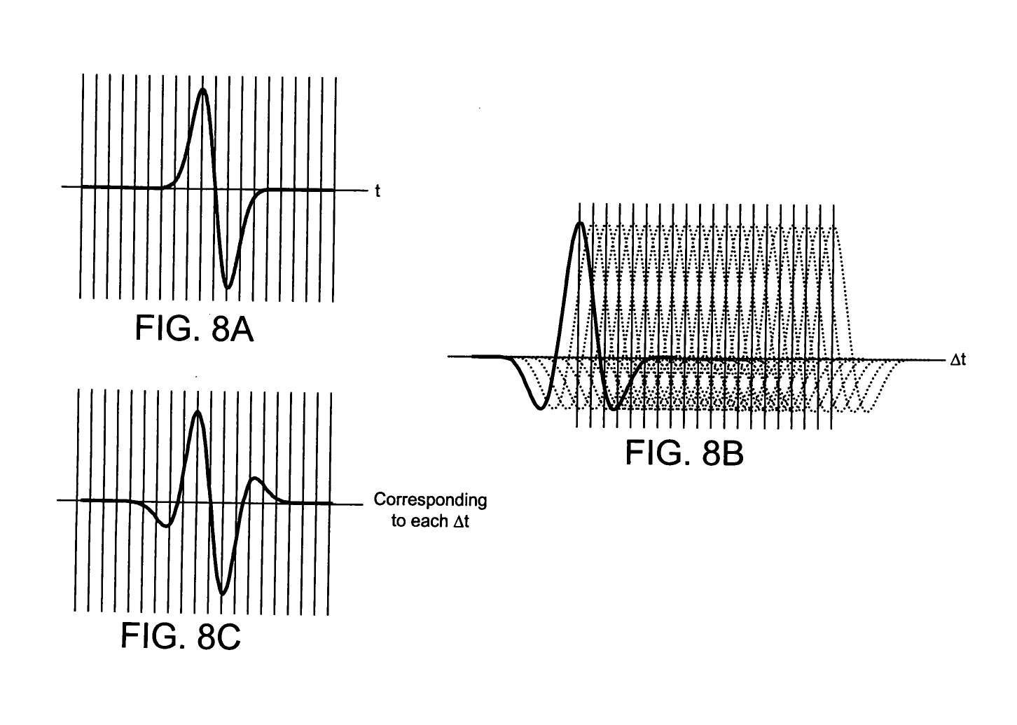

### DETAILED DESCRIPTION OF THE EMBODIMENTS

There are many approaches to UWB including impulse radio, direct sequence CDMA, ultra wideband noise radio, direct modulation of ultra high-speed data, and other methods. Therefore, the exemplary embodiment of the present invention is described in terms of an impulse radio system. However, it would be appreciated that the present invention can be applied to any UWB system, impulse or otherwise. In fact, some aspects of the present invention can be applied to non-UWB or conventional radio systems.

Introduction

PulsON® 200 Chipset

The present invention pertains to Ultra Wideband (UWB) impulse radio core technology implemented in a chipset, referred to by the inventors as the Time Domain® PulsON® 200 Chipset, which can be used to empower UWB devices capable of transmitting and/or receiving UWB signals to support RADAR; positioning, location, and tracking (PLT); and communications applications.

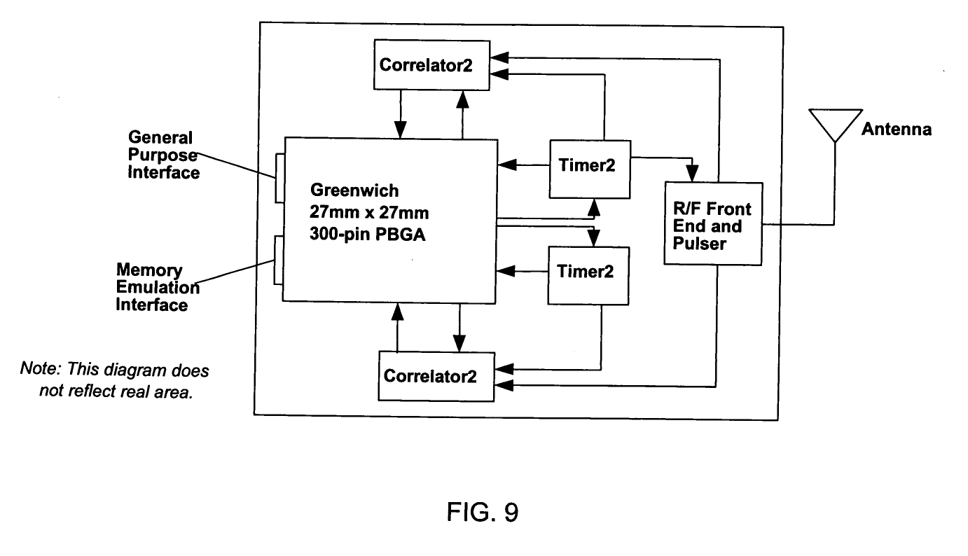

The PulsON® 200 Chipset, shown in FIG. 9, consists of a baseband processor device, referred to by the inventors as the Greenwich device, two dual-timer devices, two quad-correlator devices (Correlator2), an RF front end device, and a pulse device (shown as Timer2). The inventors also refer to the dual-timer and quad-correlator devices as Timer2 and Correlator2 devices, respectively. The Correlator2 devices include the circuitry for correlating a received signal with a template signal and providing a ramp signal that is generated by accumulating received pulse energy based on an integration length.

The Greenwich device provides all of the digital logic to perform acquisition, tracking, modulation and demodulation of the Ultra-Wideband (UWB) signals. The Greenwich device also operates the Timer2 and Correlator2 devices in order to transmit and receive UWB pulses. A commercially available processor device, such as an Advanced RISC Machine (ARM) device, and commercially available random access memory (RAM) & read-only memory (ROM) devices can control the chipset by setting up configuration registers, reading configuration registers, and optionally using Greenwich generated interrupt signals.

UWB Transmission and Reception

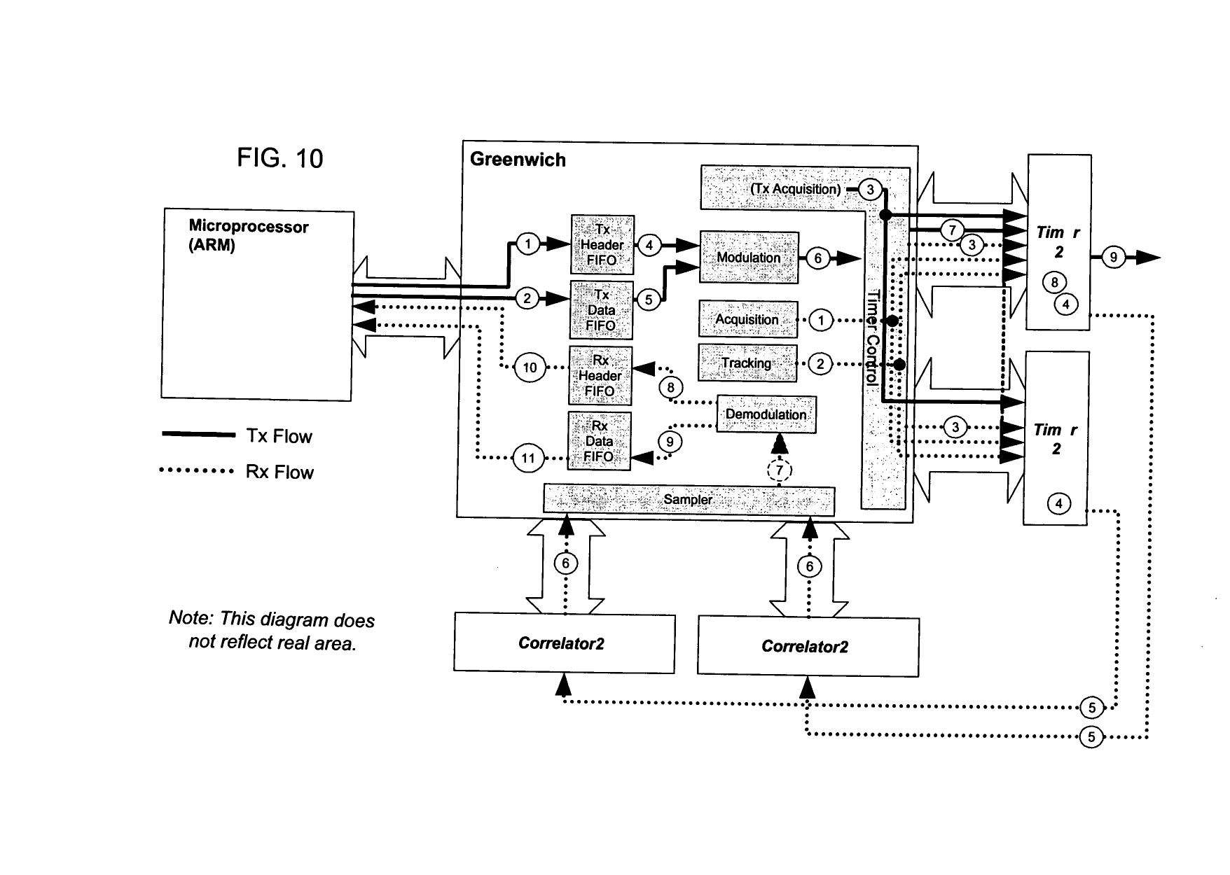

FIG. 10 illustrates the fundamental transmit (Tx) and receive (Rx) data flow of the PulsON® 200 chipset. The numbers shown in circles along solid lines correspond to Tx flow, and the numbers shown in circles along the dotted lines correspond to Rx flow.

Tx Flow

1) If an application requires a header, the external processor writes the desired transmit payload header into the Tx Header First In First Out memory buffer (FIFO).

2) The external processor writes the desired transmit payload data into the Tx Data FIFO.

3) If the application requires signal acquisition, a specialized acquisition pattern is sent.

4) If the application requires a header, a specified number of words are pulled from the Tx Header FIFO.

5) A specified number of words are pulled from the Tx Data FIFO.

6) The data is modulated according to the modulation technique specified in the configuration registers.

7) Corresponding frame-offset information is sent to a timer unit within a Timer2 device.

8) The timer unit generates trigger signals that correspond to the frame-offsets specified.

9) The trigger signals cause pulser circuitry (on-chip or off-chip) to generate UWB pulses.

Rx Flow

1) If the application requires signal acquisition, specialized acquisition algorithms find the transmitted signal.

2) If the application requires signal tracking, tracking algorithms keep up with the transmitted signal.

3) Frame-offset information corresponding to the anticipated incidence of UWB pulses is sent to a timer unit within a Timer2 device.

4) The timer unit generates trigger signals that correspond to the frame-offset specified.

5) The trigger signals cause, or otherwise fire, an independent correlator unit followed by a dependent correlator unit within a Correlator2 device to capture energy.

6) The energy captured by the correlator units is sampled.

7) The data is demodulated according to the demodulation technique specified in the configuration registers.

8) If the application requires a header, the received payload header is placed in the Rx Header FIFO.

9) The received payload data is placed in the Rx Data FIFO.

10) If the application requires a header, the external processor reads the received payload header from the Rx Header FIFO.

11) The external processor reads the received payload data from the Rx Data FIFO.

Typical Components of a PulsON™ 200 Chipset Transmission

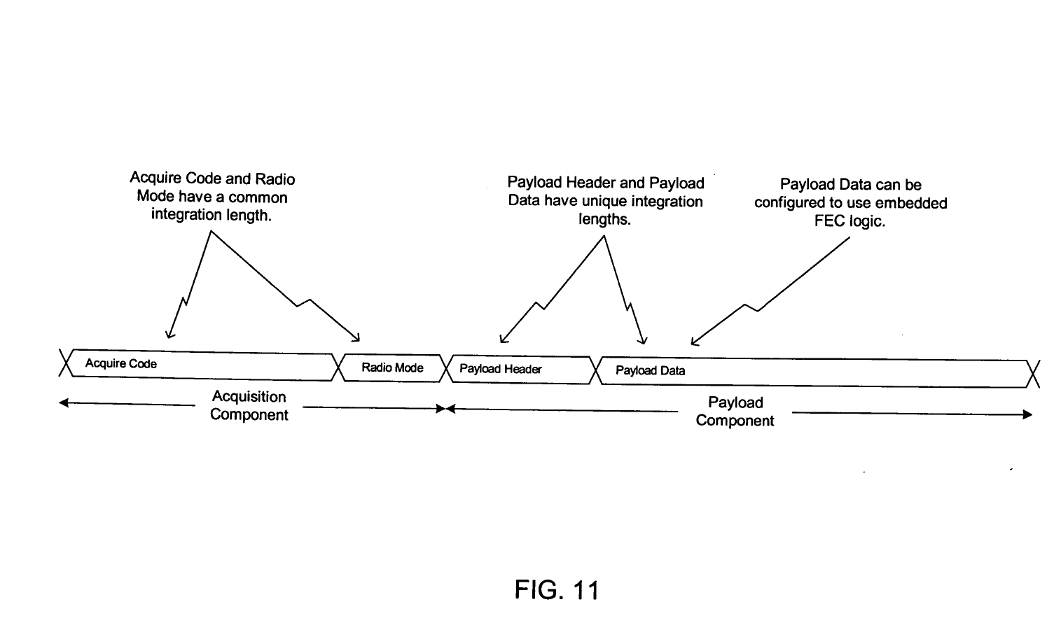

FIG. 11 presents the typical components of a PulsON® 200 Chipset transmission. While each piece of the transmission is optional, FIG. 11 represents an all-inclusive transmission and shows the relationship of each piece to the others. The transmission can be thought of as having two components: (1) Acquisition and (2) Payload. The acquisition component includes the acquire code and an 8-bit radio mode. The acquisition component is all sent with a common integration length (i.e., the number of pulse energies accumulated to create integration ramps). The acquisition code and radio mode are setup in various configuration registers. The payload component includes both the payload header and the payload data. The payload header and payload data are essentially the same except for three exceptions: (1) they have independent integration lengths, (2) they are loaded into and sourced by different FIFOs, and (3) only the payload data can be configured to use the on-chip Forward Error Correction (FEC) engines. While the payload header and payload data do have unique integration lengths, they do not have unique styles of modulation. In other words, they use the same style of modulation.

Greenwich Interfaces

The Greenwich device has four interfaces: Memory Emulation, General Purpose I/O, Timer2 and Correlator2.

Memory Emulation Interface

The Memory Emulation Interface allows the Greenwich device to transfer data to and receive data from the commercially available processor in either Static RAM (SRAM) or Synchronous Dynamic RAM (SDRAM) mode. The Memory Emulation Interface and Configuration Registers are described in more detail later in this specification.

General Purpose I/O Interface

The General Purpose I/O (GPIO) Interface can be used (1) for power management control signals, (2) to monitor external event trigger signals, (3) to control external variable attenuators, (4) to control serial devices, (5) to drive processor interrupts and/or Direct Memory Access (DMA) requests, or (6) for diagnostics. Configuring the General Purpose I/O Controller appropriately allows these important diagnostic signals to be monitored via the General Purpose Interface. The GPIO Interface logic is described in more detail later in this specification.

External Event Triggers

The General Purpose Interface can be used to monitor external event trigger signals. External event trigger signals can be read via the Greenwich configuration registers and/or can be used as trigger signals for the Greenwich master control logic, which is also referred to by the inventors as the Master Sequencer.

External Variable Attenuators

The General Purpose Interface can be used in RADAR applications to control external variable attenuators between a Low Noise Amplifier (LNA) and the Correlator2 chips.

Serial Devices

The General Purpose Interface can be used to control and program serial devices.

External Processor Interrupts and DMA Requests

The General Purpose Interface can be used to generate interrupts for external processors and DMA requests for external DMA engines. These internal signals can come from the Master Sequencer's Moore outputs, FIFO flags, or any other signal connected to the GPIO Controller logic module.

Diagnostics

The General Purpose Interface can be used to generate diagnostic signals.

Timer2 Interface

The Timer2 Interface connects the Greenwich device to two Timer2 chips. Each dual-timer chip contains two timer units. A timer unit precisely places (with 3 ps granularity) trigger signals within a 50 ns frame of time. This trigger signal activates pulser circuitry which can be on-chip or off-chip, causes a pair of correlator units to sample, and/or causes the Greenwich device to capture data from the correlator units. There are two categories of signals in the Timer2 Interface: (1) Synchronous Data and (2) Analog-to-Digital Converter (ADC) Trigger Signals.

Synchronous Data

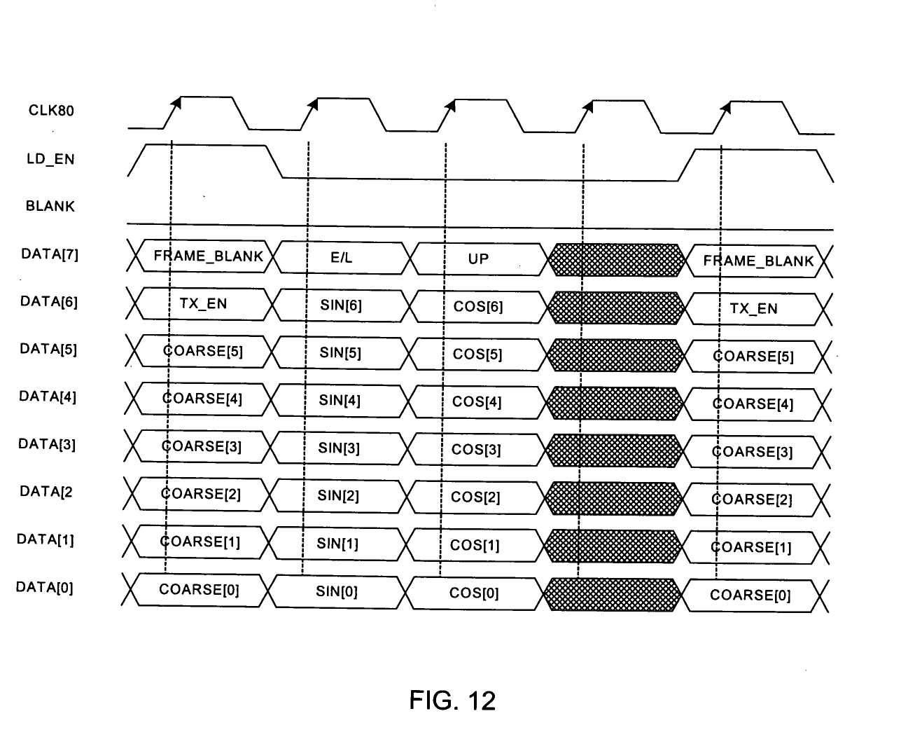

The Synchronous Data portion of the Timer2 Interface operates in response to a 80 MHz clock allowing the Greenwich device to transfer data to the Timer2 chips in a totally synchronous fashion. Essentially there is a blank signal, a load enable signal, and an eight-bit data bus for each of the four timer units. The signals included in this category are FRAME_BLANK (TA_BLANK, TB_BLANK, TC_BLANK, TD_BLANK), TA_LD_EN, TB_LD_EN, TC_LD_EN, TD_LD_EN, TA_DATA[7:0], TB_DATA[7:0], TC_DATA[7:0], and TD_DATA[7:0]. The blank signal is used to inhibit the generation of trigger signals. This feature allows reduced Pulse Repetition Frequency (PRF) operation of the chipset. The Synchronous Time Interface Load Diagram is provided in FIG. 12. The load enable signal initiates a three cycle loading procedure using the eight-bit data bus when asserted. On the first cycle, the data bus carries FRAME_BLANK, TX_EN and COARSE[5:0]. On the second cycle, the data bus carries E/L and SIN[6:0]. On the third cycle, the data bus carries UP and COS[6:0].

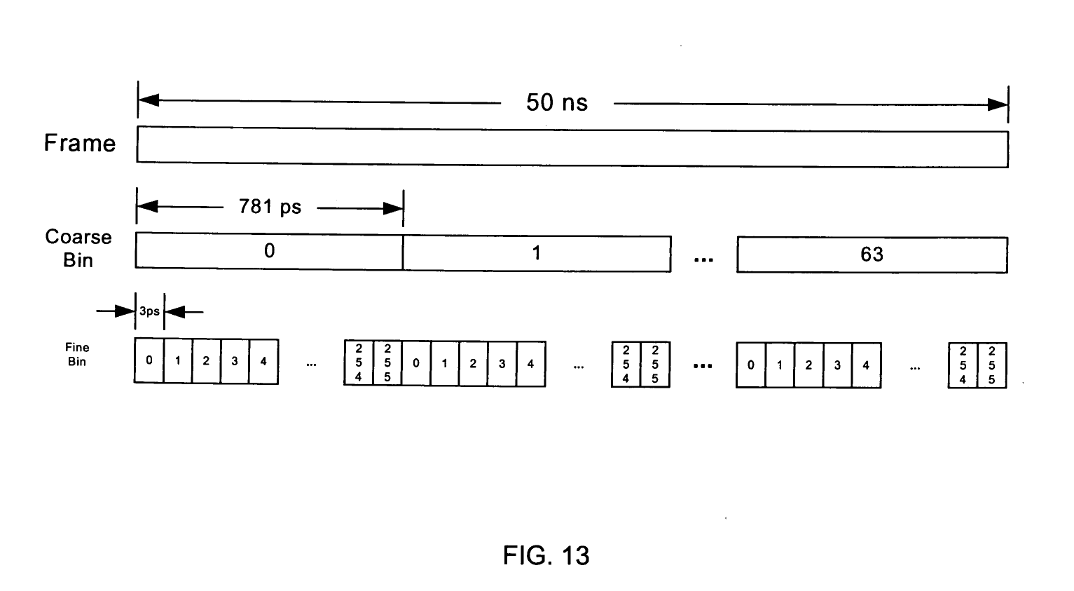

The COARSE[5:0], SIN[6:0], and COS[6:0] values loaded by the Greenwich device define the location of timer unit trigger signals within a 50 ns (20 MHz) frame of time as depicted in FIG. 13. A frame is divided into coarse bins that are further divided into fine bins. The coarse bin is selected directly by the COARSE[5:0] value, whereas the fine bin is generated using the output of an analog mixer circuit driven by the SIN[6:0] and COS[6:0] values.

The TX_EN value defines the use of the timer unit trigger. If TX_EN is asserted, then the trigger drives pulser circuitry (for transmitting UWB pulses). If TX_EN is deasserted, then the trigger drives the correlator unit and the Greenwich device (for receiving UWB pulses).

The E/L value is used to prevent meta-stable behavior by the latches that generate the triggers. If E/L is asserted, then the fine delay circuitry compensates for “Early” trigger signals. If the E/L is deasserted, then the fine delay circuitry compensates for “Late” trigger signals.

The UP value is used to select the polarity of UWB pulses for transmission. If UP is asserted the pulse is transmitted normally. If UP is deasserted, then the pulse is inverted.

ADC Trigger Signals

The ADC trigger signals from the Timer2 chips are used to signal the Greenwich device to sample data from the Correlator2 chips.

Correlator2 Interface Signals

The Correlator2 Interface Signals connect the Greenwich device to two Correlator2 chips, each comprising a quad-correlator. Each quad-correlator contains two, independent correlator units and two dependent correlator units (refered to as A, B, C, and D). Each correlator unit samples energy when triggered and converts it into an analog voltage. The independent and dependent correlator units receive their trigger from a corresponding timer unit. The independent correlator unit uses the trigger directly, whereas the dependent correlator unit uses an internally delayed version of the same trigger. Ideally the resulting triggers are separated such that the dependent correlator units captures energy 90° out of phase with respect to the energy captured by the independent correlator unit. As such, they are referred to as I and Q correlator signals. There are two categories of signals in the Correlator2 Interface: (1) Variable Gain Amplifier (VGA) Control and (2) ADC Data.

VGA Control

The Greenwich device provides signal-pairs to adjust the VGA gain on each These signals are driven by on-chip Digital-to-Analog Converters (DACs).

ADC Data

The Greenwich device receives eight signal-pairs associated with correlator unit data. Essentially there are four channels (A, B, C, and D) of differential data for an independent and dependent correlator unit. This data is captured each time the corresponding timer unit asserts its ADC trigger. These signals are received by on-chip ADCs.

3 Greenwich Logic Modules

Logic Module Overview

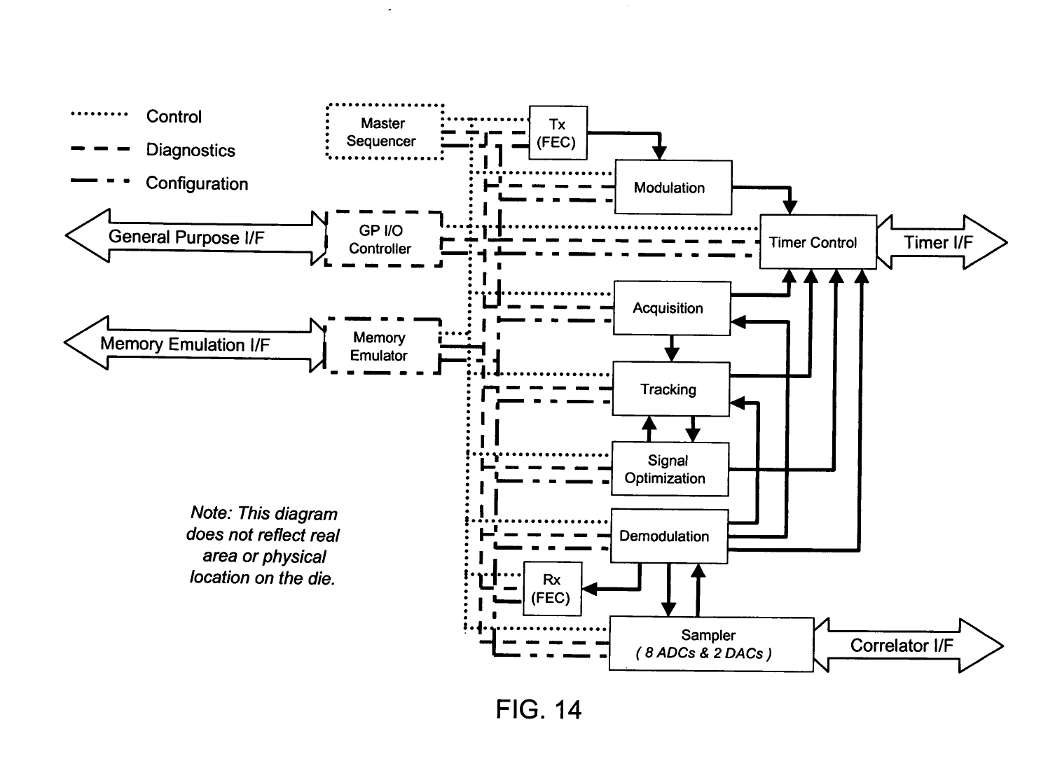

FIG. 14 illustrates the highest-level internal logic modules of the Greenwich device.

Each logic module contains configuration registers that can be read and written by an external processor using the Memory Emulation Interface. The Register Address Map is provided in Section ______ below.

[image]

[image]

[image]

Master Sequencer

One aspect of the present invention uses a programmable state machine that uses a memory based state control arrangement. More specifically, under this aspect, the “state” is determined based on a current memory address, as described later in more detail. The data contents in the current memory address are used for computation of the next address, i.e., the next state, as well as for determining the conditions required for a state transition. Consequently, the memory system of the controller can be organized to be as wide as necessary to give as much control as needed for controlling complex devices in any application. In one arrangement, the state transitions occur in one clock and “n-way branching” is also supported. Configuration is accomplished by writing to the memory locations during system initialization. Therefore, this aspect of the invention relates to a controller for controlling a device in response to control signals, where the control signals are provided by the data contents of the addressed memory, for example, in a standard memory system. Under this arrangement, the memory address relates to the state of the machine and the control decision parameters for computing the next memory address are provided by data stored in the memory address.

Bit-rate activities and, in some cases, packet-rate activities, are controlled by the Master Sequencer logic module. The Master Sequencer is a configurable state machine-based control architecture that interacts with the fine level logic modules to achieve a high level of flexibility while still maintaining sufficient high-speed/high-precision control.

The Master Sequencer (mseq) logic of the Greenwich provides a method for ordering (or ‘sequencing’) the operations of the Greenwich device. The Master Sequencer provides, through a variety of configuration registers, a means to specify processing modes, counting and fine timing, interrupts, and the general order of data processing. This is accomplished through a flexible state machine model in which the state definition, transition conditions, counter commands, and state outputs are specified through initialization of a set of master sequencer configuration registers. The Master Sequencer transition registers and state output registers can be programmed when the Memory Emulator logic's MasterReset register has the MseqSafemode bit asserted.

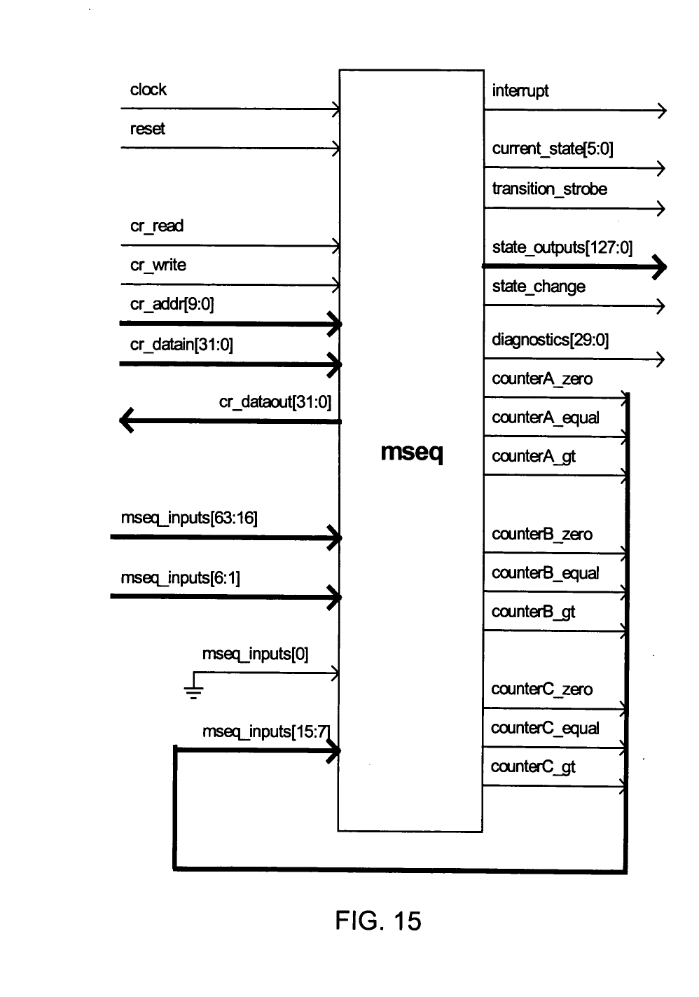

As depicted in the Master Sequencer Overview diagram shown in FIG. 15, the master sequencer logic has as input a high frequency (approximately 80 MHz) clock and a soft, active high, reset pin (MseqSafemode) from the Memory Emulator logic. The Configuration Register (CR) bus, which provides host processor access to the master sequencer's configuration registers, consists of cr_read, cr_write, 10 bits of cr_addr, and separate 32 bit wide cr_datain and cr_dataout channels. Although the CR bus is important to many facets of master sequencer operation, it is transparent to the host processor, which meets a RAM emulation interface.

The mseq_inputs bus consists of 64 logic signals from the various logic modules of the Greenwich chip. All of these input signals, like any state machine, are used as conditions that may trigger a state transition. Counter signals (counter*_zero, equal, and gt) are fed back to the Master Sequencer state machine in order to trigger transitions upon a number of counts, or after a specified time.

Master sequencer output signals include an interrupt that can be optionally generated upon any state transition. A standard setup would route this mseq interrupt signal through a GPIO pin to provide an external processor interrupt.

Each state of the sequencer drives 128 signals called state_outputs. The current_state at any time is used to select which 128 signals comprise the state_outputs bus. These signals are used to change the mode of operation of the various logic blocks. The single signal state_change is a pulse that goes high for one clock after a state change to provide a strobe for logic blocks to latch in their new mode.

The signal outputs of three counters internal to the master sequencer, counterA, counterB, and counterC, are fed back as inputs for triggering state transitions. Each counter has a “zero” signal (e.g., counterA-zero), which asserts when the counter value is equal to zero, an “equal” signal (e.g., counterA-equal), which asserts when the counter value is equal to its programmed threshold value, and a “gt” signal (e.g., counterA-gt), which remains high while the counter value is greater than its threshold.

The logic internal to the Master Sequencer that utilizes and drives these signals is explained in more detail in the following sections.

Implementation

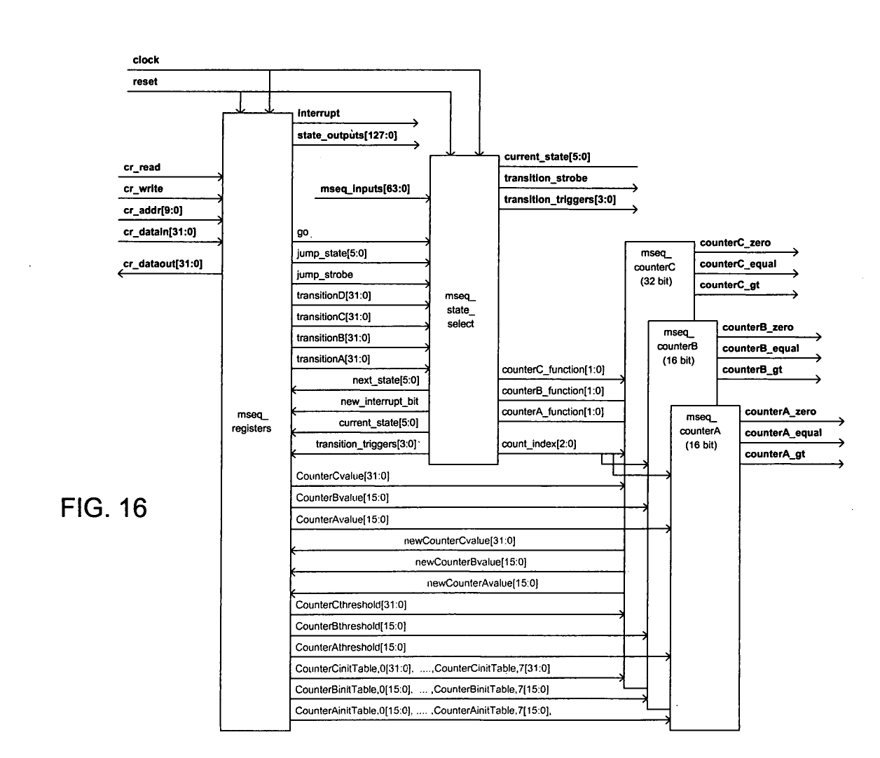

The signals previously described are produced and utilized by 5 interconnected logic blocks within the Master Sequencer. As depicted in FIG. 16, the mseq_registers block handles reading and writing the Master Sequencer configuration registers and produces signals essential to the mseq_state_select and msec_counter logic blocks. With a few added features, the mseq registers block basically provides the memory map of the Master Sequencer registers as defined in the Configuration Register Specifications section.

Referring to FIG. 16, the mseq_state_select module interacts with the mseq_registers module to form a functional state machine. The state machine may have up to 4 transitions out of any state, specified by transitionA, transitionB, transitionC, and transitionD registers. The state machine has a maximum of 64 states. The mseq_inputs bus provides input signals from other modules, which may conditionally trigger a change in the next_state output of the mseq_state_select logic. A change of next_state feeds back to mseq_registers and causes the transition and state_output registers to change at the next clock.

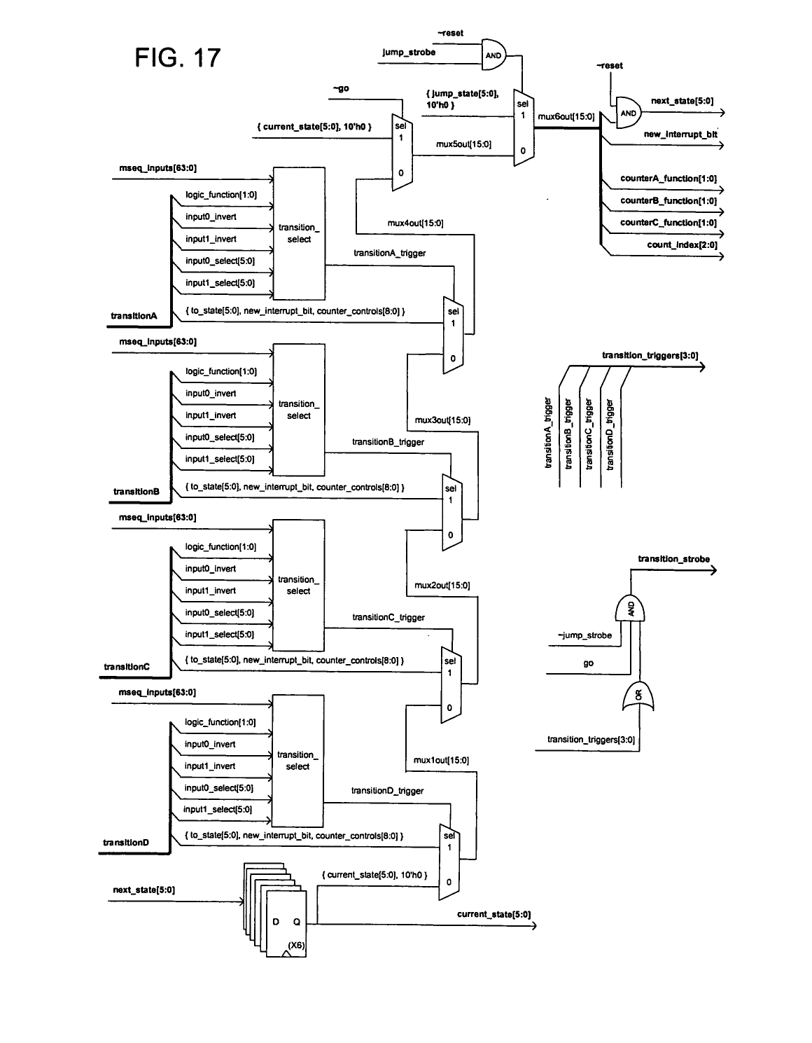

The mseq_state_select design diagram of FIG. 17 is a graphical depiction of the mseq_state_select logic. The primary purpose of the mseq_state_select logic module is to produce a prioritized selection of next_state[5:0], new_interrupt_bit, counter*_function, and count_index values. The next_state and new_interrupt_bit values are “clocked in” at the next clock assertion to become current_state and interrupt_bit. The other values (counter*_function and count_index) are continuously fed to the mseq_counters logic to drive counter actions.

Prioritized selection of these values is accomplished through a series of multiplexers and associated selection logic. As shown, the highest priority next_state update is its initialization to all zeros upon assertion of reset, indicating that the state machine always comes out of reset in state zero. The next highest priority field is jump_state[5:0], which, when selected by jump_strobe, overrides the results of the lower priority multiplexer. Jump_strobe and jump_state are inputs from mseq_registers that can be written by the processor for an asynchronous jump to any one of the 64 states available.

The next highest priority multiplexer (mux5) provides the ability to stay in current_state until the “go” signal is set. The “go” signal is a single bit in the control register of the Master Sequence configuration registers, which allows the processor to asynchronously hold the master sequencer in its current state. When the “go” bit is asserted, the next highest priority of values for next_state, new_interrupt_bit, counter*_function, and count_index are derived from the transitionA register. When transitionA_trigger is asserted, the to_state of the transitionA register is propagated forward as a possible next_state. Assuming there are no higher priority signal overrides for this to_state, it is selected as the next_state output of the mseq_state_select module. In addition, the new_interrupt_bit and counter_controls fields of transitions is propagated upon transitionA_trigger. Similarly, the transitionB, transitionC, and transitionD multiplexers and triggers have successively lower priorities for next_state update. Finally, the lowest priority field for next_state is current_state, allowing the state machine to stay in its current state if no other signals of higher priority cause a change.

The logic inputs, such as a ‘ramp_done’ pulse, are used to test each transition for a trigger. During each clock cycle the four transitions out of the current state are tested for validity. The data path multiplexer contains an implicit prioritization mechanism that selects transition A first, B second, C third, and D last. Thus, if transition select for B and C are valid in the clock cycle, but A is not, then the to_state field programmed into the B transition register is selected as the next state. The to_state number for the selected transition is latched as the current state upon the next clock, changing the transition memory address, activating a new set of 4 transition registers, thus completing the state machine cycle. Every clock in which one of the four programmed transition does not trigger, selects the current_state thereby implementing an implied ‘ELSE’ transition back to the current state when no transition occurs.

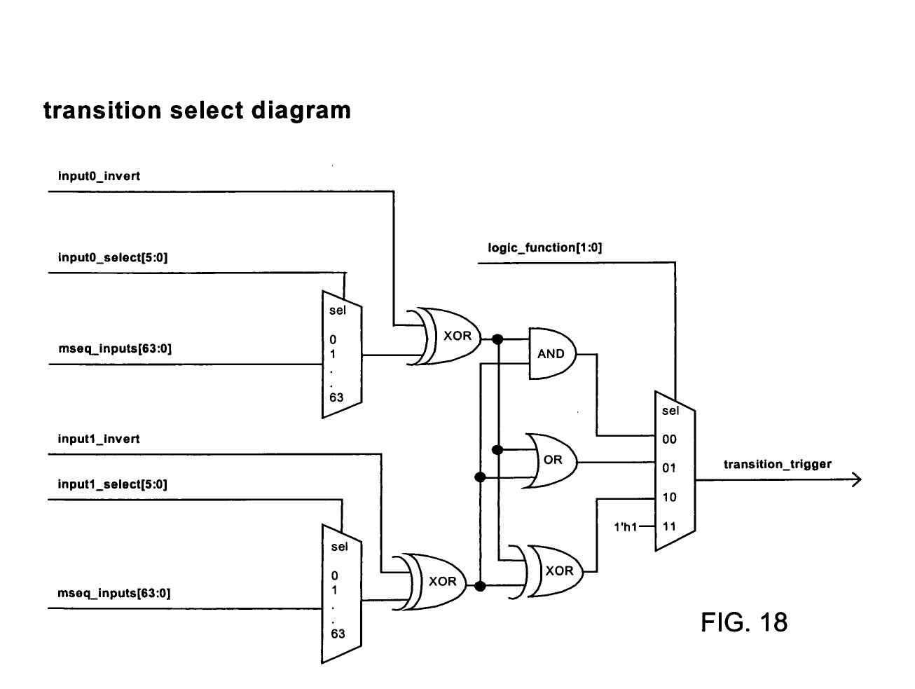

Details of the transition_selection logic, a sub-module to mseqstate_select, are provided in FIG. 18. For each transition, a pair of inputs are selected, optionally inverted (using the XOR gates), and combined by the logic AND, OR, or XOR functions. The logic function select bits from the transition description register are used to pick which output can affect the transition trigger.

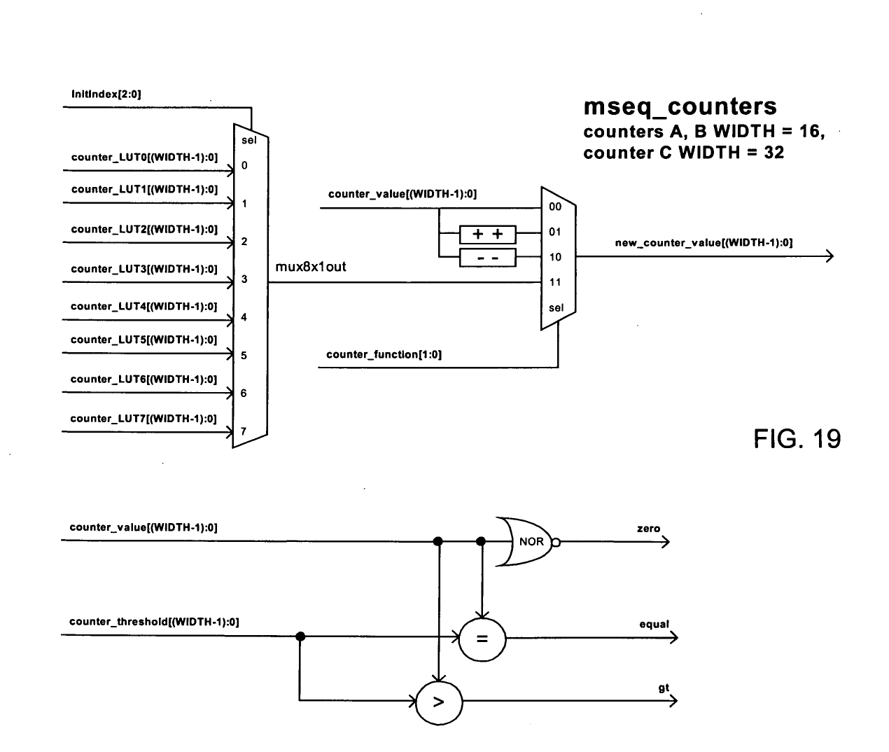

As depicted in the FIG. 19, there are 3 counters in the master sequencer for programming purposes. Each counter can be initialized by a transition or by a direct processor write to the appropriate counter*_value register. Each currently active count can likewise be read at the same address. Each transition contains one counter function for each counter A, B and C. When a transition is triggered, the counter implements either hold, increment, decrement, or load based on the counter function field. The Initindex field is used as an index to the counter Look Up Table (LUT) if the counter function is loaded.

A threshold value for each counter can also be initialized. The internal count value of the counter is continually compared to its threshold and the logic result is provided as zero, equal, or greater than the threshold. These outputs are fed back to the master sequencer as inputs and their value or inverse can be used as transition trigger signals.

Master Sequencer Inputs

Table 1 lists the 64 binary inputs from the Greenwich logic modules that can be selected to trigger a transition.

TABLE 1
Master Sequencer Selectable Inputs

| Input Number | Signal Name | Description |
|---|---|---|
| 0 | Zero | Zero (hard-coded de-assertion signal for transition condition logic). |
| 5:1 | GpioInput[4:0] | General Purpose IO Controller general purpose inputs. |
| 6 | FecPrimed | Indicates that the Tx fifo FEC data is ready to be transmitted. |
| 7 | CounterAzero | Indicates that Master Sequencer CounterAvalue == 0. |
| 8 | CounterAequal | Indicates that Master Sequencer CounterAvalue == CounterAthreshold. |
| 9 | CounterAgt | Indicates that Master Sequencer CounterAvalue > CounterAthreshold. |
| 10 | CounterBzero | Indicates that Master Sequencer CounterBvalue == 0. |
| 11 | CounterBequal | Indicates that Master Sequencer CounterBvalue == CounterBthreshold. |
| 12 | CounterBgt | Indicates that Master Sequencer CounterBvalue > CounterBthreshold. |
| 13 | CounterCzero | Indicates that Master Sequencer CounterCvalue == 0. |
| 14 | CounterCequal | Indicates that Master Sequencer CounterCvalue == CounterCthreshold. |
| 15 | CounterCgt | Indicates that Master Sequencer CounterCvalue > CounterCthreshold. |
| 16 | TimerAcquireSymbolDdone | Timer interface logic transmit acquire timer D ramp complete signal. |
| 17 | TimerAcquireSymbolCdone | Timer interface logic transmit acquire timer C ramp complete signal. |
| 18 | TimerAcquireSymbolBdone | Timer interface logic transmit acquire timer B ramp complete signal. |
| 19 | TimerAcquireSymbolAdone | Timer interface logic transmit acquire timer A ramp complete signal. |
| 20 | ContextDcodeWrap | Timer interface logic indicating repeat of Timer D code sequence. |
| 21 | ContextCcodeWrap | Timer interface logic indicating repeat of Timer C code sequence. |
| 22 | ContextBcodeWrap | Timer interface logic indicating repeat of Timer B code sequence. |
| 23 | ContextAcodeWrap | Timer interface logic indicating repeat of Timer A code sequence. |
| 24 | ContextDframeEnd | Timer interface logic indicating end of Timer D frame. |
| 25 | ContextCframeEnd | Timer interface logic indicating end of Timer C frame. |
| 26 | ContextBframeEnd | Timer interface logic indicating end of Timer B frame. |
| 27 | ContextAframeEnd | Timer interface logic indicating end of Timer A frame. |
| 28 | ContextDrollEnable | The roll enable signal from Timer D. |
| 29 | ContextCrollEnable | The roll enable signal from Timer C. |
| 30 | ContextBrollEnable | The roll enable signal from Timer B. |
| 31 | ContextArollEnable | The roll enable signal from Timer A. |
| 32 | ScanDbranch | Timer interface logic indicating a scan engine microsequence branch or end. |
| 33 | ScanCbranch | Timer interface logic indicating a scan engine microsequence branch or end. |
| 34 | ScanBbranch | Timer interface logic indicating a scan engine microsequence branch or end. |
| 35 | ScanAbranch | Timer interface logic indicating a scan engine microsequence branch or end. |
| 36 | ModSymbol Done | Modulation logic indicating a complete symbol modulated. |
| 37 | TxHfifoFull | Tx logic indicating the Tx Header FIFO is full. |
| 38 | TxHfifoAFull | Tx logic indicating the Tx Header FIFO is almost full. |
| 39 | TxHfifoAEmpty | Tx logic indicating the Tx Header FIFO is almost empty. |
| 40 | TxHfifoEmpty | Tx logic indicating the Tx Header FIFO is empty. |
| 41 | TxDfifoFull | Tx logic indicating the Tx Data FIFO is full. |
| 42 | TxDfifoAFull | Tx logic indicating the Tx Data FIFO is almost full. |
| 43 | TxDfifoAEmpty | Tx logic indicating the Tx Data FIFO is almost empty. |
| 44 | TxDfifoEmpty | Tx logic indicating the Tx Data FIFO is empty. |
| 45 | RxHfifoFull | Rx logic indicating the Rx Header FIFO is full. |
| 46 | RxHfifoAFull | Rx logic indicating the Rx Header FIFO is almost full. |
| 47 | RxHfifoAEmpty | Rx logic indicating the Rx Header FIFO is almost empty. |
| 48 | RxHfifoEmpty | Rx logic indicating the Rx Header FIFO is empty. |
| 49 | RxDfifoFull | Rx logic indicating the Rx Data FIFO is full. |
| 50 | RxDfifoAFull | Rx logic indicating the Rx Data FIFO is almost full. |
| 51 | RxDfifoAEmpty | Rx logic indicating the Rx Data FIFO is almost empty. |
| 52 | RxDfifoEmpty | Rx logic indicating the Rx Data FIFO is empty. |
| 55:53 | AcquireStatus[2:0] | Signal meaning can vary with acquisition mode - see table in Acquisition Logic section. |
| 57:56 | AcquireRampIndex[1:0] | The correlator that passed acquire threshold for long code acquisition (2′b00 = A, etc.). |
| 58 | SigoptDone | Indicates Signal Optimization done. |
| 59 | OldeDone | Indicates Open Loop Drift Estimation done. |
| 61:60 | SigoptLockIndex[1:0] | The correlator with the most energy during Signal Optimization scan (2′b00 = A, etc.). |
| 62 | SigoptLockIndexValid | Indicates that Signal Optimization lock index bits are valid. |
| 63 | DemodSymbolDone | Demodulation logic indicating a complete ramp has been built. |

TABLE 2
Master Sequencer State Outputs

| Output Number | Signal Name | Description |
|---|---|---|
| 3:0 | TimerDmode[3:0] | Timer mode table is maintained in the Timer Control section. |
| 7:4 | TimerCmode[3:0] | Timer mode table is maintained in the Timer Control section. |
| 11:8 | TimerBmode[3:0] | Timer mode table is maintained in the Timer Control section. |
| 15:12 | TimerAmode[3:0] | Timer mode table is maintained in the Timer Control section. |
| 16 | TimerContextDenable | Selects timer context for offline context snap or restore-see the Timer Control section. |
| 17 | TimerContextCenable | Selects timer context for offline context snap or restore-see the Timer Control section. |
| 18 | TimerContextBenable | Selects timer context for offline context snap or restore-see the Timer Control section. |
| 19 | TimerContextAenable | Selects timer context for offline context snap or restore-see the Timer Control section. |
| 23:20 | TimerContextAddress[3:0] | Offline context address, which is snapped or restored when Timer context strobe is asserted. |
| 25:24 | TimerContextMode[1:0] | Snap or restore offline context command —refer to the Timer Control section. |
| 26 | TimerContextStrobe | Strobe for executing Timer context snap or restore command. |
| 27 | TimerScanDrun | Selects scan engine for D timer to start when scan strobe is asserted. |
| 28 | TimerScanCrun | Selects scan engine for C timer to start when scan strobe is asserted. |
| 29 | TimerScanBrun | Selects scan engine for B timer to start when scan strobe is asserted. |
| 30 | TimerScanArun | Selects scan engine for A timer to start when scan strobe is asserted. |
| 31 | TimerScanStrobe | Strobe signal for beginning scan engine microsequence(s) based on run and address values. |
| 36:32 | TimerScanAddress[4:0] | Scan engine microcode address which is active when scan strobe is asserted. |
| 37 | TimerSnapStrobe | Stores the timer active contexts in Timer config memory for inspection by host processor. |
| 38 | TimerSigoptMode | Enables Signal Optimization to control Timer context save/restore signals. |
| 39 | TimerNullingMode | Allows Demodulation frame offset adjustments during nulling demodulation. |
| 42:40 | AcquireMode[2:0] | Mode command for acquisition logic —refer to acquisition logic section. |
| 43 | DemodFifoSelect | Specifies the target FIFO and demod integration length: 0 for Data Payload, 1 for Data Hdr. |
| 44 | DemodAcquireMode | Specifies header or data mode: 0 for Data, 1 for Acquire header support. |
| 45 | DemodTrainMovAvg | Initializes the moving average training sequence in the demodulation logic. |
| 47:46 | SigoptMode[1:0] | Mode command for the Signal Optimization logic. 0: reset; 1: enable. |
| 49:48 | OldeMode[1:0] | Mode command for the OLDE logic. 0: reset; 1: enable. |
| 52:50 | TrackingLoopSelect[2:0] | Specifies Timer control for the tracking loop. Refer to the tracking logic section for details. |
| 54:53 | TrackingRampSelect[1:0] | Specifies where the tracking loops gets ramps. Refer to the tracking logic section for details. |
| 55 | TrackingArun | Enables closed loop tracking for Timer/Correlator A. |
| 56 | TrackingBrun | Enables closed loop tracking for Timer/Correlator B. |
| 57 | TrackingCrun | Enables closed loop tracking for Timer/Correlator C. |
| 58 | TrackingDrun | Enables closed loop tracking for Timer/Correlator D. |
| 62:59 | TrackingMode[3:0] | Sets the configuration of the Offset LUT for Tracking. Refer to the Tracking logic section. |
| 63 | DemodRun | Runs Demod. |
| 64 | DemodGainRun | Activates auto VGA gain adjustment. |
| 65 | DemodGainEnable | Set in all states where automatic VGA gain control is used. |
| 67:66 | DemodOutputMode[1:0] | Specifies Rx Fifo format —0: none; 1: ramps; 2: raw samples; 3: demod bits. |
| 68 | SigoptClock | Enables the clocks for the Signal Optimizer logic. |
| 69 | AcquireClock | Enables the clocks for the Acquisition logic. |
| 70 | DemodClock | Enables the clocks for the Demodulation logic. |
| 71 | ModulationClock | Enables the clocks for the Modulation logic. |
| 72 | TimerDclock | Enables the clocks for the Timer D interface logic. |
| 73 | TimerCclock | Enables the clocks for the Timer C interface logic. |
| 74 | TimerBclock | Enables the clocks for the Timer B interface logic. |
| 75 | TimerAclock | Enables the clocks for the Timer A interface logic. |
| 76 | TrackingDclock | Enables the clocks for the Tracking logic associated with timer D. |
| 77 | TrackingCclock | Enables the clocks for the Tracking logic associated with timer C. |
| 78 | TrackingBclock | Enables the clocks for the Tracking logic associated with timer B. |
| 79 | TrackingAclock | Enables the clocks for the Tracking logic associated with timer A. |
| 80 | SamplerClock | Enables the clocks for the ADC sampling interface logic. |
| 81 | ModHeaderGo | While asserted, mod logic reads bits from Tx hdr fifo, modulates, and sends to timer I/F logic. |
| 82 | ModDataGo | While asserted, mod logic reads bits from Tx data fifo, modulates, and sends to timer I/F |
| | | logic. |
| 83 | AdcFifoRun | While asserted, ADC fifos are active. |
| 84 | VgaGainDacEnable | While asserted, the DAC which controls external VGA gain is enabled. |
| 94:85 | DiagSelect[9:0] | Selects diagnostic signals from each of the logic modules to form GPIO selectable outputs. |
| 95 | TrackForwardRamp | Mark transitions in Rx where ramps are irregularly spaced. |
| 125:96 | GPIO Output[29:0] | Master Sequencer GPIO selectable outputs. |
| 127:126 | Reserved | |

General Purpose I/O

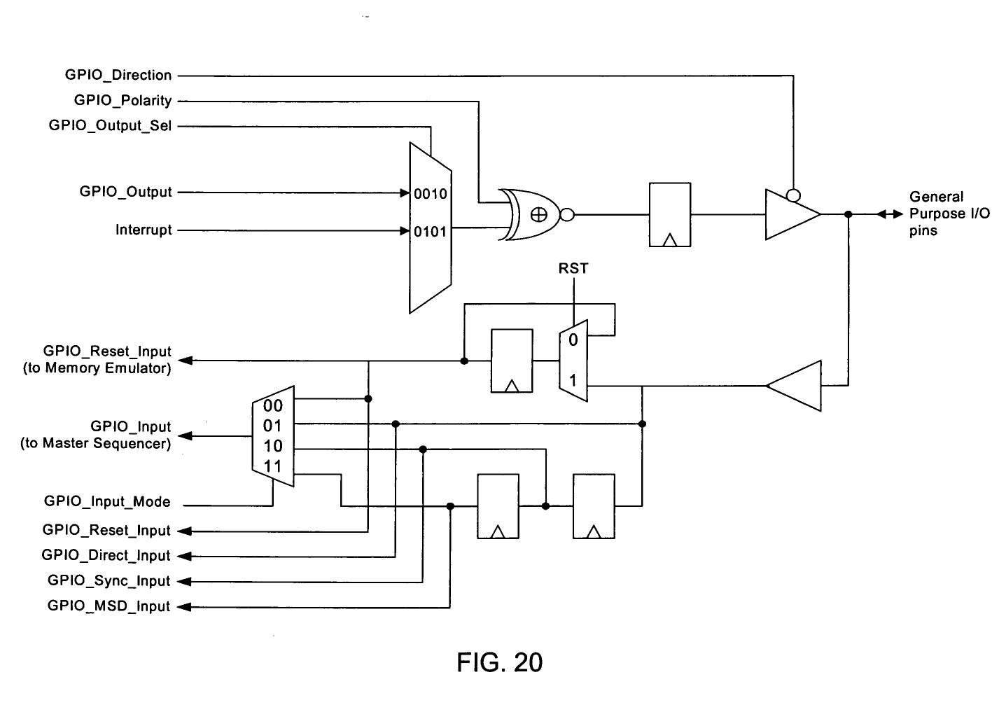

In order to provide the maximum flexibility with the least amount of pin consumption, There are thirty GPIO pins on the Greenwich device that can be configured for use as either inuts or outputs. The structure of each General Purpose I/O is shown in FIG. 20.

Memory Emulator

The Memory Emulator logic module provides configuration and informational registers, such as the Memory Emulator Interface Mode, the Device ID, and the Code ID registers. The Interface Mode register configures the memory data width and memory interface type. The Device ID and Code ID registers allow the Greenwich device and its firmware to be uniquely identified. These ID registers serve an informational purpose only. The Memory Emulator logic module allows the Greenwich to be attached to an external processor in such a way that the external processor perceives the Greenwich as a memory device (i.e. memory-mapped configuration registers). The SDRAM mode is available to use with more modern, aggressive performing processors, while the SRAM mode is available to support older, less expensive processors. By using one of these two memory modes, the Greenwich can operate with a large set of potential processors. The Memory Emulator logic module cannot be operated in SDRAM and SRAM mode simultaneously. Both the SDRAM and SRAM modes offer variable memory data width interfaces.

Alternatively, these three GPIO pins can be driven by an external processor along with the Greenwich reset, which allows the three GPIO pins to be reprogrammed for other uses after reset. The Memory Emulator transfers information between SDRAM or SRAM and the configuration registers within each logic module. Depending on the data width of the memory being emulated, the Memory Emulator bundles multiple sub 32-bit accesses into one common access of the internal 32-bit configuration registers. For example, in order to perform a full 32-bit wide write while in 8-bit SRAM mode, four consecutive writes are executed. All of the internal 32-bit configuration registers are on 32-bit boundary word addresses.

Tx (FEC)

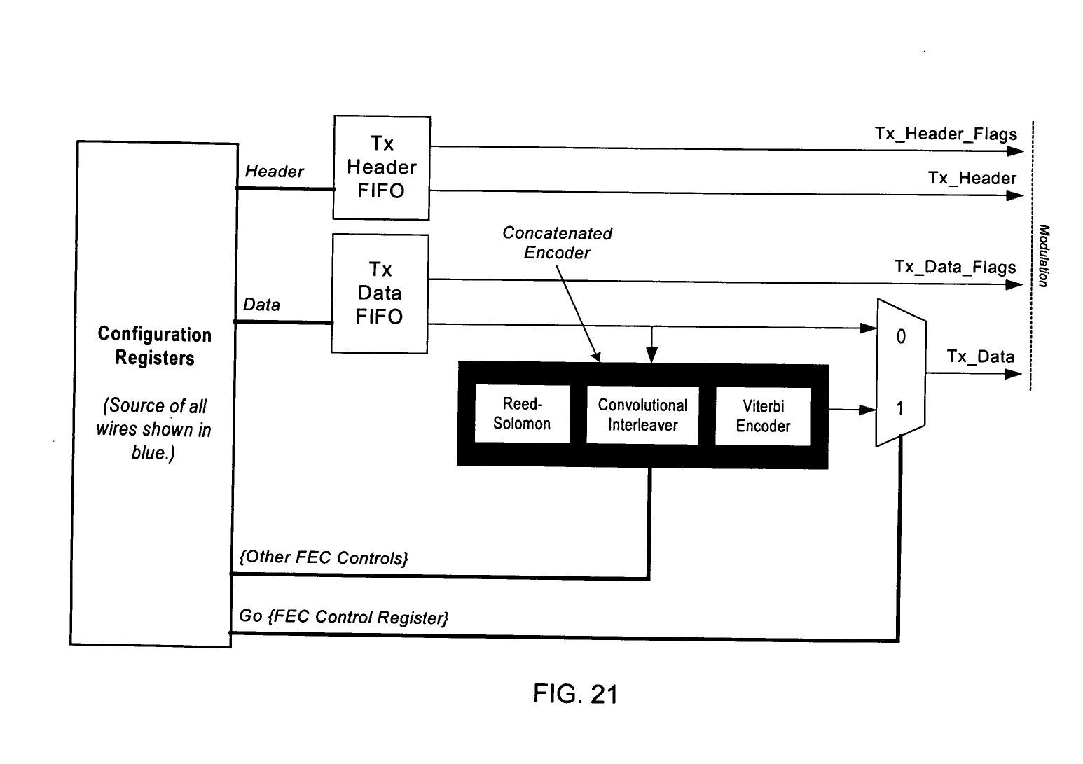

The Tx (FEC) logic module, shown in FIG. 21, stores data intended for transmission as UWB pulses. There are two FIFOs in this design, one for the payload header (the Tx Header FIFO) and one for the payload data (the Tx Data FIFO). The Tx Header FIFO and Tx Data FIFO are 32 byte wide by 64 byte deep (2K byte total) and 32 byte wide by 1 K byte deep (32 K byte total), respectively. The external processor can preload one or both FIFOs, or it can keep the corresponding FIFOs sufficiently filled during the transmission of a packet. Data from the Tx Data FIFO can be configured to flow through zero or more FEC engines including Reed-Solomon, Convolutional Interleaving plus Viterbi, and a concatenated encoder. The data resulting from the Tx Header FIFO and the Tx Data FIFO (potentially post-FEC) are fed to the Modulation logic module. The Tx (FEC) logic module can operate in two modes: Non-Interleaver and Interleaver modes.

Non-Interleaver Mode

During Tx, 32-bit words are pulled from the Tx Data FIFO, encoded by the FEC unit and then modulated and transmitted. The FEC unit first encodes the data using a Reed-Solomon encoder. The Reed-Solomon unit is a block encoder that adds a fixed number of bytes to the data stream for each block. The block size (N) is one of 255, 127, or 63 bytes, and is selected by writing N−1 into the Tx FecMode register. A ‘tact’ parameter informs the Reed-Solomon encoder to allow for tact correctable errors per block. In practice, the higher the value for “tact” parameter, the less user data is transmitted per block. The number of user bytes per block is known as ‘K’. The value of K is determined by the following formula:

K=N−2*tact

Additionally, a Viterbi 2-to-1 convolutional encoder further encodes the output from the Reed-Solomon encoder, before sending it to the modulation unit.

The following rules can be followed during transmission in the Non-Interleaver mode:

1) In order to get the benefit of Reed-Solomon error checking on the Rx side, the user's data buffer can be a multiple of ‘K’ 32-bit words. Any amount of data cab be chosen for transmission, but if the buffer is not a multiple of K, then the last Reed-Solomon block of data received would not contain error statistics in the Rx FEC registers.

2) A common method of running the Master Sequencer on the transmit side is for the Master Sequencer to decrement a counter each time modulation completes a symbol. If the FEC is not enabled, then the following formula can be used:

count=32*numUserWords

But with the FEC enabled, the following formula can be used:

count=32*numUserWords*(N/K)*2

3) The count above is an even integer.

4) The processor could pre-load all or part of the user's data into the Tx Data FIFO before any transmission has begun.

5) The Master Sequencer could make use of low- or high-water marks associated with the Tx Data FIFO to generate an interrupt (or assert a GPIO pin). The processor can then continue to fill the FIFO while transmission is in progress. For example, the Master Sequencer can be programmed to assert one GPIO pin when the low water mark is reached, and assert another GPIO pin when the high water mark is reached. The processor can then continue filling the FIFO whenever the low water mark is reached and terminate the filling operation whenever the high water mark is reached. This way, the processor does not need to be concerned with the exact count of words in the FIFO at any given instant.

6) Because of the length of the data pipeline through the Modulation logic module, extra words may be fetched from the Data FIFO that are not actually transmitted.

Interleaver Mode

The purpose of an interleaver is to “mix-up” the data stream so that the effect of any burst errors in the raw channel data stream is minimized. Any burst error is spread out on the receiver side by a de-interleaver. When using the interleaver, the user's Tx data is preceded by a number of 32-bit words to “prime” the interleaver for each transmitted packet. Furthermore, the user's data is appended with a number of 32-bit words. The purpose of these trailing words is to ensure that all of the user's data is pushed completely through the interleaver pipeline and transmitted to the receiver.

The following rules can be followed during transmission, if the interleaver is enabled:

1) After the processor fills the Tx Data FIFO with all or part of the data packet, the master sequencer waits until the FecPrimed signal is received before starting to transmit the acquisition header.

2) Leading zero words are inserted in the Data FIFO before the user's data. The number of words required is determined by the following formula:

numLeadZeros=K*M

Where M is one of:

If N=63, then M=8

if N=127, then M=4

if N=255, then M=2

3) Trailing zero words are inserted in the Data FIFO after the user's data. The number of trailing zero words required is the same as the number of leading zero words.

4) A common method of running the Master Sequencer on the transmit side is for the MasterSequencer to decrement a counter each time modulation completes a symbol. If the FEC is not enabled, then one would use the following formula:

count=32*numUserWords

But with the FEC and interleaver enabled, the following formula is used:

count=int(ceil(32*(numUserWords+numTrailingZero Words)*(N/K)*2))

5) Because of the length of the data pipeline through the modulation unit, extra words may be fetched from the Data FIFO that are not actually transmitted.

Programming Tx Registers

When programming the Tx FIFO registers, the following rules are followed:

The HeaderWaterMarks and DataWaterMarks registers are written first.

The HeaerControl and DataControl registers are written next.

The FecMode register is written next. Note that N−1, not N, is written to the FecMode register.

The HeaderData are written into the Tx header FIFO.

The first part of the user's data are written into the Tx Data FIFO. The remainder can be written when the Data FIFO low-water mark is asserted.

Modulation Logic Module

Overview

The Modulation logic module is responsible for pulling Tx Header and Tx Data information, generating the proper frame offset information, and passing on that information to the Timer Control logic. The Master Sequencer and a hard-coded Modulation State Control logic control this process. The four forms of modulation supported are (1) Flip Modulation, (2) Fine-Shift Modulation, (3) Quadrature-Flip Time Modulation (QFTM), and (4) 4-position Multi-Position Modulation (MPM) with QFTM. Flip Modulation, QFTM, and MPM with QFTM are further described in co-pending U.S. patent application Ser. Nos. 09/875,290 and 09/537,692, which are incorporated herein by reference.

The following four sections describe those forms of modulation, absent any data whitening or integration. The corresponding state figures illustrate the UWB pulses that would result if no whitening and no integration were performed on the data prior to hand-off to the Timer Control logic. Data whitening and integration can occur in the last stages of the modulation logic and are therefore addressed later.

Flip Modulation

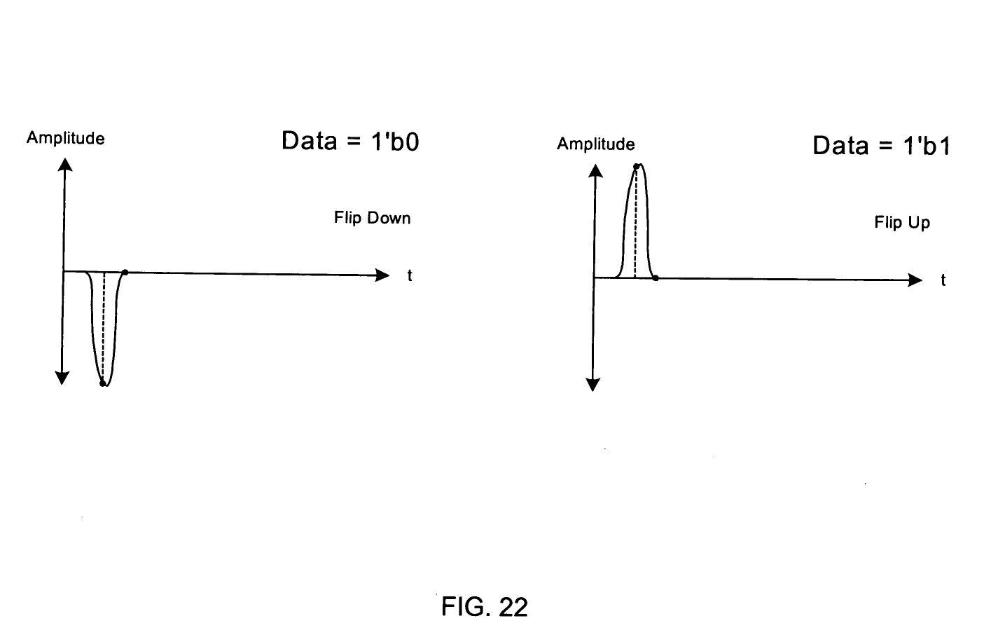

Flip Modulation simply uses one bit of data to transmit either a high going or a low going UWB pulse during a frame (or in many cases during a sequence of frames). FIG. 22 shows those two states for any given frame. Setting the Flip bit in the Modulation Control register enables Flip Modulation.

Fine-Shift Modulation

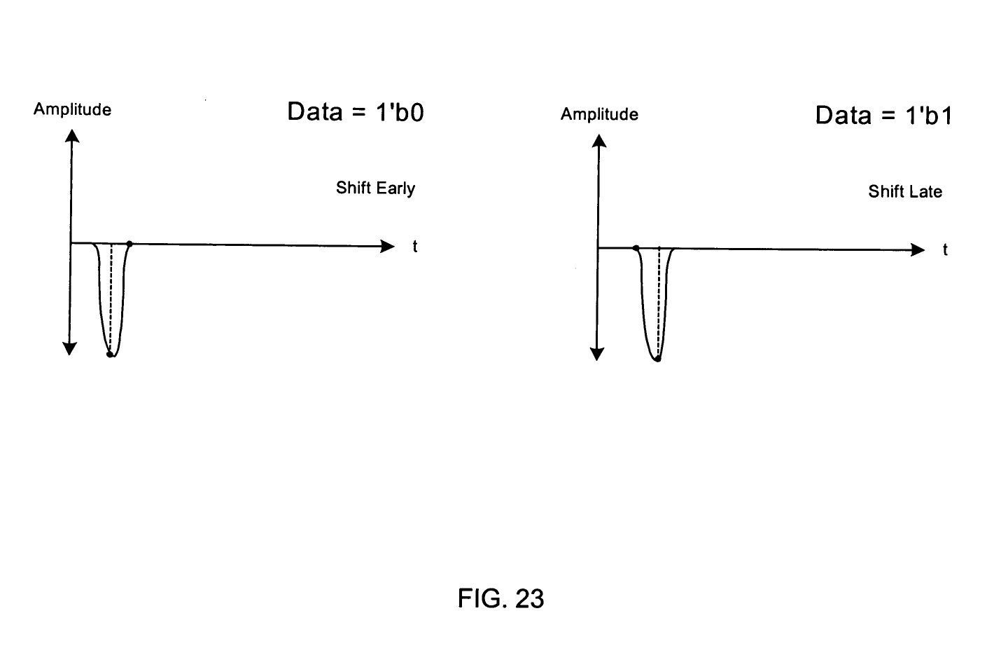

Fine-Shift Modulation simply uses one bit of data to transmit either an early shifted or late shifted UWB pulse during a frame (or in many cases during a sequence of frames). FIG. 23 shows those two states for any given frame. Setting the Shift bit in the Modulation Control register enables Fine-Shift Modulation.

QFTM

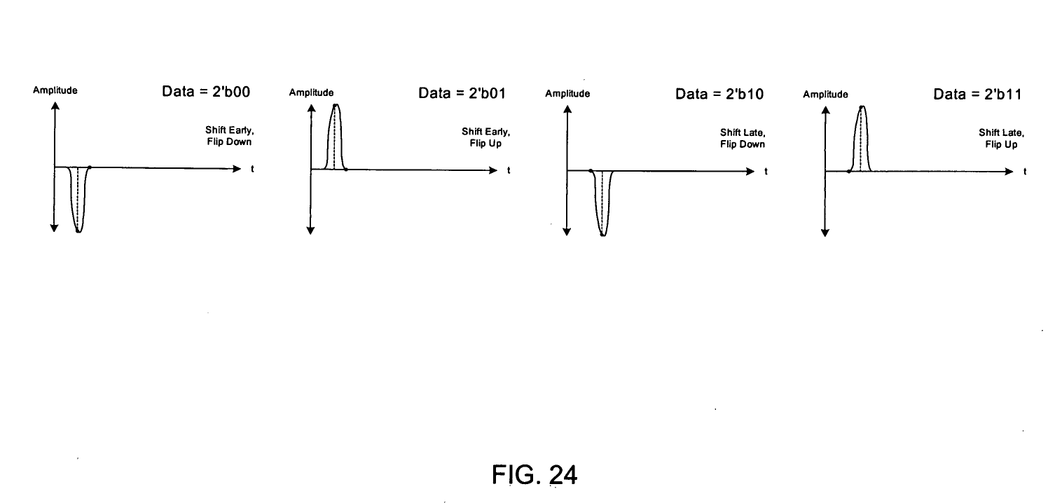

QFTM is a combination of Flip Modulation and Fine-Shift Modulation. It uses two bits of data to transmit either a high going or a low going UWB pulse that is shifted either early or late during a frame (or in many cases during a sequence of frames). FIG. 24 shows those four states for any given frame symbols. Setting both the Flip and Shift bits in the Modulation Control register enables QFTM.

4-Position MPM with QFTM

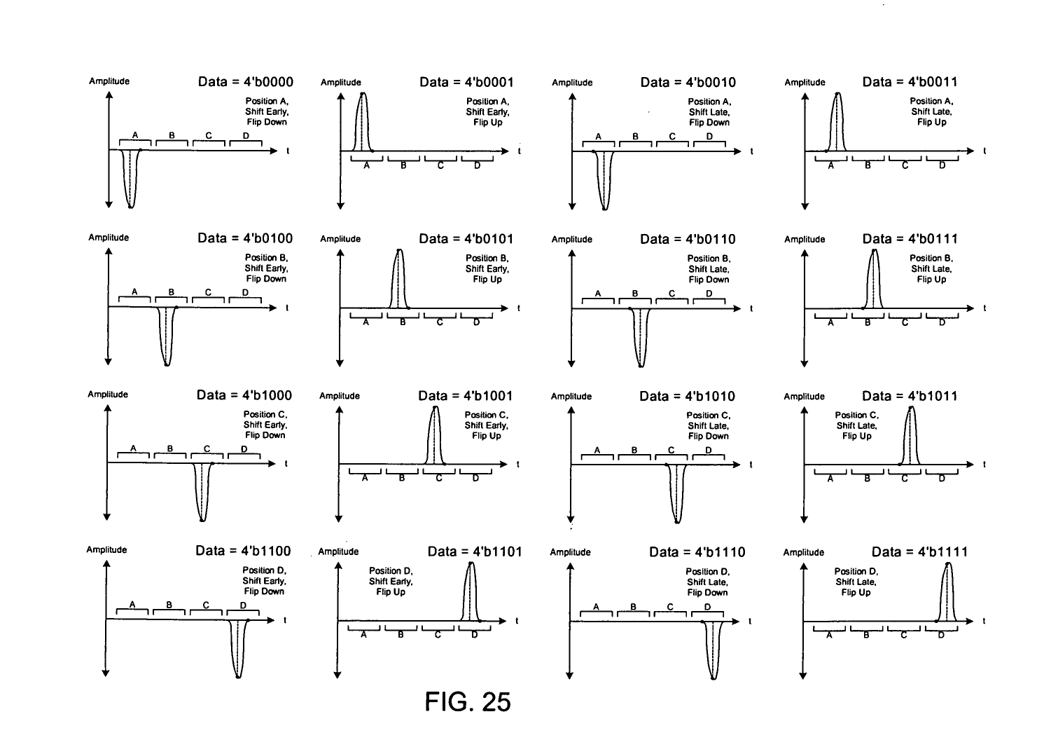

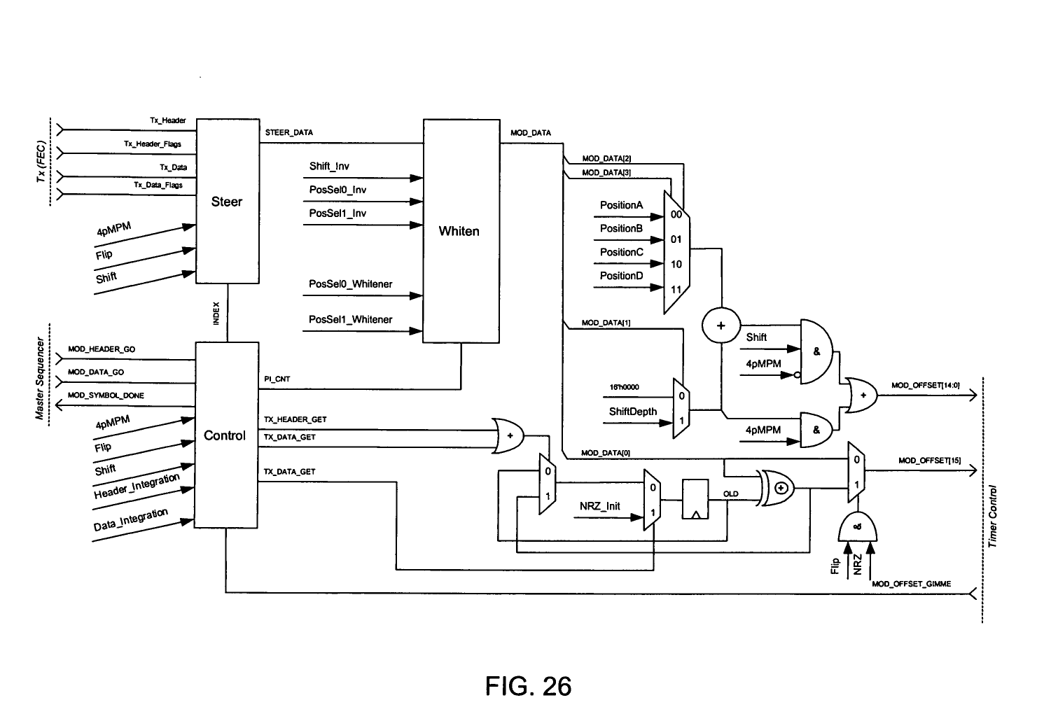

4-position MPM with QFTM Modulation uses QFTM within one of four positions during a frame (or in many cases during a sequence of frames). The four positions account for two bits of data, while the QFTM within the location accounts for two more bits of data. FIG. 25 shows those sixteen states for any given frame. Setting the Flip, Shift, and 4 pMPM bits in the Modulation Control Register enables 4-position MPM with QFTM.

Data Flow

FIG. 26 presents the Modulation logic diagram. When the Master Sequencer asserts the MOD_HEADER_GO signal, the Modulation State Control logic pulls Tx Header information from the Tx (FEC) logic and prepare it for use by the Timer Control logic. Similarly, when the Master Sequencer asserts the MOD_DATA_GO signal, the Modulation State Control logic pulls Tx Data information from the Tx (FEC) logic and prepare it for use by the Timer Control logic. If both MOD_HEADER_GO and MOD_DATA_GO are asserted at the same time, the Tx Header information takes priority over the Tx Data information. This information from the Tx (FEC) logic is fed to the Steer logic where it is pared down and formatted as four bits (STEER_DATA[3:0]). The source information is pared down differently according to the enabled form of modulation. Table 3 describes the behavior of each STEER_DATA bit as a function of the modulation.

TABLE 3
Forms of Modulation

| Form of Modulation | STEER_DATA[3] | STEER_DATA[2] | STEER_DATA[1] | STEER_DATA[0] |
|---|---|---|---|---|
| None | 1′b0 | 1′b0 | 1′b0 | 1′b0 |
| Flip | 1′b0 | 1′b0 | 1′b0 | Flip |
| Fine-Shift | 1′b0 | 1′b0 | Shift | 1′b0 |
| QFTM | 1′b0 | 1′b0 | Shift | Flip |
| 4pMPM w/QFTM | PositionSelect[1] | PositionSelect[0] | Shift | Flip |

The four bits of STEER_DATA are fed to the Whitener logic that can be configured to whiten all but the Flip bits. Data whitening ensures that an equal number of ones and zeros are transmitted. Whitening the PositionSelect bits causes STEER_DATA[3:2] to send “Position A”, “Position B”, “Position C”, and “Position D” an equal number of times. Data whitening is configurable and can be disabled all together.

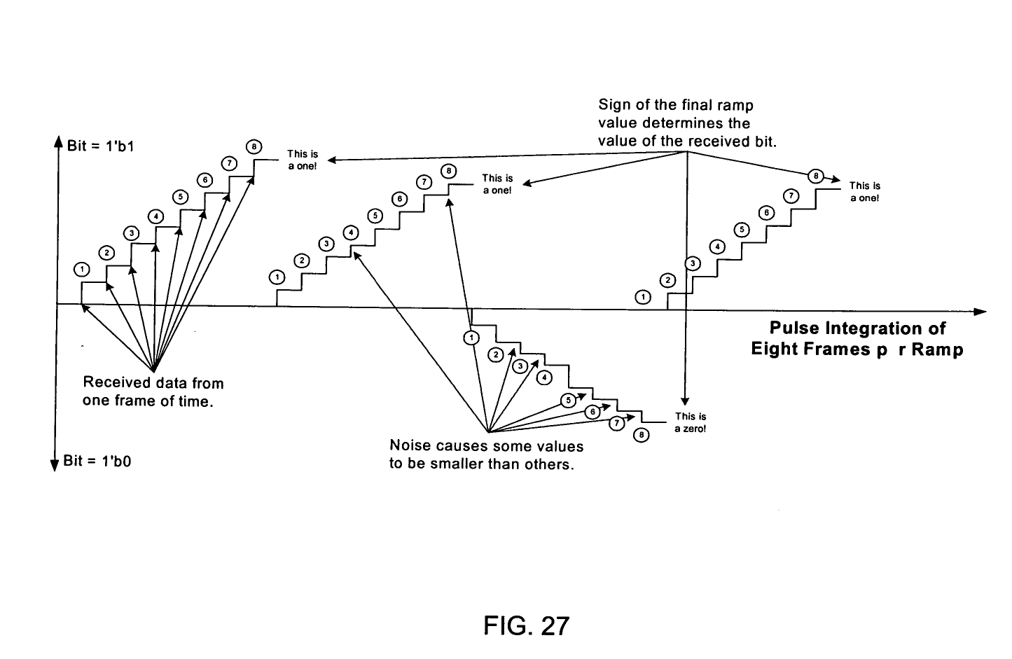

Data whitening is used in conjunction with resending the same data numerous times. The receiver of the data adds the data each time building up a “ramp” for each bit. The amplitude of the ramp determines the actual bit value. By using large ramp lengths (large pulse integration values), the impact of noise on the true signal is reduced. FIG. 27 depicts the construction of ramps using an example pulse integration of eight frames per ramp.

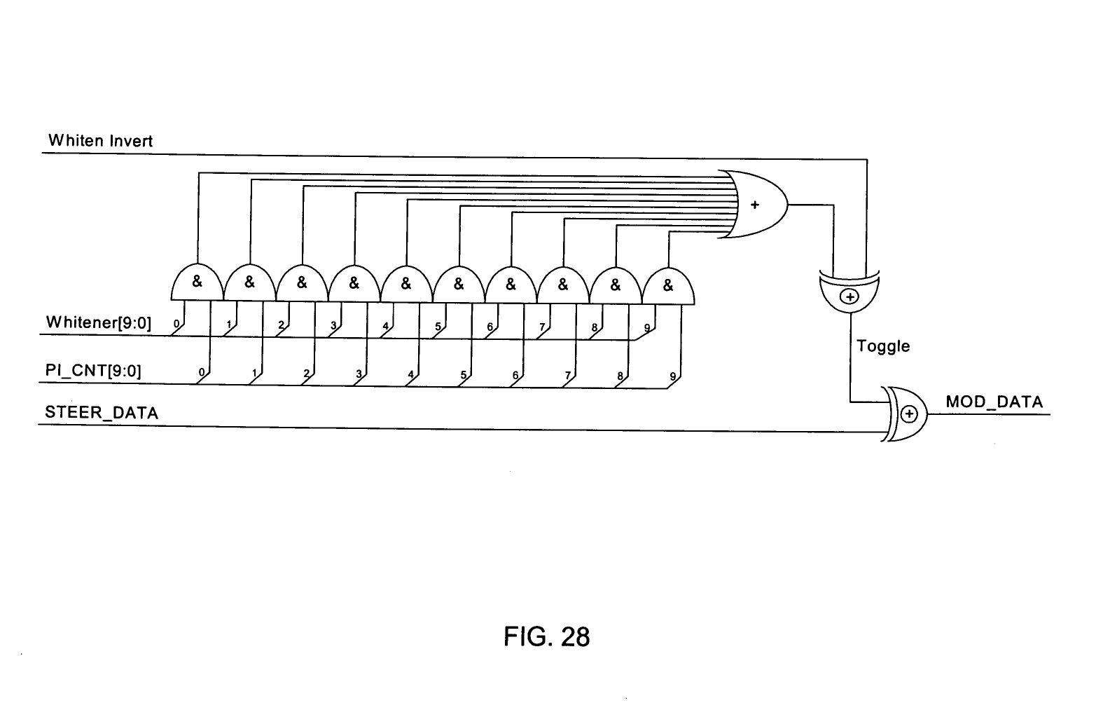

The data whitening is accomplished on a per bit basis. Each whitenable bit has a Whiten Invert value and a Whitener[9:0] value. The Whitener[9:0] value masks off the pulse integration counter bits and is configured such that no more than one pulse integration count bit is used (unmasked) at a time. The unmasked count bit is used to toggle the original STEER_DATA bit. The Whiten Invert value can be used to invert the meaning of the resulting bit. The Whitener[9:0] value is configured with all zeros to allow the data to be unchanged by the Whitener logic. FIG. 28 shows the whitening logic associated with any one of the four data bits.

Referring back to FIG. 26, THE MOD_DATA[3:0] that results from the Whitener logic is used to generate an offset (within a frame of time) information for the Timer Control logic. The offset value (MOD_OFFSET[15:0]) varies according to the form of modulation being used. The most significant bit of the offset (MOD_OFFSET[15]) is used as a flip pulser select signal, i.e., it chooses between an up or down going pulse. The equations below define the offset as a function of the ShiftDepth, PositionA, PositionB, PositionC, and PositionD registers. The flip-modulation offset formulae are as follows:

MOD_OFFSET[14:0]=15′h0000

MOD_OFFSET[15]=MOD_DATA[0]

The fine-shift modulation offset formulae are as follows:

```
if (MOD_DATA[1])
  MOD_OFFSET[14:0] = ShiftDepth[14:0]
else
  MOD_OFFSET[14:0] = 15′h0000
MOD_OFFSET[15]=1′b0
```

The QFTM offset formulae are as follows:

```
if (MOD_DATA[1])
  MOD_OFFSET[14:0] = ShiftDepth[14:0]
else
  MOD_OFFSET[14:0] = 15′h0000
MOD_OFFSET[15]=MOD_DATA[0]
```

The 4-position MPM w/QFTM offset formulae are as follows:

```
if (MOD_DATA[1])
  MOD_OFFSET[14:0]=ShiftDepth[14:0]
else
  MOD_OFFSET[14:0]=15′h0000
if (MOD_DATA[3:2]==2′b00)
  MOD_OFFSET[14:0]=MOD_OFFSET[14:0]+PositionA[14:0]
else if (MOD_DATA[3:2]==2′b01)
  MOD_OFFSET[14:0]=MOD_OFFSET[14:0]+PositionB[14:0]
else if (MOD_DATA[3:2]==2′b10)
  MOD_OFFSET[14:0]=MOD_OFFSET[14:0]+PositionC[14:0]
else if (MOD_DATA[3:2]==2′b11)
  MOD_OFFSET[14:0]=MOD_OFFSET[14:0]+PositionD[14:0]
```

MOD_OFFSET[15]=MOD_DATA[0]

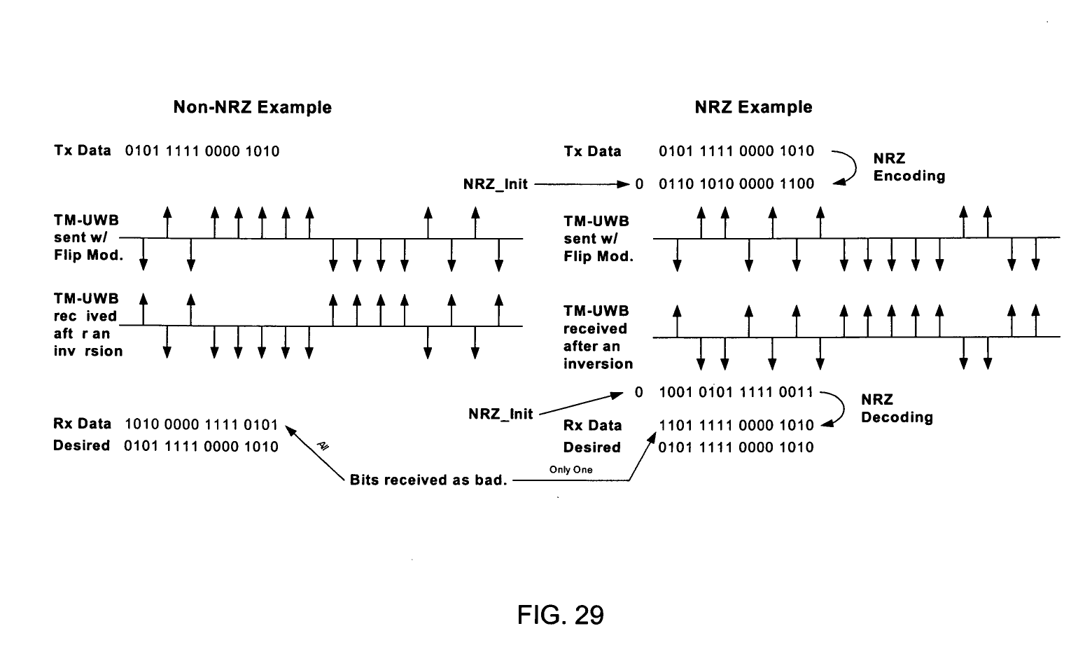

Non-Return to Zero (NRZ) is used to minimize data losses associated with UWB pulse inversions. There is a potential for UWB pulses to become inverted after signal acquisition due to transmission phenomena. Non-NRZ modulation would result in every flip bit being incorrect during an inversion. If the pulses are flipped based upon an NRZ encoded stream of data, NRZ encoding sends a low going pulse when a current data portion matches a previous data portion. When the current and previous data portions are mismatched, the transmitted pulse would be high going. The NRZ_Init value is used for the previous data portion for the first piece of “current” data. NRZ encoding sends a low going pulse when a current data portion matches a previous data portion. When the current pre-encoded and previous data portion are mismatched, the transmitted pulse would be high going. This is essentially an XOR operation. The NRZ_Init value is used for the previous encoded data portion for the first piece of “current” pre-encoded data. As illustrated by the example in the FIG. 29, the NRZ algorithm only suffers one bit error at the boundary of the signal inversion.

Timer Control

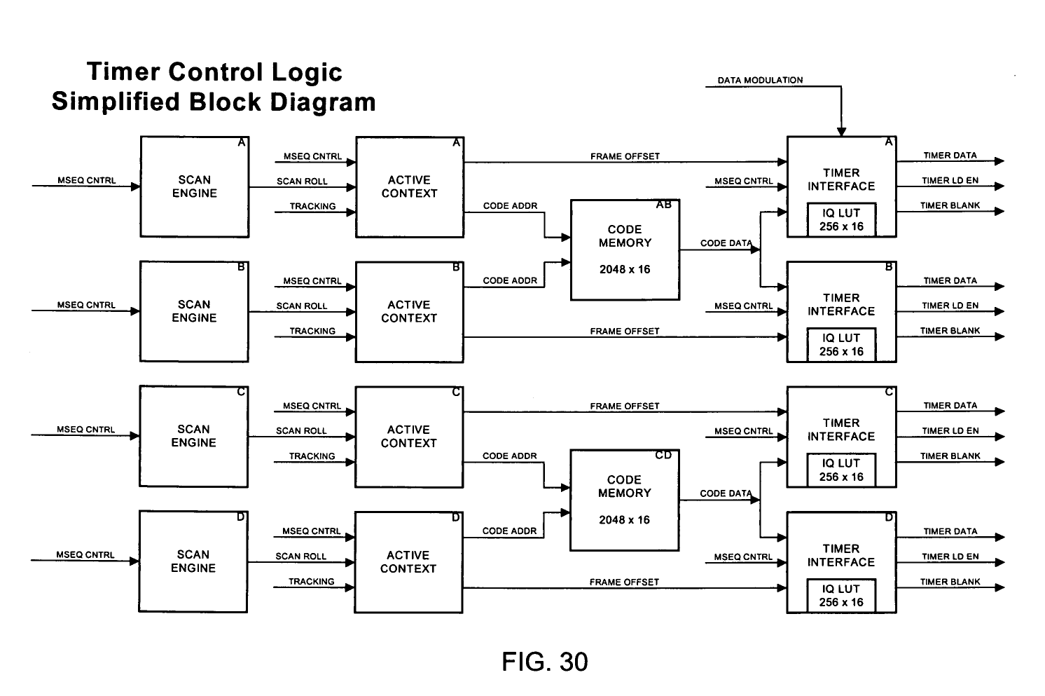

FIG. 30 is a simplified block diagram of the Timer Control logic having four independent Timer Control channels. A Timer Control channel consists of a Scan Engine, a Timer Context, a Code Memory, and a Timer Interface. Note that a single Code Memory is shared between two channels.

Scan Engine

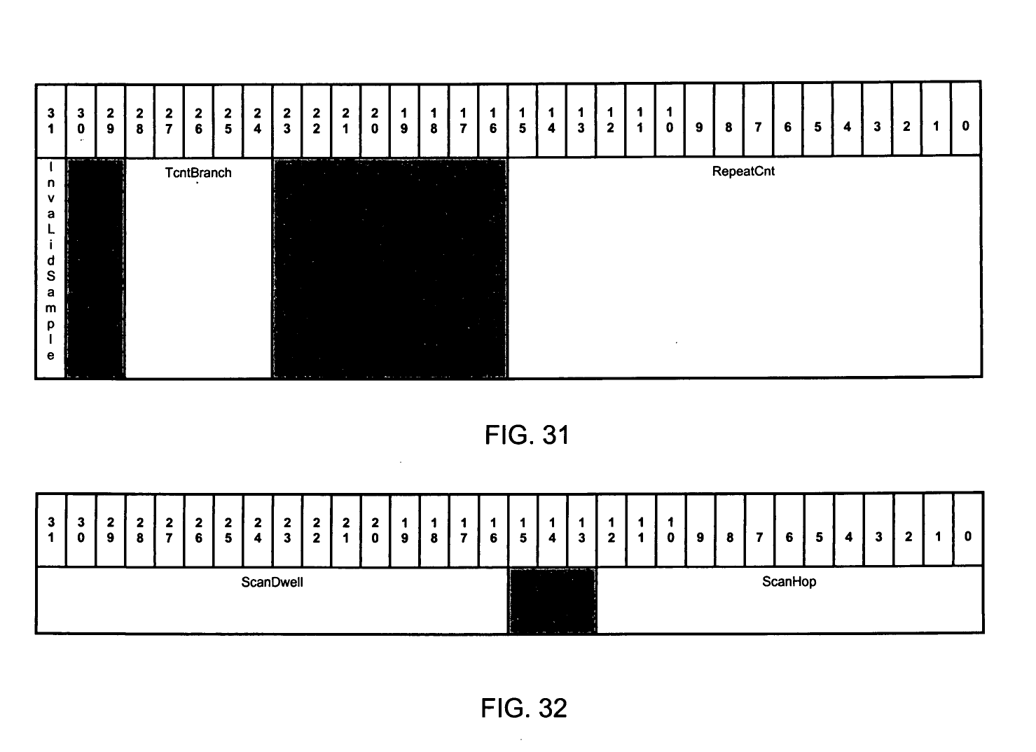

A Scan Engine is a programmable microsequencer responsible for adding predetermined time hops to the frame offset. A total of 32 unique, loadable scan instructions are supported. Instructions can be used singly or linked together. The Master Sequencer provides overall control for all Scan Engines. The scan engine microsequencer memories are programmed via the Memory Select, Memory Address, and Memory Data registers. The format of the 64-bit microinstruction for the ScanEngineMsWord and ScanEngineLsWord is depicted in FIG. 31 and FIG. 32, respectively, and is described below.

| | | | | |
|---|---|---|---|---|
| Field Name | Access | Reset | Valid Values | Description |

TimerLogic (ScanEngineMsWord)

| | | | | |
|---|---|---|---|---|
| InvalidSample | WO | X | 0/1 | Indicates that a sample is invalid and should be ignored by |
| | | | | demodulation. |
| TcntBranch | WO | X | 0 . . . 31 | The absolute Scan Engine instruction address that the Scan |
| | | | | Engine branches to upon completion of the current instruction. |
| RepeatCnt | WO | X | 0 . . . 65535 | The number of hops executed by this instruction. The number of |
| | | | | hops can be any value between 1 and 65536. The repeat count |
| | | | | value is specified as the number of hops minus 1 (i.e. between 0 |
| | | | | and 65535). |

TimerLogic (ScanEngineLsWord)

| | | | | |
|---|---|---|---|---|
| ScanDwell | WO | X | 0 . . . 65535 | The number of pulses to dwell between hops. The dwell count can |
| | | | | be any value between 1 and 65536. The scan dwell value is |
| | | | | specified as the number of pulses desired minus 1 (i.e. between 0 |
| | | | | and 65535). |
| ScanHop | WO | X | | The increment of time to move the frame offset. This is a 2's |
| | | | | complement number with a range of +13 ns to −13 ns. The least |
| | | | | significant bit is approximately 3.1789 ps. |

Timer Contexts

The primary function of a Timer Context is to generate the frame offset and code address for a code memory used to define a code offset. The frame offset numerically

represents the start of a virtual frame relative to the start of a physical frame as defined by a Timer2 ASIC. The governing equations are:

$$frame {offset}_{NEXT} = frame {offset}_{CURRENT} + scan roll + \\ ( 18.10 ) ( 18.10 ) ( 13.0 )$$

$${tracking}_{FREQUENCY} + {tracking}_{PHASE} + channel roll$$

$$( 4.10 ) ( 8.3 ) ( 12.10 )$$

$$\text{code address} = \text{code base address} + \text{code index}$$

Where the notation (x.y) represents a fixed-point number where x is the whole number of fine bins and y is the fractional number of fine bins, as shown in FIG. 13.

The Timer Logic manages frame offsets and code addresses that are sent to the Code Memory and Timer Interface using a set of Timer Context registers. Each Timer channel (ABCD) has 1 Active and 4 Offline context registers. The Offline Contexts are used for temporary storage of the Active Context. For example, channel A has online context A and offline contexts A0, A1, A2 and A3. The same example holds for channels B, C and D. These ContextOffsets correspond to the master sequencer output TimerContextAddress. Table 4 specifies the ContextOffset used to calculate the memory addresses for all Active and Offline context registers:

TABLE 4
Timer Context Offsets

| ContextOffset | | ContextOffset | | ContextOffset | | ContextOffset | | ContextOffset | |
|---|---|---|---|---|---|---|---|---|---|
| A0 | 0x00 | B0 | 0x40 | C0 | 0x80 | D0 | 0xc0 | A | 0x100 |
| A1 | 0x10 | B1 | 0x50 | C1 | 0x90 | D1 | 0xd0 | B | 0x110 |
| A2 | 0x20 | B2 | 0x60 | C2 | 0xa0 | D2 | 0xe0 | C | 0x120 |
| A3 | 0x30 | B3 | 0x70 | C3 | 0xb0 | D3 | 0xf0 | D | 0x130 |

The following set of Timer Logic registers collectively define each Timer Context: CodeLength, CodeBase, Offset, TrackRoll, AcquireControl, Snapshot, StaleCount, TxAcqCodeLength and ChannelRoll.

Table 5 defines the timer context modes of operation as specified by the master sequencer output TimerContextMode:

TABLE 5
Timer Context Modes

| TimerContextMode[1:0] | Timer Context Mode |
|---|---|
| 2′b00 | Context save by channel from active to |
| | offline as determined by least significant |
| | 2 bits of TimerContextAddress. |
| 2′b01 | Context restore by channel from offline |
| | to active as determined by least significant |
| | 2 bits of TimerContextAddress. |
| 2′b10 | Broadcast restore from |
| | any single offline context (as determined |
| | by least significant 2 bits of |
| | TimerContextAddress) to any active context |
| | (as determined by the TimerContextEnable). |
| 2′b11 | Causes the active context to be copied |
| | to all 4 offline contexts for a given channel. |

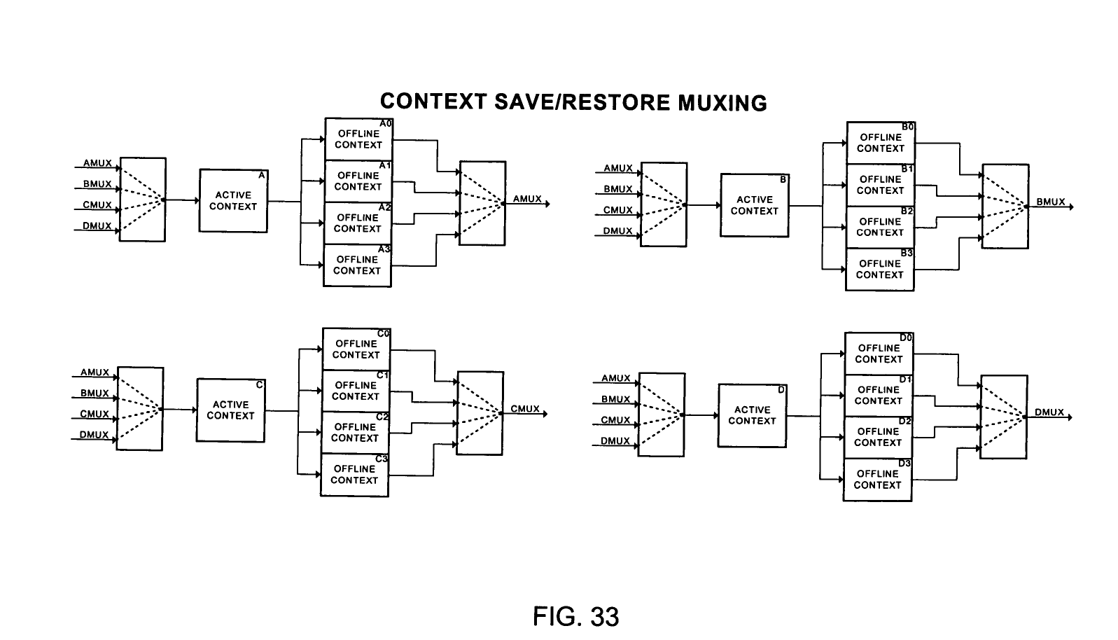

The data paths that allow for saving and restoring the Active Contexts are shown in FIG. 33.

Code Memory

Each 2048×16 code memory is shared by 2 timing channels. The partitions of the code memory are listed in Table 6.

TABLE 6
Code Memory Partitioning

| Address Range | Contents |
|---|---|
| 0-15 | Rx Acquire Code 16/32 |
| 16-31 | Rx Acquire Code 32 |
| 32-33 | Rx Acquire Code 2/4 - Channel A/C |
| 34-35 | Rx Acquire Code 4 - Channel A/C |
| 36-37 | Rx Acquire Code 2/4 - Channel B/D |
| 38-39 | Rx Acquire Code 4 - Channel B/D |
| 40-N = (length of Tx | Tx Acquire Code 16/32 (256/512) (4096/8192) |
| acquire code + 39) | |
| (N + 1)-2047 | Rx/Tx Payload Code/Long Code Acquisition |

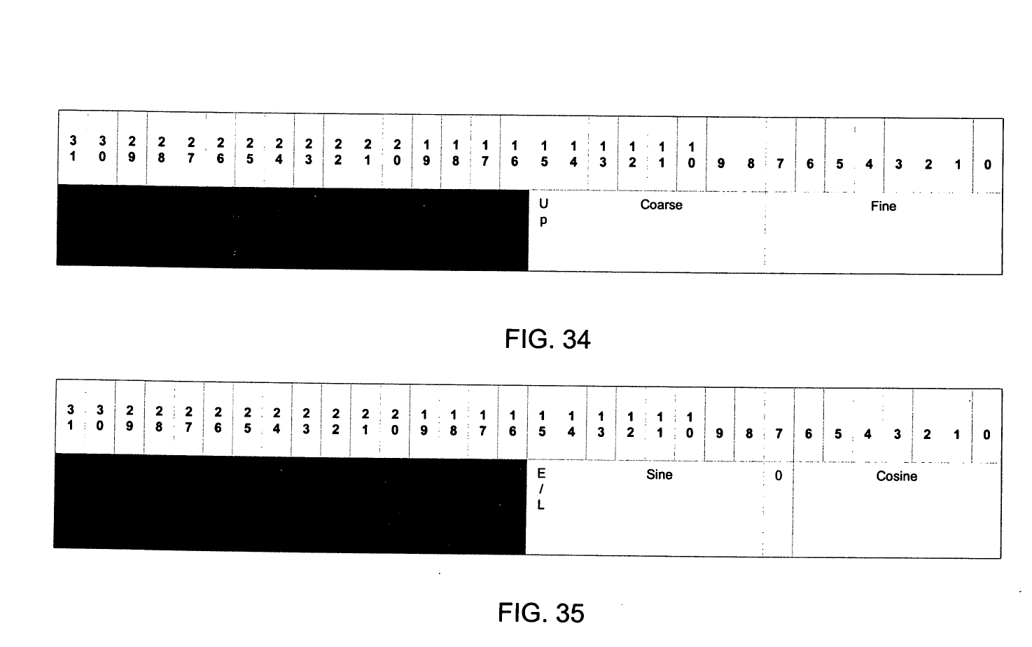

Code Memory is used to define a code offset of 0 to 100 ns. Code Memory is written via the Memory Select, Memory Address and Memory Data registers. The Memory Data register is 32 bits, but only the least significant 16 bits are used for code memory. A value of 0×ffff is decoded to indicate a blanked code. Note that actual code span range may be limited to less than 100 ns in certain modes of operation. FIG. 34 illustrates the Code Memory, which is described below.

TimerLogic (CodeMemory)

| Field | | | Valid | |
|---|---|---|---|---|
| Name | Access | Reset | Values | Description |
| Up | WO | X | 0/1 | The pulse polarity: |
| | | | | 1 = normal, 0 = inverted. |
| Coarse | WO | X | 0 . . . 127 | The number of coarse |
| | | | | bins in the 100 ns frame. |
| Fine | WO | X | 0 . . . 255 | Index into the 256x16 |
| | | | | IQ LUT to determine the fine bin. |

The In-phase and Quadrature (IQ) Look Up Table (LUT) contains an Early/Late trigger and the sine and cosine values used to generate a fine bin offset. The IQ LUT is indexed by the Fine field from code memory. FIG. 35 illustrates the IQ LUT, which is described below.

TimerLogic (IqLut)

| | | | Valid | |
|---|---|---|---|---|
| Field Name | Access | Reset | Values | Description |
| E/L | WO | X | 0/1 | The early/late trigger: |
| | | | | 1 = early, 0 = late. |
| Sine | WO | X | | Used to generate the fine offset. |
| Cosine | WO | X | | Used to generate the fine offset. |

Timer Interface

The Timer Interface is responsible for loading the timer offset into the Timer2 chips during the appropriate clock cycle, along with other signals such as pulse up/down, early/late, and blank. The value of timer offset is formed according to the following equation:

timer offset=frame offset+code data+data modulation

TimerOperation Modes

Table 7 specifies the timer operation modes for each timing channel as defined by the Master sequencer output Timer[ABCD]mode:

TABLE 7
Timer Operation Modes

| Timer[ABCD]mode | Timer Operation Mode |
|---|---|
| 4′b0000 | Reset |
| 4′b0001 | Transmit Acquire Code 16/32 |
| 4′b0010 | Transmit Acquire Code 16/32 Flip |
| 4′b0011 | Transmit Acquire Code 256/512 |
| 4′b0100 | Transmit Acquire Code 256/512 Flip |
| 4′b0101 | Transmit Acquire Code 4096/8192 |
| 4′b0110 | Transmit Acquire Code 4096/8192 Flip |
| 4′b0111 | Transmit Payload without Data 1x |
| 4′b1000 | Transmit Payload with Data 1x |
| 4′b1001 | Transmit Payload without Data 2x |
| 4′b1010 | Transmit Payload with Data 2x |
| 4′b1011 | Receive Acquire Code 2/4 |
| 4′b1100 | Receive Acquire Code 16/32 |
| 4′b1101 | Receive Payload 1x |
| 4′b1110 | Receive Payload 2x |
| 4′b1111 | Idle |

Supported Features

The following are among the features supported by the Timer Control logic:

1. Four independent timing channels

2. Four offline timing contexts per channel (total of sixteen)

3. Four independent scan engines with 32-instruction microsequencer

4. PRF rates of 20, 10, 5, 2.5, and 1.25 MHz

5. Code lengths up to 2048 for radar and 1992 for PLT/Communications

6. Maximum roll rate of ±13 ns/frame

7. Code span up to 100 ns for non-20 MHz PRFs

8. Flip and blank coding

Acquisition

Overview

Acquisition is the first required step for data reception and is responsible for locking the receiver to a transmitter's signal. Acquisition is performed using one of two selectable modes: short code or long code. Short code acquisition uses either a length 16 or 32 code and 16 parallel ramp builder pairs to search for a transmitter's acquisition header. Long code acquire may use any power of two code length between 16 and 1024 and 4 ramp builder pairs to search for the transmitter's signal.

Both short code and long code acquisition are divided into first stage and second stage separated by OLDE and Sigopt operations, as described later in detail in connection with tracking. First stage acquire (FSA) consists of building a set of ramps and evaluating specified threshold equations. Once a ramp is found that meets the threshold, the transmitter and receiver are code aligned and roughly frame aligned. Second stage acquire (SSA) is used to locate the end of the acquisition header.

The available modes of acquisition are determined through the AcquireMode Master Sequencer outputs as defined in Table 8.

TABLE 8
Acquire Modes

| AcquireMode | Definition |
|---|---|
| 3b′000 | Reset |
| 3b′001 | Acquire Stage 1 (FSA) using threshold |
| | equations 1 and 2 |
| 3b′010 | Scan1 (Searching for max ramp |
| | and its location within a frame) |
| 3b′011 | Scan2 (Scanning back over previously |
| | discovered max - max was found during Scan1) |
| 3b′100 | Track (olde/sigopt running - the |
| | radio is between fsa and ssa) |
| 3b′101 | Second Stage Acquire |
| | (SSA) - looking for the delimiter |
| 3b′110 | Acquire Stage 1a (FSA) using |
| | threshold equations 3 and 4 |
| 3b′111 | Unused - mapped to reset |

The Acquisition logic provides AcquireStatus bits to the Master Sequencer as inputs depending on the Acquisition mode according to Table 9.

TABLE 9
AcquireStatus Master Sequencer Inputs

| Acq. Mode | AcquireStatus[2] | AcquireStatus[1] | AcquireStatus[0] |
|---|---|---|---|
| Reset | 0 | 0 | 0 |
| AcquireStage1 | Threshold eq1 | threshold eq2 | ramp_done |
| Scan1 | Threshold eq1 | new_max | ramp_done |
| Scan2 | Threshold eq1 | scan2_done | ramp_done |
| Track | 0 | 0 | 0 |
| SSA (Check | 0 | fsa_track_{—} | compare_valid |
| Lock) | | compare | |
| SSA2 | ssa_done | rm_error | ramp_done |
| AcquireStage1a | Threshold eq3 | threshold eq4 | ramp_done |

Short Code Acquisition

Acquisition Frame Format

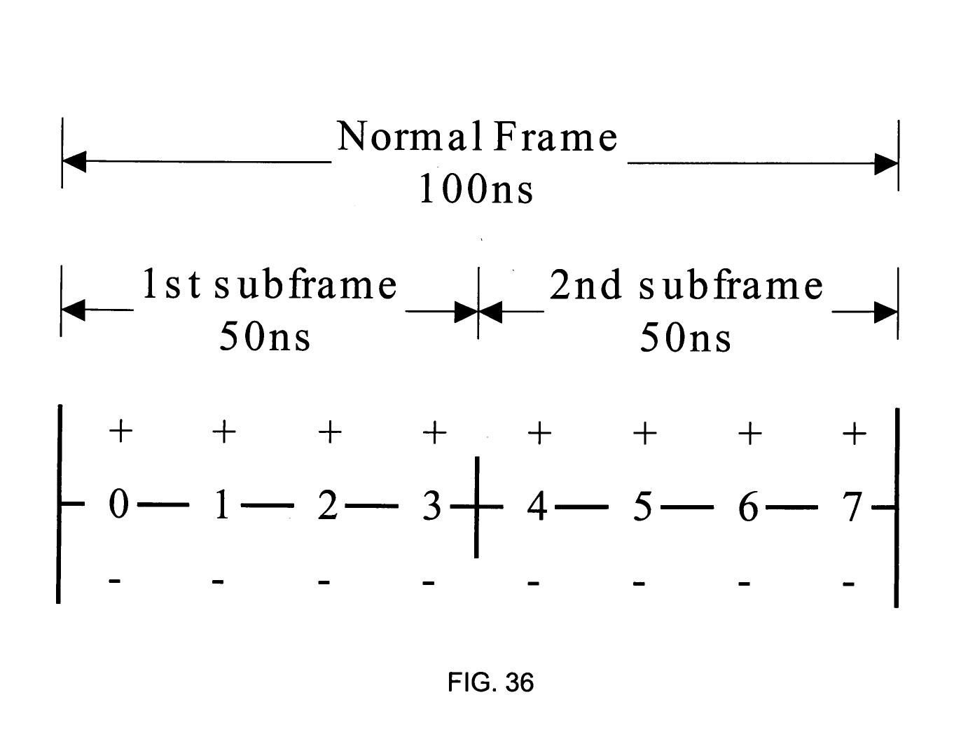

When a length 16 code is used, the receiver and transmitter use an exemplary 100 ns frame format, shown in FIG. 36, during first and second stage short code acquisition. The actual frame length is set by the Greenwich reference clock input.

Referring to FIG. 36, the normal 100 ns frame is divided into two 50 ns subframes, with a total of eight pulse positions, shown (numbered 0-7). Since the pulse at each location could be positive or negative (flipped), there are 16 possible pulse states.

All eight pulse positions are sampled in a 100 ns frame by firing the four correlator pairs twice per frame. The acquisition hardware inverts these eight samples and routes both the inverted and non-inverted samples to the 16 ramp builder pairs for processing. For 32 length codes there are 32 possible pulse locations, but the correlators can still only measure 16 of the 32 positions per frame. Therefore, an acquire code longer than 16 can be considered as combinations of different length 16 codes.

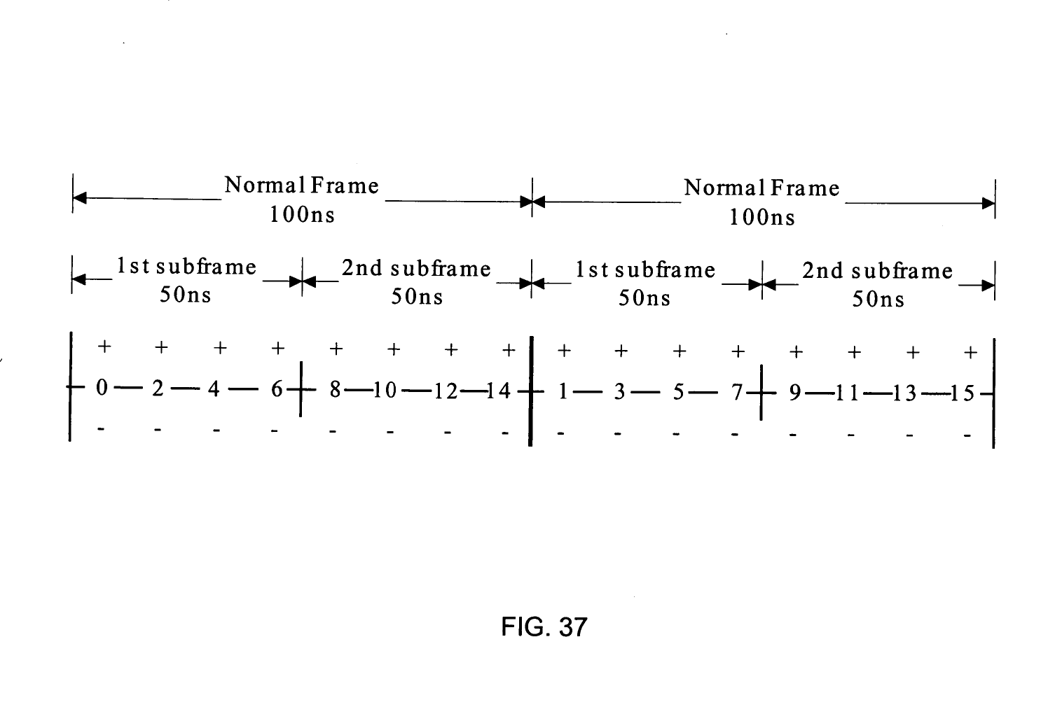

For length 32 codes, the combination of the length 16 codes is done in an interleaved fashion, meaning that the transmitter alternates between the two codes every frame. FIG. 37 depicts a length 32 code acquisition frame format where one length 16 code specifies the even numbered pulse locations and a second length 16 code specifies the odd numbered locations.

Referring to FIG. 37, the transmitter alternates between the even and odd pulse positions between each frame during transmission. The length 16 code specifying the even pulse positions is referred to as the “even” code and the length 16 code specifying the odd pulse locations as the “odd” code. The receiver acquisition hardware samples the 16 samples in each frame and attempts to match the transmitters sequence.

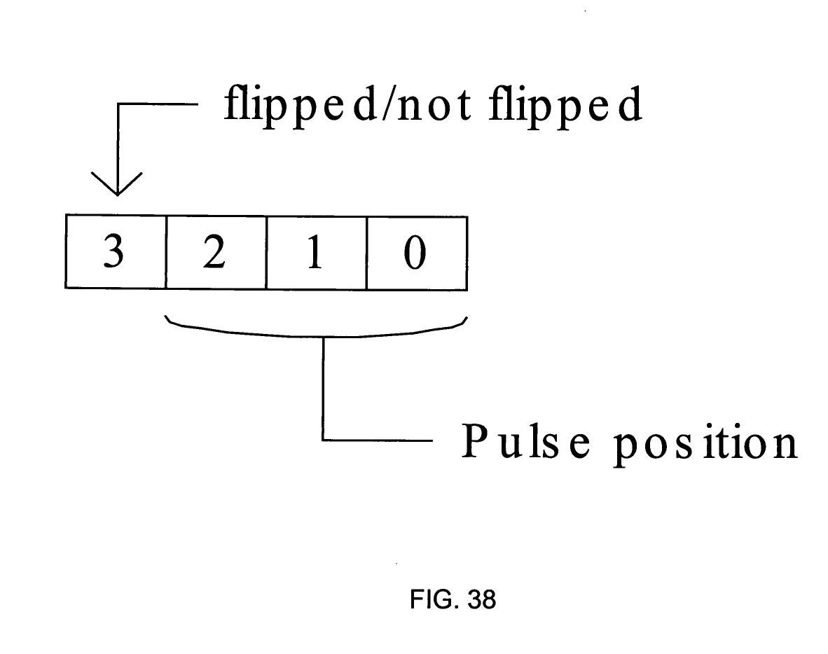

With 16 possible pulse positions a four bit code word is required. The short acquisition code word format is given in FIG. 38. In FIG. 38, the left most bit (bit 3) specifies if the pulse should be flipped or not and bits 2-0 specify the pulse location within the 100 ns frame.

Acquisition Codes

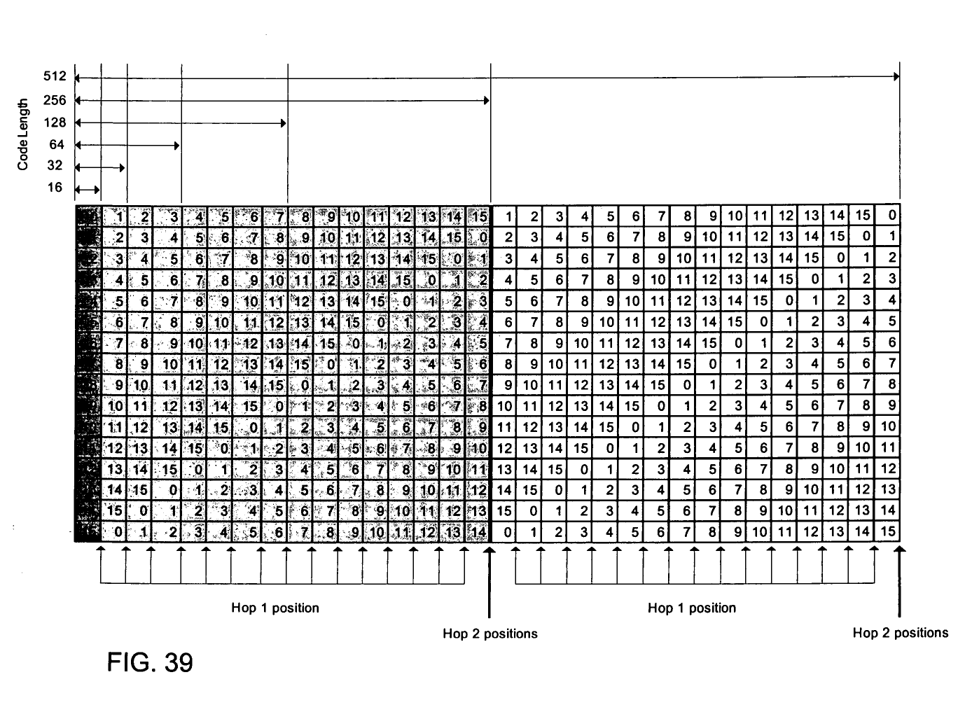

The short code first stage acquisition process uses either a length 16 or 32 code. Longer codes (up to 4096) may be used in the short code second stage logic. The first stage code can be programmed into the acquisition logic through acquisition code registers. An acquisition sequence generator uses the code to derive other longer codes. The process used to derive the longer codes from the length 16 code is discussed below using the FIG. 39.

In FIG. 39, the left column represents the initial position of the length 16 code in the acquisition sequence generator. The generator initially contains the length 16 code in the order it was programmed into root registers. The other columns represent snapshots of the generator register showing how the code positions change as the longer codes are derived. During first stage acquisition, the sequence generator register simply cycles through the left most column from top to bottom going through the length 16 code. To generate a longer code, the logic goes through the left column once but instead of starting over at 0 when the end of the column is reached, the logic “hops” one code position. This causes the sequence to hop over code 0 and start at code 1. The second column from the left shows the sequence after one hop. The process repeats each time the end of a column is reached until the desired code length is obtained. For example, to generate a length 64 code the first four columns are used. For a length 256 code the first 16 columns are used.

Codes of up to length 256 can be generated using a length 16 code and single hops. For codes longer than 256, two hops are required to break up the sequence. For example, to generate a length 512 code, one can start in the upper left corner of the figure and single hop at the end of each column, until the end of the sixteenth column is reached. At this point, if a single hop is used, one can start over at the left most column and have a length 256 code. However, if two positions are hoped, the length 256 code does not repeat and code 1, in the seventeenth column, would be the starting point. The length 512 code is completed by single hopping through the remaining 15 columns which complete the table. To generate even longer codes (up to length 4096), double hops are performed at each length 256 code boundary.

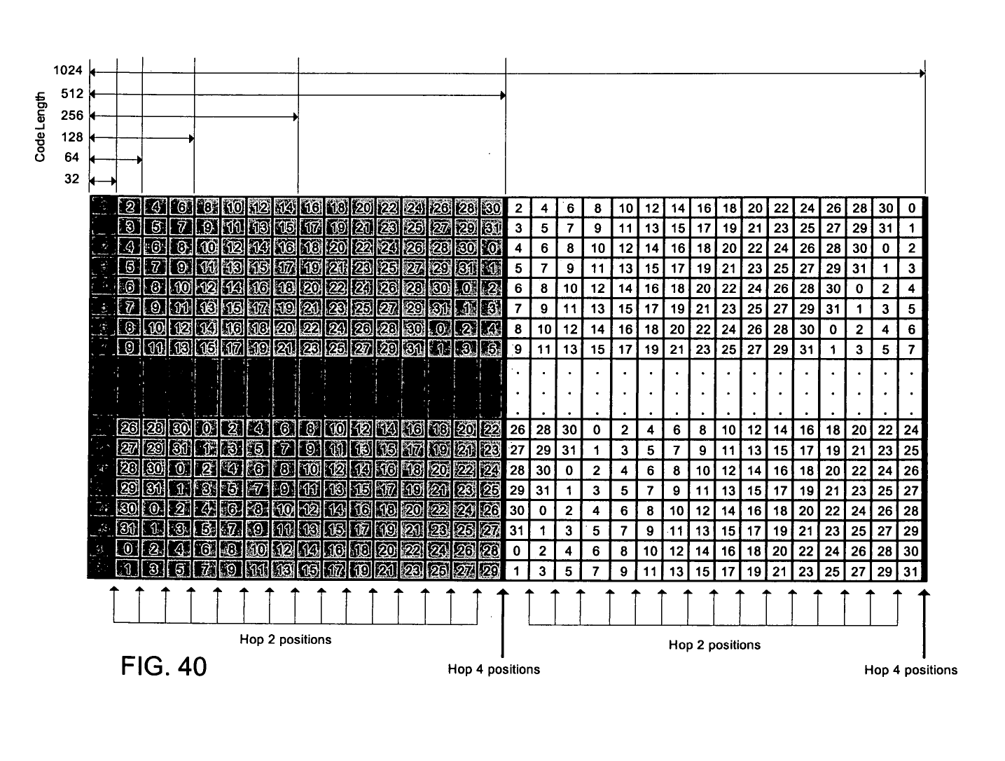

The process to derive longer codes from a length 32 code is slightly different due to the fact that the transmitter alternates between the “odd” and “even” 16 length codes, even when hopping. FIG. 40 shows how a length 32 code is used to derive longer codes.

During normal operation, the transmitter and receiver cycle through the first column alternating between odd and even pulse locations. When a longer code is needed the sequence generator hops two positions (instead of only one) to maintain the odd-even sequence. Codes of length up to 512 can be generated using 2 hops. To generate codes longer than 512, the sequence generator hops 4 positions at each length 512 boundary. Again, hopping 4 positions is required to maintain the proper even-odd pulse position sequence.

Note that the only specified values stored in the acquisition logic are the 4 bit acquisition codes. The sequence generator within the acquisition logic is used to generate the longer codes using the hopping sequence described above.

Acquisition Header

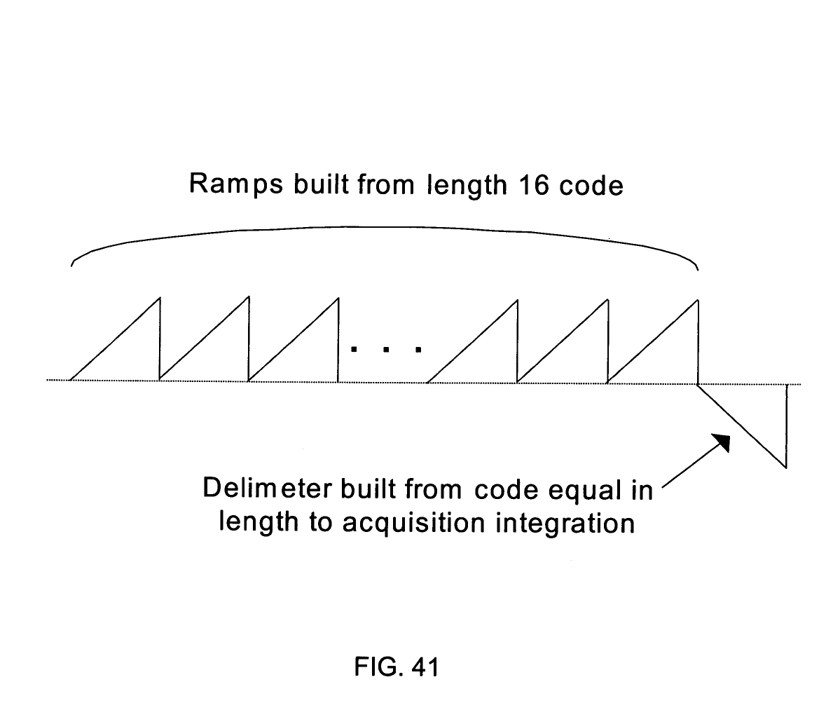

The leading ramps of any data packet form a fixed pattern known as the acquisition header. The format of the acquisition header depends on the acquisition integration length and acquisition code length. The header format for length 16 codes with integration lengths of 16, 32, 64, 128, and 256 and length 32 codes with integration lengths of 32, 64, 128, 256, and 512 have the same format. The transmitter sends a programmable number of pulses to ramps in the receiver using the length 16 or 32 code, followed by one negative (flipped) ramp called the delimiter. The delimiter is simply a ramp that builds in the opposite direction of the other acquisition header ramps. The delimiter marks the end of the acquisition header (start of payload data) and is always built from a code equal in length to the acquisition integration length. Pumps built during acquisition header for a length 16 code and acquisition integration lengths of 16, 32, 64, 128, or 256 is shown in FIG. 41. The format for a length 32 code with integration lengths 32, 64, 128, 256, and 512 is identical.

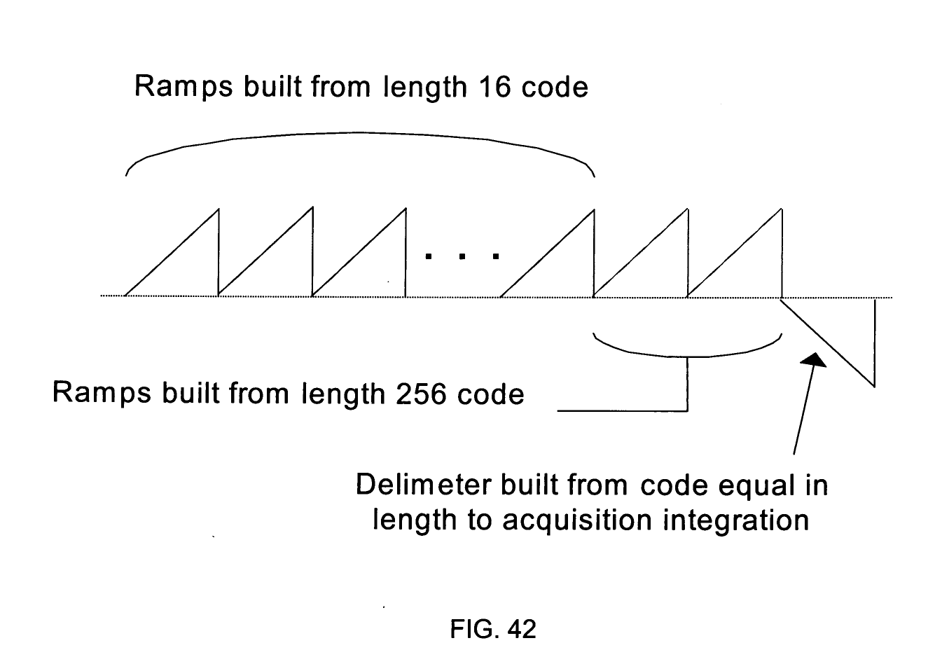

The last two ramps before the delimiter are different for length 16 codes with integration lengths of 512, 1024, 2048, and 4096 and length 32 codes with integration lengths 1024, 2048, and 4096. The same leading ramps built from the length 16 or 32 code are sent, but for the longer integration lengths the transmitter sends pulses that build two positive ramps to allow the acquisition hardware to align to an intermediate length code before the final long code is reached. This intermediate step is required since only 16 ramp builders are available in the acquisition engine. These intermediate ramps are constructed from either a length 256 code (if a base length 16 code is used) or length 512 (if a base length 32 code is used). The final delimiter is built from a code whose length is equal to the acquisition integration length. FIG. 42 shows ramps built by an acquisition code length 16 and integration lengths of 512, 1024, 2048, or 4096. The format for a length 32 code with integration lengths 1024, 2048 and 4096 is identical.

Radio Mode

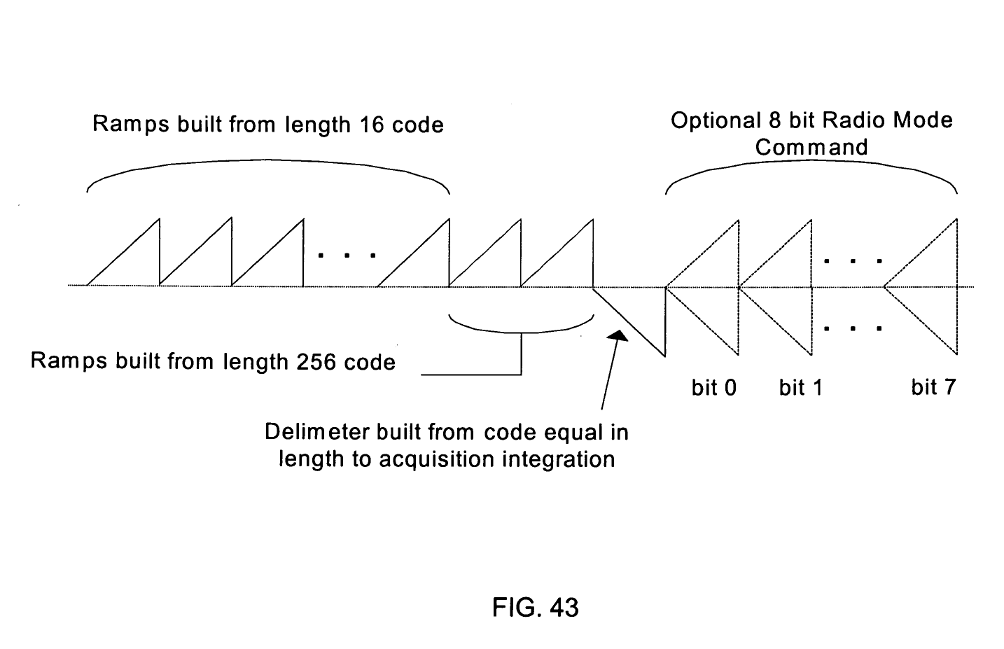

An optional 8-bit Radio Mode command byte may be inserted between the acquisition header delimiter and the data header. The command byte could be used to provide control information such as data integration length, modulation type, etc. about future data packets, not including the packet immediately following the radio mode byte. This is because the receiver is not agile enough to respond to the change until the next packet. Ramps built by an acquisition header that contains a radio command byte is shown in FIG. 43.

If radio mode reception is enabled in the acquire RadioModeCommand register, the acquire logic builds 8 additional ramps after the delimiter using the length 16 or 32 code, demodulates the 8 ramps, and stores the byte in the acquire ReceivedRadioMode register. The acquire logic also compares the received byte with the byte stored in the CompareByte field of the acquire RadioModeCommand register. The results of the comparison are sent to the master sequencer that may generate an interrupt to the external processor.

Since the acquisition logic demodulates the command byte using the (usually) longer acquisition integration length and fixed modulation type (flip), the command is considered more robust than if it were contained in the data payload area. This technique also allows radio control to be maintained when transitioning between different data payload integration lengths and modulation types.

First Stage Acquisition

First stage acquisition (FSA) aligns the receiver's frame and code sequence with the transmitter's acquisition header using a length 16 or 32 code and 16 ramp builder pairs. The following sections discuss first stage acquisition thresholding and the two types of first stage acquisition, scan and non-scan.

First Stage Acquisition Threshold

The equations used to decide when first stage acquisition is complete are called the first stage acquire threshold equations. Simulations have identified several possible threshold equations involving the quantities listed in Table 10.

TABLE 10
Important First Stage Acquire Quantities

| Quantity | Description |
|---|---|
| MaxR | 1^{st} largest acquisition ramp |
| NextR | 2^{nd} largest acquisition ramp |
| MaxV | Maximum correlator variance |
| MinV | Minimum correlator variance |
| MeanV | Mean correlator variance |
| MA_MeanV | Moving (historical) average of the |
| | mean correlator variance |
| MA_MinV | Moving (historical) average of the |
| | minimum correlator variance |
| Logic_1 | Constant value 1 |
| Logic_0 | Constant value 0 |

A basic set of first stage acquire threshold equations are given in the table below. Other equations can be realized using up to four threshold equation setup registers as listed in Table 11.

TABLE 11
Example First Stage Acquire Threshold Equations

| Number | Threshold Equation |
|---|---|
| 1 | N * MaxR/MA_meanV > C |
| 2 | MaxR/NextR > C |
| 3 | Logic AND or OR of equation 1 and 2 (via |
| | the Master Sequencer) |
| 4 | N * MaxR/MaxV > C |
| 5 | N * (MaxR/MA_meanV) * (MinV/MaxV) > C |
| 6 | N * (MaxR/MA_meanV) * [FORCE_ZERO(MinV − |
| | MA_MinV)/FORCE_ONE(MaxV − MA_MinV)] > C |
| 7 | N * (MaxR − NextR)/MA_meanV > C |
| 8 | N * [(MaxR − NextR)/MA_meanV] * (MinV/MaxV) > C |

In the equations shown in Table 11, N represents the acquisition integration length and C is some programmable constant. The FORCE_ZERO(x) function yields x for x≧0 and 0 for x<0 and the FORCE_ONE(x) function yields x for x≧1 and 1 for x<1.

To provide a flexible thresholding scheme the acquisition logic includes fourfully programmable threshold equations. The equations have the following format.

Register₁*Term₁*OP₁(Term₂−Term₃)<,>,=,≠Register₂*Term₄*OP₂(Term₅−Term₆)

Each of the four threshold equations can be programmed such that terms 1-6 can select any of the quantities in Table 10. The logic operators, OP₁ and OP₂, can be set to FORCE_ONE, FORCE_ZERO or NOP (no operation). Register₁ and Register₂ are 12-bit configurable registers that realize the N and C constants in the equations above. All of the equations listed in Table 11 (as well as many others) can be realized. Also, to provide a flexible comparison scheme the, equations left and right side may be compared using the greater than, less than, equal to, or not equal to operators.

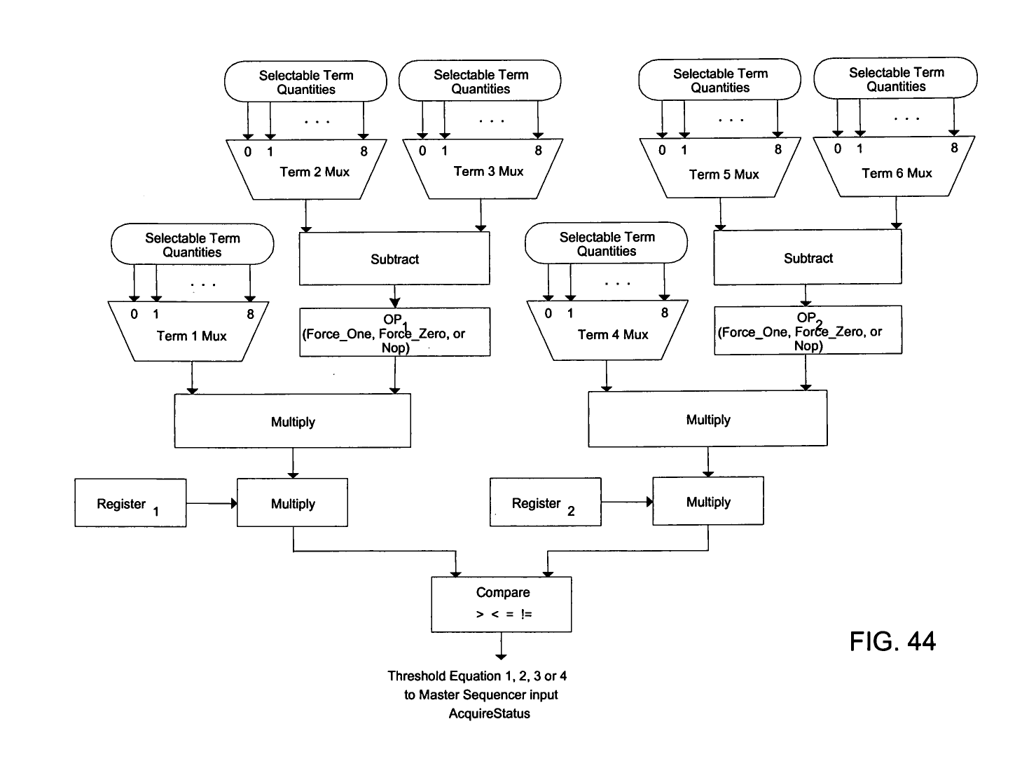

To support equation number 3 in Table 11, the Boolean result of each threshold equation may be combined using logic AND or logic OR in the Master Sequencer. The first stage acquisition threshold equation logic is shown in FIG. 44.

Acquire Floating-Point Format

The quantities that may be selected for terms 1-6 in the FSA Threshold Equations are all signed 22-bit binary numbers. This size causes an implementation problem for the threshold equation logic since the two multiply steps in each side of the equation result in an 88-bit result. Therefore, the quantities are converted to a twelve bit floating-point number and all subtracts and multiplies use this format. The conversions and arithmetic are performed automatically by the acquisition logic internal to the Greenwich device. The floating point format described below is used to program the two twelve bit registers, register₁ and register₂ in the equation above. The format is given in Table 12:

TABLE 12
Acquire Floating-Point Format

| Bit | Definition |
|---|---|
| [11] | Mantissa Sign; 1′b0 = Positive, 1′b1 = Negative |
| [10:3] | Exponent |
| [2:0] | Mantissa |

Floating-point formats can be described by the bit widths of the exponent and mantissa fields and whether or not the format contains a sign bit. The format is represented as “s.8.3” since a sign bit, an 8-bit exponent, and a 3-bit mantissa are used. Converting from 22-bit integer to s.8.3 float is best explained by an example that converts the number +256 to its twelve-bit floating point equivalent. First, +256 is written in binary (0100000000). Then, the binary number is normalized by moving the binary point to the left, until the most significant 1 is just to the right of the binary point (0.100000000). As such, the 8-bit exponent and 3-bit mantissa is determined. The exponent is the number of positions the binary point was moved during the normalization step, which is 9 (binary 00001001) in this case. The mantissa is simply the first three binary digits to the right of the binary point after the number is normalized. The mantissa is therefore binary “100”. Since 256 is positive, the sign bit of the floating point number is “0”. Therefore, the decimal number +256 written in 12-bit floating point format is “0 0000 1001 100”.

The acquire floating-point format supports numbers less than 0.5. Normalizing a number smaller than 0.5 moves the binary point to the right which could result in a negative exponent. To avoid negative exponents, the acquire floating-point exponent is biased by the constant 128 (0×80). Applying this bias, the above example makes the exponent for +256 become 0×89 and the final number be “0 1000 1001 100.”

First Stave Acquisition Modes

Acquisition logic supports two modes of FSA: scan and non-scan.

Scan Mode

Scan Mode FSA finds the largest ramp in a frame by performing a two-pass frame scan. The first scan (SCAN1) covers the entire frame and is followed by another, possibly finer resolution, scan (SCAN2). The second scan is not a complete frame scan, it only covers the time centered on the maximum ramp found in SCAN1 to allow for drift.

Scan mode FSA begins with the master sequencer placing the acquire logic in AcquireStage1 mode. The acquire logic evaluates threshold equations 1 and 2 each time ramps complete. For scan mode FSA, threshold equation 1 is configured such that when it is true the transmitter's acquire header has likely been found and FSA is complete. Threshold equation 2 is set to signal when useful energy has been detected and SCAN1 should start. Once threshold equation 2 is satisfied, the master sequencer changes the acquire mode to SCAN1. In SCAN1, the acquire logic builds ramps and continuously compares the maximum ramp from the latest ramp set to the largest ramp in SCAN1. If the latest maximum ramp is larger than the previous maximum, the new_max signal is sent to the master sequencer shown in Table 10. This signal allows the master sequencer to mark the ramps position within the frame in order to return to the location in SCAN2. Threshold equation 1 is also evaluated during SCAN1 so that if it is met the master sequencer can complete FSA.

If a complete frame scan was completed, but threshold equation 1 was never met, a second scan begins just ahead of the maximum ramp recorded in SCAN1. Referring to Table 10, during SCAN2 mode, the acquire logic generates the result of threshold equation 1 and a new signal called scan2_done. The scan2_done signal is the Boolean result of the following equation:

Scan2 Max Ramp>(Scan2 Factor)×(Scan1 Max Ramp)

The scan2 factor can be set to 1, ⅞, ¾, or ⅝ in the acquisition control register. Once a ramp is found that meets this equation, FSA is complete. The ramp's current sequence value (code) specifies where the pulse should be in the next frame. The acquisition logic informs the master sequencer that first stage acquisition is complete via scan2_done.

The acquire logic maintains several read-only registers that capture scan mode FSA information. The acquire FSAMagnitude register records the maximum ramp and its index measured when acquire is in AcquireStage1 mode and a new maximum ramp is found larger than the previous maximum ramp. The next maximum ramp, its index, and all five variance statistics are also recorded in the FSAMagnitude and FSAVariance1-3 registers. These quantities are also captured during SCAN1 and SCAN2 modes and stored in separate magnitude and variance registers.

The magnitude and variance registers capture new information when a new maximum ramp is found that is larger than the previous maximum ramp for that particular acquire mode (AcquireStage1, SCAN1, SCAN2). First stage acquire may complete when the maximum ramp is not larger than the previous maximum ramp. As a result, the maximum, next maximum ramps and variances would not be recorded. Another set of read only registers, the acquire TrackMagnitude and TrackVariance1-3 registers always record the maximum, next maximum ramps, ramp indices and variance statistics when the acquire mode changes to Track mode (done when FSA is complete). This guarantees that the ramp information and variances are always be captured when FSA completes.

Non-Scan Mode

Non-scan mode is the simpler from of first stage acquire. The master sequencer places the acquire logic in AcquireStage1 mode and evaluates the threshold equation results generated by the acquire logic, as shown in Table 10. Once the master sequencer determines a desired combination of threshold equation results (both true, either true, etc.), FSA is complete.

The same read-only FSAMagnitude and FSAVariance1-3 registers capture information each time a new maximum ramp is found and the TrackMagnitude and Track VarianceVariance1-3 registers record the same information whenever FSA completes.

Quick Check

During non-scan mode FSA, the Master Sequencer observes the threshold equation results each time a set of acquire ramps are built to determine if FSA is complete. Once the desired results for both equations are present, the Master Sequencer may choose to declare FSA as complete, and place the acquire logic in Track mode. Alternatively, it can build a second set of ramps at previous correlator positions to make sure that the previous successful threshold results are still valid. This method of rechecking the previous threshold is called “quick check.”

To perform quick check, the Master Sequencer places the acquire logic into AcquireStage1 a mode instead of Track mode after detecting a successful threshold. The acquire logic waits for 1 bad data frame and begins building ramps on the first good frame of data. The logic uses a new pair of threshold equations, equations 3 and 4 to determine if FSA is complete. The results of threshold equations 3 and 4 are sent to the Master Sequencer and it may choose to end FSA, continue building ramps and use threshold equations 3 and 4, or revert back to threshold equations 1 and 2 by changing the acquire mode back to AcquireStage1.

Back Ramp Logic

The purpose of the back ramp logic is to provide either sign adjusted correlator samples or completed ramps for tracking and for building a ramp history that is used as a threshold during second stage acquisition. The acquisition back ramp logic is made up of a sequence generator and one pair of ramp builders. The sequence generator and ramp builders are referred to as the back sequence and back ramps since they operate in the background with respect to the main sequence generator and the 16 parallel ramp builders. When first stage acquisition is complete, the detected transmitter sequence is loaded into the back sequence generator and sign adjusted correlator samples are used for tracking. Once second stage acquisition begins, back ramps are used for tracking instead of correlator samples. The back ramp magnitude is used to update a threshold used by the second stage acquisition logic as described in the next section. Since the back sequence generator register only uses the length 16 (or 32) code and never hops to build a longer code, the back ramp stops building when the transmitter begins using a longer code.

Back Ramp Threshold the Second Stage Acquisition (SSA) to find the delimiter. Once SSA starts, the back I/Q ramps begin to build. As the back ramp completes, its quadrature ramp (qramp) is compared to the current value of the back ramp threshold. If the back qramp is greater than or less than the current value of the threshold by a selectable percentage, the back ramp threshold becomes the previous threshold ± the selectable percentage. The selectable percentage may be either 12.5% or 25% as selected by a range bit in the acquire Control register.

For example, if 25% is selected and the current back ramp threshold is 40 the upper and lower limits before the back ramp threshold would change to 40+0.25(40)=50 and 40−0.25(40)=30. As each back qramp completes, it is compared to these limits. If the qramp is inside these limits, the back ramp threshold doesn't change. If the ramp is outside the limits the threshold becomes the limit value. In our example, if the back qramp was 50, the upper limit (40) would be exceeded and the back ramp threshold would become 40. If the back qramp were 20, the lower limit (30) would have been exceeded and the threshold would become 30. This operation continues as each back ramp completes until the delimiter is found or the receiver aligns with the intermediate ramps when longer integration lengths are used.

The dynamic method of updating the back ramp threshold after each back ramp compensates the ramp magnitude changes due to such factors as the change of distance between the transmitter and receiver, while the acquire logic searches for the delimiter in SSA.

Check Lock

Another method used to reduce false acquires involves a comparison called check lock. The reason for the comparison is that if the last ramp built, for example, a signal optimization process, as described later, is significantly smaller than the ramp that completed FSA, it is probable that the transmitter is either no longer sending its acquire header or there was never an acquire header on the air to begin with (a false acquire). The sum-of-squares acquire ramp that passed FSA is compared with the last Sigopt sum-of-squares ramp using the following formula:

Last Sum-of-Squares Ramp>fsa_track*FSA Sum-of-Squares Ramp

The fsa_track factor is selectable from 1 to 1/8 in steps of ⅛. This equation is evaluated by the acquire logic each time the Master Sequencer switches the acquire mode from Track to SSA. The acquire logic sends the comparison result to the Master Sequencer just after switching to SSA. Referring to Table 10, AcquireStatus[0] is normally used for the ramp_done signal but on the third clock after switching to SSA the signal becomes compare_valid and AcquireStatus[1] contains the comparison result called fsa_track_compare. The result is sent once. All remaining signals sent to the Master Sequencer by the acquire logic during SSA are listed in Table 10 under AcquireMode SSA.

The check lock comparison is performed by the acquire logic and the results are sent to the Master Sequencer.

Second Stage Acquisition

Second stage acquisition follows the initial tracking phase and is used to find the acquisition delimiter. After successful first stage acquisition, the receiver and transmitter are aligned to the length 16 or 32 code. For code length 16 and integration lengths of 256 or code length 32 and integration lengths of 512 or less, a single delimiter is sent by the transmitter and can be detected by the acquisition logic with no additional alignment steps. For integration lengths greater than 256 (greater than 512 for length 32 codes), the receiver logic first becomes aligned with the length 256 code before alignment to longer codes can be done.

As ramps are built during second stage acquisition they are checked using the following formula.

Max SSA Ramp>(Back Ramp Factor)×(Back Ramp Threshold)

The back ramp factor is selectable via the Acquire Control register. The exemplary values for the back ramp factor are 1, ⅞, ¾, and ⅝.

For acquisition code length 16 and integration lengths of 256 or less (512 or less for length 32 codes), once a ramp is found that meets the equation above, second stage acquisition is complete and either the radio command byte is received and compared or data demodulation begins.

For acquisition code length 16 and integration lengths greater than 256 (greater than 512 for length 32 codes), the logic first searches for a ramp built from the length 256 (512) code that meets the threshold equation. Once the ramp is found, the receiver is aligned to the length 256 (512) code and the logic searches for the delimiter by building ramps using a code equal in length to the integration length. When the delimiter is found, second stage acquisition is complete and the Master Sequencer is notified. The acquisition logic demodulates the radio command bits and notifies the Master Sequencer that SSA in complete. The acquisition logic also provides the result of the radio mode byte comparison.

Long Code Acquisition

In addition to the parallel acquire techniques that use either length 16 or 32 codes that have been discussed so far, the Greenwich acquire logic also supports acquisition using codes up to length 1024. The additional technique, called long code acquire, shares many of the same steps used in short code acquire but also has several key differences.

To enable long code acquire the code length field in the Acquire Control register is set to long code. Long code acquire isn't based on the 16 position frame format discussed previously. Long code acquire uses all four correlator pairs and each pair samples once per frame. Four ramp builder pairs are used (instead of 16) to build acquire ramps, but the sequence generator is not used. Instead of a ramp being made up of samples from different correlators, as was the case for short code acquire, the long code acquire ramps are built from samples obtained by one correlator pair. Therefore ramp0 builds from samples from correlator A, ramp1 builds from correlator B samples, etc.

Once the four I/Q ramps complete, the maximum and next maximum ramps are found and thresholding takes place using threshold equations 1 and 2. Quick check is supported for long code acquire so threshold equations 3 and 4 are used if quick check is performed. Once FSA is complete acquire is placed in Track mode, then into SSA mode. Check lock is then performed just as it is for short code acquire and SSA completes when the delimiter is found.

The acquire header used for long code acquisition is similar to the header format used in short code acquire when the acquire integration length is short (256 or less for length 16 codes, 512 or less for length 32 codes). The transmitter sends a long string of pulses that build corresponding ramps, followed by one negative ramp called the delimiter. This is the header format for all long code acquire headers regardless of the integration length. The same delimiter thresholding method used in short code acquire is also used in long code SSA so the same back ramp threshold and back I/Q ramps are also used. Radio mode is available for long code acquire.

The master sequencer input AcquireRamplndex[1:0] is driven by the acquire logic and is only valid for long code acquire. The signal is used to specify which of the four correlator pairs built the maximum ramp that passed the FSA threshold. The master sequencer uses this information to know where to place the correlators.

The present invention supports code lengths 64, 128, 256, 512, and 1024 in long code acquire mode. Code length 16 and 32 are also supported but the faster short code acquire technique should be used if these lengths are acceptable. Preferably, acquire integration lengths are less than or equal to the code length. For example, an integration of 32 pulses using a length 128 code can be used. For a maximum code length of 1024, the maximum integration length can be equal to or less than 1024. Also, the transmit header FIFO can be used to send the acquire header and the payload header. Under this arrangement, the acquire integration length is equal to the payload header integration length.

Acquisition Time

The time required to complete first stage acquisition, initial tracking, and second stage acquisition is referred to as the acquisition time. The formula used to determine the acquisition time is given below:

$$Acquire Time = first stage acquire time + tracking time + second stage acquire time = ( ramp time ) ( frame length \text{/} step ) ( code length / 16 ) + 25 ( ramp time ) + 3 ( ramp time )$$

The frame length is adjustable between 1× and 2× the period of the reference frequency. With the reference frequency typically 20 MHz, the frame length ranges between roughly 50 ns and 100 ns. The ramp time is simply the amount of time required to build a ramp and is given by the frame length times the acquisition integration length. The step variable is the distance the correlators are advanced (rolled) between ramps. A larger step size allows the frame to be covered more quickly but a step size set too large may step over a pulse.

The best-case acquisition time occurs when code length equals 16, the integration length equals 16, the step size is set to 3 ns and the frame length is set to 100 ns. Plugging these numbers into the equation above, the acquisition time becomes:

$$Acquire Time = ( 100 ns * 16 ) ( 100 ns / 3 ns ) ( 16 / 16 ) + 25 ( 100 ns * 16 ) + 3 ( 100 ns * 16 ) = 53.3 us + 40 us + 4.8 us = 98.1 us$$

For a length 32 acquire code, the minimum acquisition integration length becomes 32 and the acquire time becomes:

$$\begin{matrix}Acquire Time = ( 100 ns * 32 ) ( 100 ns / 3 ns ) ( 32 / 16 ) + \\ 25 ( 100 ns * 32 ) + 3 ( 100 ns * 32 ) \\ = 213.3 us + 80 us + 9.6 us \\ = 302.9 us\end{matrix}$$

The long code acquisition time is given by the following formula.

$$\begin{matrix}Acquire Time = first stage acquire time + tracking time + \\ second stage acquire time \\ = ( ramp time ) ( frame length / step ) ( code length ) \\ ( 0.25 ) + 25 ( ramp time ) + 3 ( ramp time )\end{matrix}$$

The 0.25 factor comes from using 4 correlator pairs to search either the code or frame space instead of only one pair. Including the code length parameter significantly increases the long code acquire time.

Acquisition Logic Design

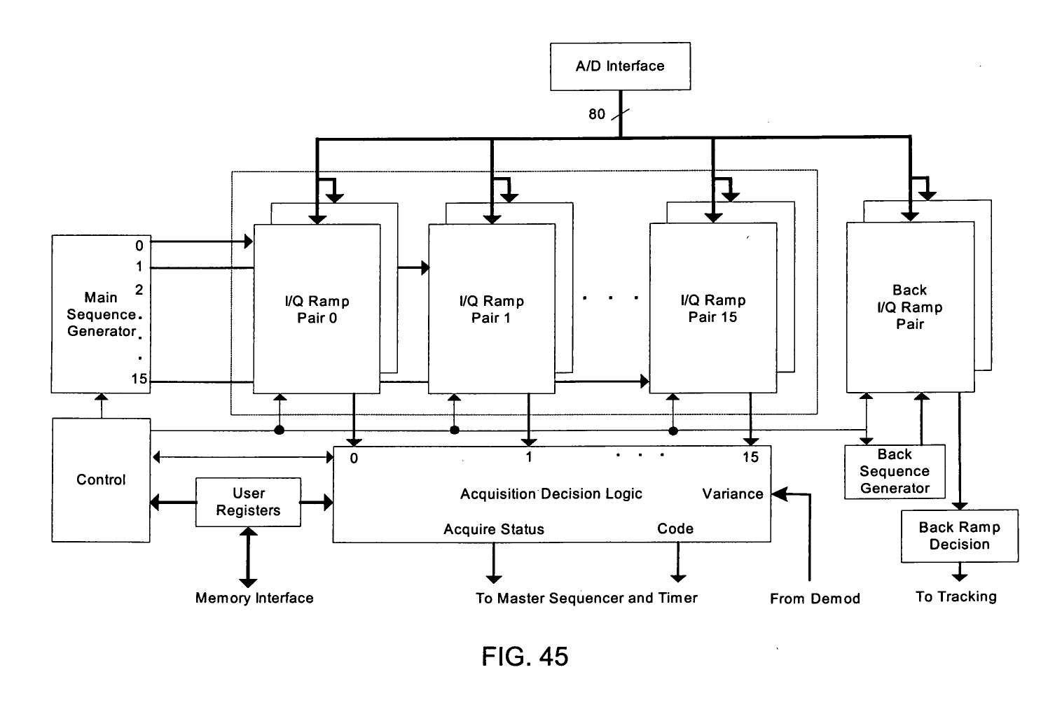

The acquisition logic is shown in FIG. 45 and is divided into four main areas: sequence generators, ramp builders, control, and decision logic. The acquisition logic contains two separate sequence generators called the main and back sequence generators. During short code acquisition the main sequence generator supplies the 16 parallel ramp builder pairs with the 4-bit code that, within each correlator, selects one of eight correlator samples and optionally inverts the sample. The back sequence generator supplies the correlator select code to the single back ramp pair. During long code acquisition, the main sequence generator's first four outputs are fixed and are used to select one of the four correlator samples. The main sequence generator is initialized with the contents of the acquisition code registers at the start of acquisition. The main sequence generator also derives any longer code from the length 16 or 32 code. The back sequence generator is initialized with the transmitters sequence found during first stage acquire and only operates from the length 16 or 32 code.

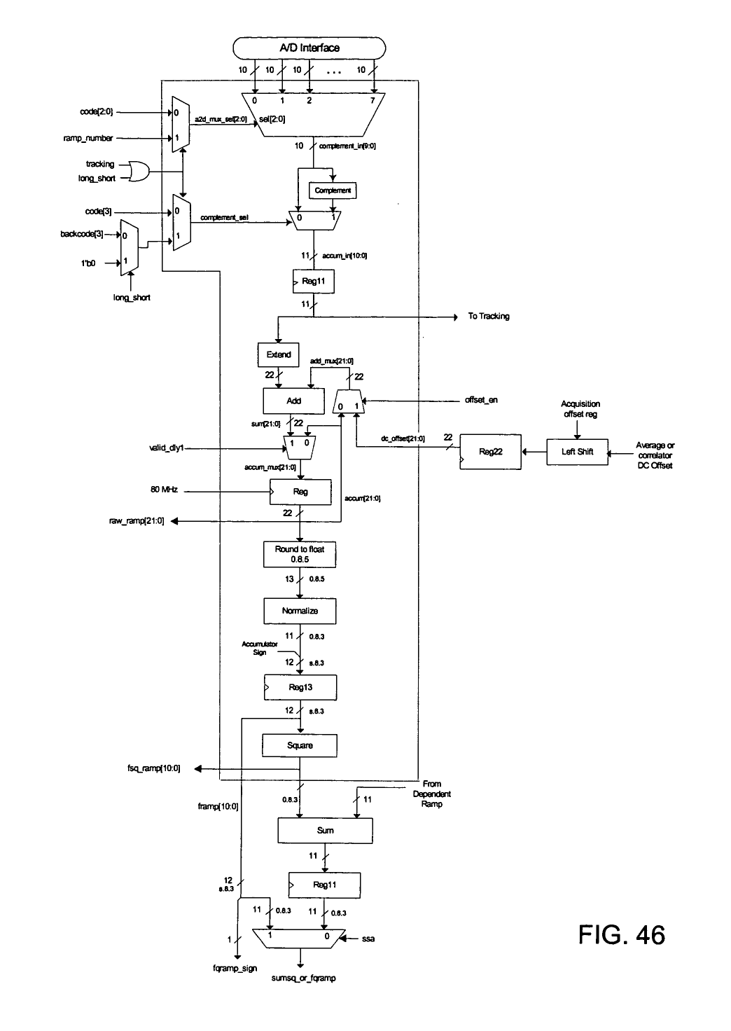

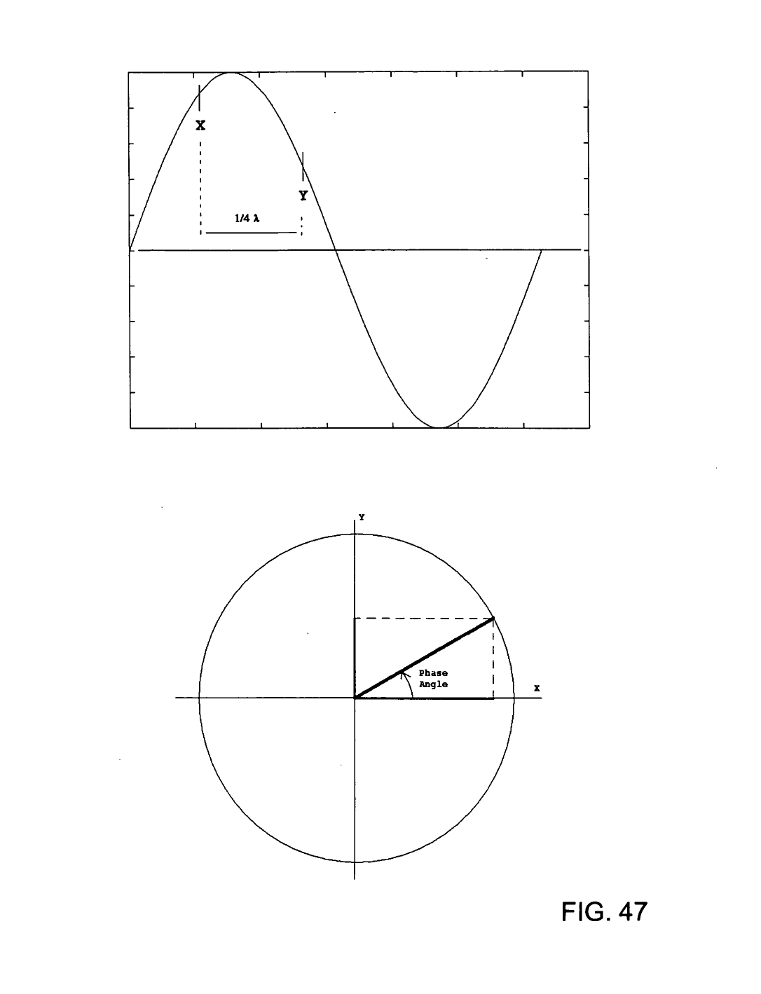

During short code acquisition, the sixteen ramp builder pairs are used to search for the transmitter's signal during acquisition. Each ramp builder selects one of the eight A/D samples, optionally twos-complements the sample based on the code from the sequence generator, and then adds the result to the ramp accumulator. Long code acquisition uses four of the sixteen ramp builders and does not twos-complements the correlator samples since flipped pulses are not used. After each ramp builder has added the correct number of samples (based on the acquisition integration length register), the sum-of-squares ramp magnitudes are used by the threshold logic to determine if acquisition is complete. The back ramp pair is used during second stage acquisition. The block diagram of a single ramp builder is shown in FIG. 46.

Referring to the FIG. 46, the A/D Interface supplies the 10-bit correlator samples to each ramp builder when the valid_dly1 signal is asserted. For short code acquisition, the four bit code from either the main or back sequence generator is used to select one of the eight samples and optionally twos-complement of it. During long code acquisition, the code input is fixed so that the ramp builder selects the same correlator output. The correlator sample is summed with either a DC offset (if this is the first ramp sample) or the ramp accumulator. Once the correct number of pulses has been added, the ramp is rounded to an unsigned 8.5 floating-point number, normalized for integration, squared, and then summed with its quadrature ramp (qramp) to arrive at the sum-of-squares ramp.

The acquisition control logic is responsible for controlling the ramp builders and sequence registers during acquisition. The control logic manipulates the main sequence generator when longer codes are needed, reinitializes the ramp accumulators when ramps are complete, and initializes and controls the back ramp logic during second stage acquire.

The acquisition decision logic compares the ramp magnitudes and correlator variances to determine if acquisition is complete according to the threshold equation logic and formulas covered in the first and second stage acquisition sections.

Acquisition Registers

The following registers can be read or written by the host processor and are used to control the acquisition process:

The acquisition code registers contain the length 16 or 32 code used during short code acquisition.

The acquisition integration length register contains the desired number of pulses per ramp.

The acquisition control register sets several acquisition parameters including the acquisition mode (long code/short code), the back ramp, scan2, and range threshold factors, and the factor used to compare the last FSA and track ramps.

The four acquisition Threshold*Equation registers configure the four threshold equations. The registers select which terms are used, the operation of the OP₁ and OP₂ functions, and how the right and left side of each equation are compared (<, >, =, ≠).

The four Threshold*Registers provide the Register₁ and Register₂ values to each of the four acquisition threshold equations.

The radio mode command register is used to enable or disable the radio mode comparison. If enabled (bit 8=1′b1) the lower 8 bits of the register are compared to the received radio mode byte. The comparison result is sent to the Master Sequencer.

The following registers can only be read by the host processor and are used to provide acquisition status information:

The received radio mode register stores the received radio mode byte when the radio mode function is enabled. The register is overwritten each time a new radio mode byte is received. To avoid overwriting a miscompared radio mode byte, the radio would go to an idle mode until the resulting interrupt from the miscompare has been handled.

The acquisition status register provides the Boolean result of each first stage acquire threshold equation.

The three sets of ramp magnitude and variance registers capture the largest and next largest ramp magnitudes, ramp indexes, and the variance statistics detected in each of the FSA, scan1 and scan2 first stage acquisition modes.

The Track Magnitude and Track Variance1-3 registers capture the largest ramp magnitude, next largest ramp magnitude, ramp indexes and all variance statistics when Acquire is placed in Track mode at FSA completion.

Tracking

Tracking Overview

One challenge in building a UWB radio is maintaining a common time base between two radios. Since the radio's time base is derived from a reference clock that is generated from an imperfect source, the time base differs slightly from radio to radio. The objective of tracking is to keep the two radios synchronized to the same time base.

As with any radio system, a UWB transmitter creates a signal for a receiver to interpret. Even without modulating data on this signal, it contains information about the transmitter. To the receiver, the difference in time bases manifests itself as the pulse ‘drifting’ in time (phase drift). If the receiver can determine the phase drift rate, it has determined the difference in time bases. Since the receiver has the opportunity to learn this difference, it should attempt to match the transmitter.

Tracking accomplishes this drift rate measurement by determining the phase angle at the sample location. By measuring the phase at different points in time, the rate of phase change can be calculated. To calculate the phase, Tracking samples the incoming pulse using a pair of correlators (samplers) that are separated by ¼ wavelength. The phase of the pulse is related to these samples through the arctangent of the ratio as depicted in FIG. 47. This phase information is used as the error signal for a closed loop controller.

Since the incoming signal is noisy, integration is employed to increase the SNR. Integration is the processes of adding successive samples (‘building a ramp’) and is simply vector addition from a tracking viewpoint. Since the phase is changing, the post-integration angle is the mean of the phase angle during the summation. This fact extends the ability of the tracking logic to track larger drift rates.

Master Sequencer outputs can be configured to specify various modes of operation for Tracking. The Tracking Mode is used to specify which logic block controls the Tracking loops. The Tracking Mode is specified by Master Sequencer outputs as defined in Table 13.

TABLE 13
Tracking Mode Definition

| Bits | Tracking Mode |
|---|---|
| 4′b1000 | Used for all tracking activities except OLDE. |
| 4′b1001 | OLDE has control of tracking. |

The Tracking Ramp Select Mode is used to specify which logic module is supplying ramp data to Tracking. The Tracking Ramp Select Mode is specified by Master Sequencer outputs as defined in Table 14.

TABLE 14
Tracking Ramp Select Mode Definition

| Bits | Tracking Ramp Select Mode |
|---|---|
| 2′b00 | OLDE supplies ramps to the tracking loop. |
| 2′b01 | Signal Optimization supplies ramps to the tracking loop. |
| 2′b10 | Acquisition supplies ramps to the tracking loop. |
| 2′b11 | Demodulation supplies ramps to the tracking loop. |

Tracking receives ramp data from the ramp-builders and applies those ramps toward a Tracking ramp. The integration length specified is important for ramp alignment. For example, during Signal Optimization, if Signal Optimization's integration is 16 and Tracking's integration is 64, then 4 Signal Optimization ramps are collected by Tracking into a larger Tracking ramp that is then used to calculate phase corrections and updated drift-rate estimates. However, if Signal Optimization's integration is larger than Tracking's integration, the ramps are misaligned. Therefore, to ensure alignment, Tracking's integration is greater than or equal to the integration of the logic module that is supplying ramps to Tracking.

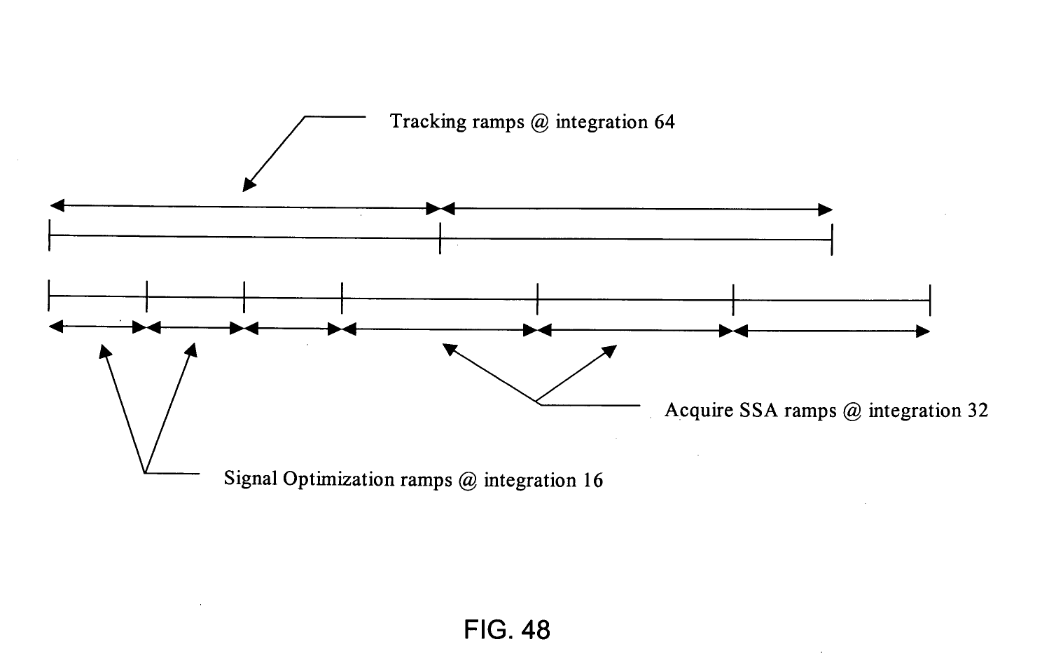

Misalignment also occurs whenever the supplying ramp builder's integration increases. For example, if Signal Optimization's integration is 16, Tracking's integration is 64, and 3 Signal Optimization ramps are built and supplied to Tracking, then, by changing states to Second Stage Acquire (SSA), Acquire becomes the supplying ramp builder with an integration of 32. Now the Acquire ramps and the Tracking ramp are not aligned because of the odd number of length-16 Signal Optimization ramps and the increase in integration from 16 to 32. The tracking misalignment is illustrated in FIG. 48. If such misalignment occurs, Tracking updates are not performed, i.e. Tracking essentially becomes non-functional.

Therefore, to ensure alignment, the supplying ramp builders' integration length is not increased from one supplier to the next regardless of the sequence of supplying logic modules. For example, in a typical receive mode, (Signal Optimization integration)>=(Acquire integration)>=(Demod Header integration)>=(Demod Data integration). The sequence of supplying logic modules can vary depending on the radio's operating mode; however, the integration length is not increased from one module to the next.

The Tracking Loop Select Mode is used to specify whether the Timers are tracking independently or are all driven by a single loop. The Tracking Loop Select Mode is specified by Master Sequencer outputs as defined in Table 15.

TABLE 15
Tracking Loop Select Mode Definition

| Bits | Tracking Loop Select Mode |
|---|---|
| 3′b0xx | Where xx is used to specify the timer used to control all tracking |
| | loops. 00 = Timer A, 01 = Timer B, 10 = Timer C, |
| | 11 = Timer D. |
| 3′b100 | Independent Tracking. Timer A controls the A loop, Timer B |
| | controls the B loop, Timer C controls the C loop and Timer D |
| | controls the D loop. |
| 3′b101 | Signal Optimization logic controls the tracking loop. |

Tracking Controller

Tracking has two stages. During the first stage, which is referred to as Open Loop Drift Estimation (OLDE), the receiver attempts to initially measure the drift rate. This provides the closed loop controller with a reasonable estimate of the drift rate and an opportunity to orient the correlators on the pulse for maximum demodulation SNR. The second stage involves engaging the closed loop controller for the receiver to maintain synchronization with the transmitter.

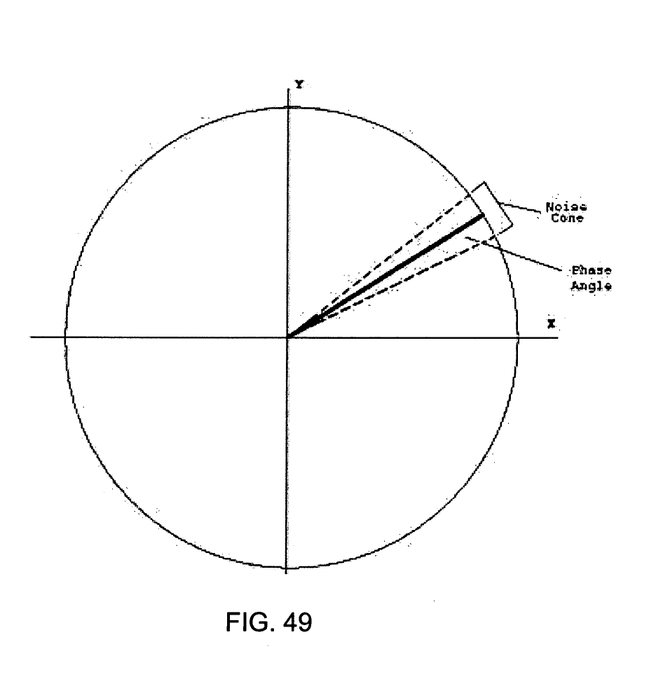

The OLDE stage occurs between First Stage Acquisition (FSA) and Second Stage Acquisition (SSA) and plays a balancing act. Due to the noise in the measurement, the exact phase of the pulse isn't known. Rather, the phase is known with some degree of uncertainty. This uncertainty is related to the post-integration SNR. Since the uncertainty is a result of noise and forms a cone around the measured phase, it's sometimes referred to as a noise cone. Noise impact on phase angle is illustrated in FIG. 49. The larger the phase drift, the less the rate calculation is affected by the uncertainty.

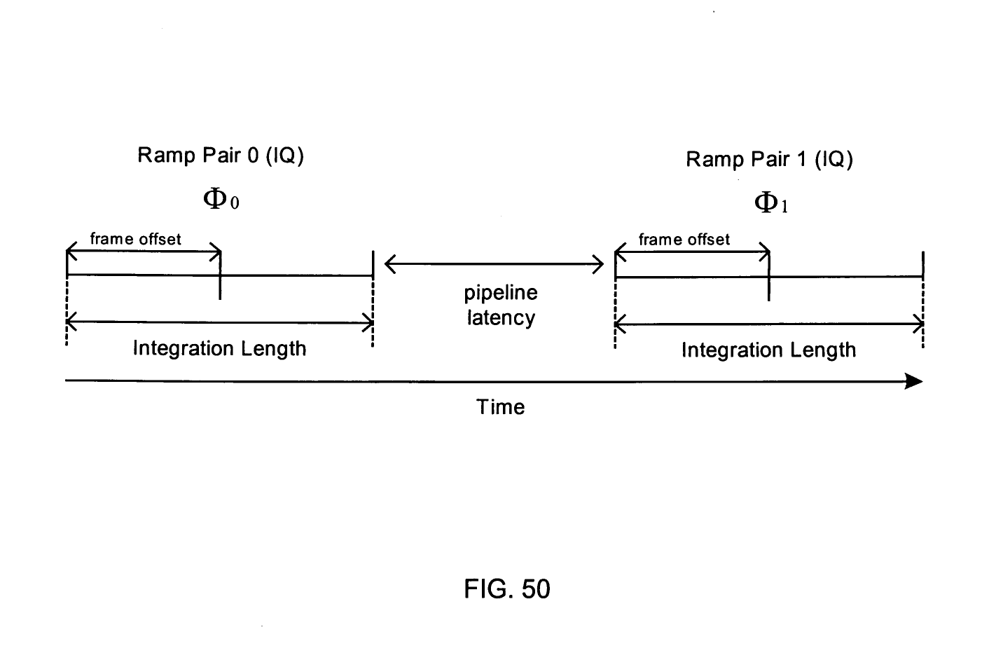

During OLDE, two pairs (IQ) of ramps are built at the same location within a frame, but separated in time. This is illustrated in FIG. 50. At the completion of building the second ramp pair, the phase drift between the first and second ramp pairs is calculated. An OLDE Ki coefficient is used to remove the pipeline latency contribution to the phase delta calculation. This allows tracking to simply normalize the phase delta with respect to the integration to calculate the frequency error. A Kc coefficient is used to account for the change in phase error caused by the frequency error and pipeline latency.

The OLDE stage completes with an initial estimation of the drift being passed to the closed loop controller and the correlator pair being properly oriented on the pulse. Tracking's closed loop controller is engaged immediately after the OLDE stage. During the closed loop stage of tracking, Acquisition, then Demodulation supplies ramps to the tracking loop. The controller is given complete, demodulated ramps. The ramps are normalized (shift leading zeros out of x-channel) and are used to form an address into a programmable Offset Look Up Table (LUT) as described in the following paragraphs.

The Offset LUT is a 128×8 SRAM of OffsetLutData entries addressed by OffsetLutAddress. The function that the Offset LUT implements (i.e. OffsetLutData entries) is arctan(N/D). The function takes two inputs (N and D), and involves two operations (division and arctan). The two inputs are the Numerator and the Denominator that are derived from the incoming I and Q ramps as explained below. The Numerator and Denominator are also used to build the OffsetLutAddress as explained below. The values stored in the Offset LUT specify one octant (⅛ cycle) of the signal. That is, the largest value stored in the Offset LUT is 31.875 Timer fine bins, or 45 degrees. Given this one octant, the signs of the inputs, and their relative magnitudes, the calculated offset is expanded into a full cycle.

The I and Q ramp inputs are 22-bits each. To use all 22-bits from each ramp would require over 17,000 billion table entries (2\hat{ }44). Instead, the OffsetLutRatio is used to select a subset of bits from each ramp. The OffsetLutRatio selects the width of the Numerator and Denominator fields according to Table 16.

TABLE 16
OffsetLutRatio Definition

| Bits | Behavior |
|---|---|
| 2′b00 | 4 bits of Numerator, 4 bits of Denominator |
| 2′b01 | 5 bits of Numerator, 3 bits of Denominator |
| 2′b10 | 6 bits of Numerator, 2 bits of Denominator |
| 2′b11 | 7 bits of Numerator, 1 bit of Denominator |

The different ratios of Numerator and Denominator bits allows for a different distribution of resolution. For example, 4 bits each provides the most uniform distribution around the unit circle, but it has the largest quantization around zero. Uniform distribution is better for OLDE, but small quantization around zero is better for steady-state tracking. For example, an OffsetLutRatio of 2′b00 selects the 4 most significant bits from the larger of the two ramps (Denominator) and the 4 corresponding bits from the smaller ramp (Numerator). The Offset LUT contains only the first octant where N=<D always. No values are written into the Offset LUT where N/D>1. Continuing the example, if

I=22′b 00_{—}0000_{—}0001_{—}1001_{—}0111_{—}0011

Q=22′b 00_{—}0000_{—}0000_{—}0100_{—}0100_{—}0101

the relative magnitudes and signs determine the Numerator and Denominator. In the example, the I ramp is larger, so it is the Denominator. Starting at the first 1 of the I ramp, 4-bits (1_{—}100) are selected along with the corresponding 4-bits of the Q ramp (0_{—}010). The Q ramp is smaller so it is the Numerator. Therefore, the inputs to the Offset LUT arctan function are D=1_{—}100 (0×C) and N=0_{—}010 (0×2). The N and D values are then concatenated to form an Offset LUT address. Since the MSB of the D value is always a ‘1’, it isn't used. The address formed for this example is {N∥D}={0010,100}=>{001_{—}0100}={0×14}. The OffsetLutData at that address is the corresponding arctan(N/D) offset.

The Offset LUT provides the controller a measure of the amount of accumulated drift (the offset). Using the offset and the time over which it was accumulated, the controller calculates the new drift rate that is relative to the previous drift rate. To account for pipeline latency, a crossover multiplier factor (Track Kc) is used. The controller then scales the offset by a programmable damping factor (Kp) to obtain the phase correction. The newly calculated drift rate is processed by the controller's history loop. The phase and drift rate corrections are passed to the Timer Interface logic. The Timer Interface logic applies the drift rate correction every frame and the phase correction when provided.

The History Loop

When acquisition threshold is first satisfied and before tracking is established, the tracking loop needs to be aggressively responsive to correlation errors, both in terms of correction limits and correction rates. A gain loop parameter defines the actual size or otherwise the limit of an adjustment or correction that can be made during the tracking process in response to an error. A bandwidth parameter relates to the rate by which such correction is made. Thus, before tracking is established the loop parameters may require high gain and bandwidth. At this stage, the adjustments are made aggressively with large corrections being allowed (i.e., high gain) at high correction rates (i.e., high bandwidth). Once tracking is established, the tracking loop needs to become low gain and bandwidth to maximize noise immunity. This means that the amount of corrections allowed are small (i.e., low gain) and the correction rate is low (low bandwidth). Conventional tracking loops use loop parameters that offer a compromise between gain and bandwidth parameters for all tracking stages.

According to another aspect of the invention, tracking loop parameters are determined by a table, which defines the variance of gain and bandwidth parameters for the tracking loop between the time the acquisition threshold is attained until tracking is established. The tracking loop parameters are stored as entries in a “Gain Look Up Table.” The entries are retrieved as required successively. The first entry in the table is used immediately after the acquisition threshold is satisfied. This entry defines the initial allowed correction amount as well as how long this setting is used before advancing to the second entry. The second entry is then used for an amount of time specified in that entry and so on. Each entry has loop parameters that are appropriate for the loop at that phase of packet reception. The parameters in the Gain Look Up Table may be derived based on histograms that relate to the variance of gain and bandwidth parameters in various environments.

As such, the history loop's intent is to increase the accuracy and noise immunity of the drift rate estimate. The controller's history loop accomplishes this by computing a moving average of the previous drift rate estimates. One way for computing a moving average requires the oldest element in a window to be subtracted and new element added to the sum. The sum is then normalized by a window width. This method, however, requires storing each element in the window. This method quickly becomes unappealing as the window width, and thereby memory required, grow.

Sumₙ=Sumₙ₋₁−Element_{n-windowwidth}+Elementₙ

Meanₙ=Sumₙ/windowwidth

An alternate approach to computing a moving average is to subtract the mean from the sum instead of the oldest element. This method is no more computationally expensive, requires much less memory, and provides a reasonable approximation to the previous method.

Sumₙ=Sumₙ₋₁−Meanₙ₋₁+Elementₙ

Meanₙ=Sumₙ/windowwidth

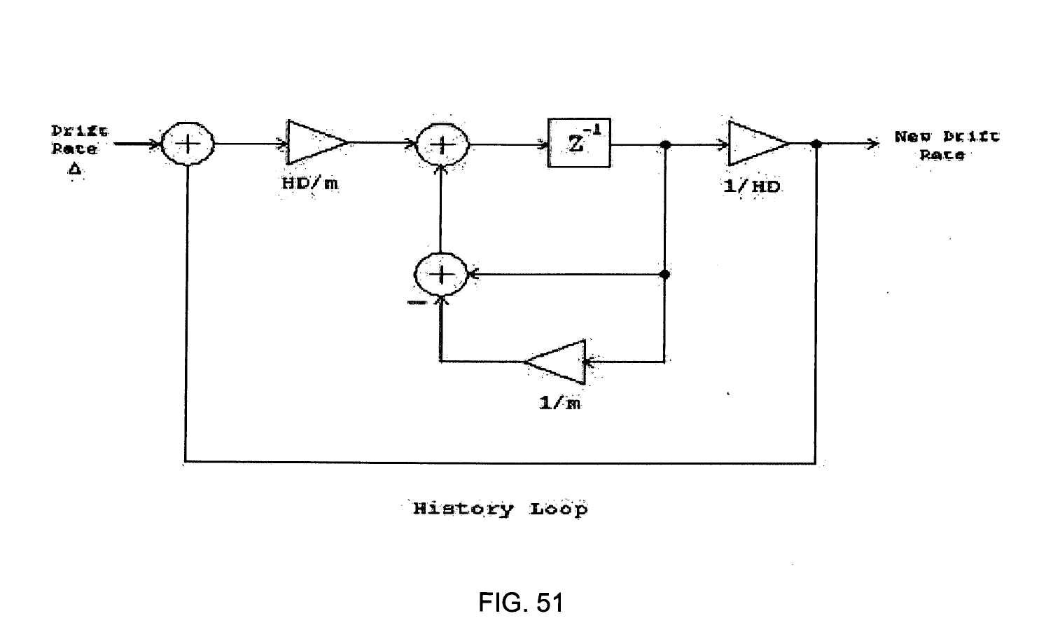

Since the controller is making adjustments in real-time and does not have a full window width's worth of samples, the window size starts at one and is increased up to the desired window size as more data points become available. As the number of samples present in the window increases, each new sample affects the mean less than the previous sample. Each sample contributes (1/number of samples) until the window reaches its desired width, where each contributes (1/window width). Since the window is based in time, this process is referred to as ‘building the loop's history’ and the window width is referred to as history depth (HD). A signal flow diagram illustrating the process is shown in FIG. 51.

The first summing node is present to translate the measured drift from a relative rate to an absolute rate. The absolute rate is then scaled by the input gain. The input gain is a function of the desired history depth (number of samples to average) and the current history depth (number of samples present). The term m, which occurs in two of the three gain terms, is the current history depth rounded up to the next power of two. Once at least history depth samples are present, the input gain, HD/m, is equal to one and the feedback damping term, 1/m, is equal to I/HD. On the output of the filter, a normalization term is present to remove the scaling from the input gain. As the current history depth increases, the input gain term and feedback damping decrease. This process lowers the filter's bandwidth. The Gain Lookup Table (GLUT) is described in the Register Definition section. The bandwidth of the filter is tuned through the history depth. The larger the history depth, the lower the filter bandwidth.

The bandwidth of the history filter is based on the bandwidth of the rate of change in drift and the modulation scheme. Since the controller is being stimulated by demodulated ramps, the modulation becomes a factor in the drift measurement.

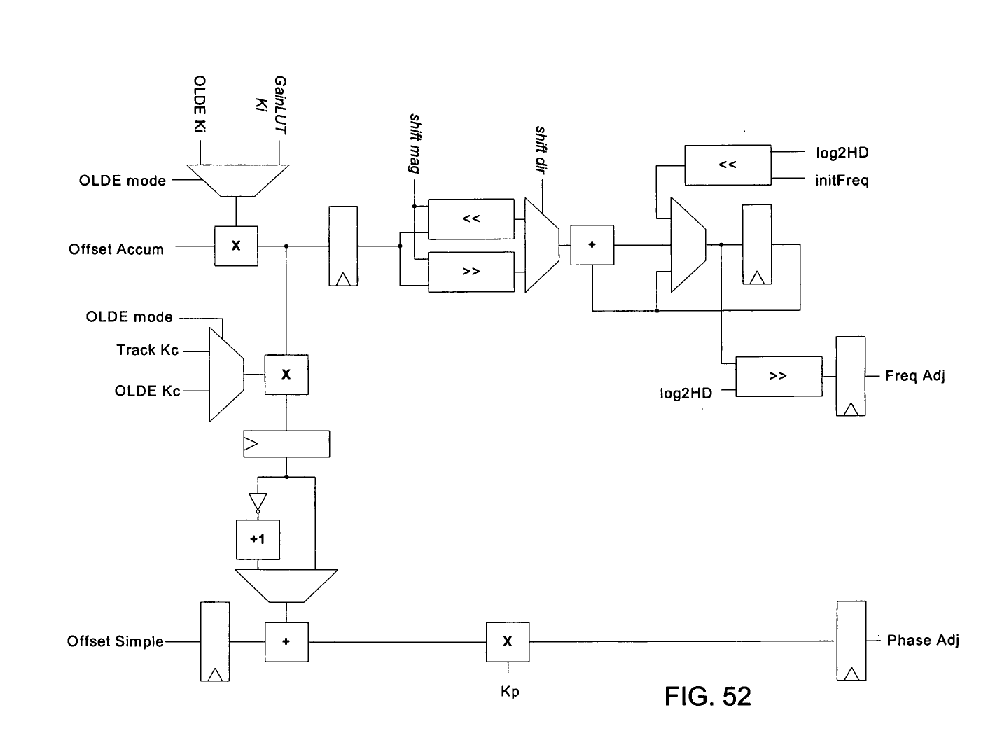

Depending on the modulation scheme used, the maximum amount of drift that the controller can detect/recover from varies. Any modulation scheme using shift modulation limits the detectable accumulated drift to be less than ⅛ wavelength. Flip-only modulation allows up to ½ wavelength. What this means is that the closed loop controller has to be a bit more aggressive (higher bandwidth) for modulation involving shift than it does for flip-only. FIG. 52 depicts the phase and frequency adjustment logic of the history loop.

The following is the math behind choosing an appropriate Kc value:

φ_{adj}=φ₁±[Δφ_{IL}/IL(IL/2+PL)] [eqn #1]

φ_{adj}=φ₁±[Δφ_{IL}(½+PL/IL)] [eqn #2]

Kc-OLDE=(½+PL/IL)

For “steady-state” (closed loop) tracking:

φ₁=Δφ_{IL}

substituting into eqn #2 and realizing the phase error and frequency error are always in the same “direction” during steady-state tracking, φ_{adj} is defined by the following equation:

φ_{adj}=φ₁+[φ₁(1/2+PL/IL)] [eqn #3]

factoring out φ₁:

φ_{adj}=φ₁[1+(½+PL/IL)] [eqn #4.a]

φ_{adj}=φ₁(1.5+PL/IL) [eqn #4.b]

Kc-Track=(1.5+PL/IL)

Where:

IL=integration length

PL=pipeline latency

Δφ_{IL}=Δφ_{OLDE}*Ki-OLDE

φ₁=measured phase error

Note that during “steady-state” tracking that the same thing could be accomplished using a Kp term.

Sources of Drift Rate Change

The controller has three sources of drift rate change to overcome. The three sources are from initial estimation error from the OLDE logic, Doppler Drift due to a change in velocity, and thermal induced due to a change in the temperature of the reference clock's oscillator.

The first source, which is not truly a change in drift rate, is removing the error from the initial estimate provided by the OLDE. The OLDE logic provides a measure of the drift that is an estimate. This measurement is only as accurate as allowed by the noise. By taking repeated measurements and averaging, the drift rate becomes more accurate as the noise averages to zero. Since the drift rate error is constant in this scenario, it is much easier to correct.

A second source of drift rate change, which is an acceleration of drift, is a change in relative velocity of the radios (Doppler Effect). This is by far the smaller source of drift acceleration and is virtually negligible. For example, if the mean drift over the course of a tracking ramp were 62.5 ps, the total actual drift would be 125 ps. This translates into a movement of 0.125 ft. Assume a very slow tracking sample rate of 1 kHz (1 ms), one radio would have to accelerate at a rate of 0.125 ft/(1 ms)² or 125,000,000 ft/s². A more realistic example would be a very fast motorcycle. A fast motorcycle could accelerate from 0-60 mph (88 ft/s) in roughly 3 seconds. The average rate of acceleration for this example is 29.3 ft/s². The drift observed in 1 ms would be 14 fs, which is about 1/100 of a degree.

The dominant factor in drift acceleration is thermally induced. The frequency of the reference clock is proportional to the temperature of the crystal oscillator used to generate the clock. In choosing an oscillator, therefore, the thermal response of the oscillator should be studied.

Signal Optimization

Since acquisitions' objective is to find any pulse energy that is on its code sequence, the acquire point may not be the ‘best’ point to maintain lock or demodulate. The objective of Signal Optimization is to find a better point. So, after short-code acquisition, the receiver moves the timer channels around the lock point for Open Loop Drift Estimation (OLDE). After OLDE has established lock using loop A, Signal Optimization begins.

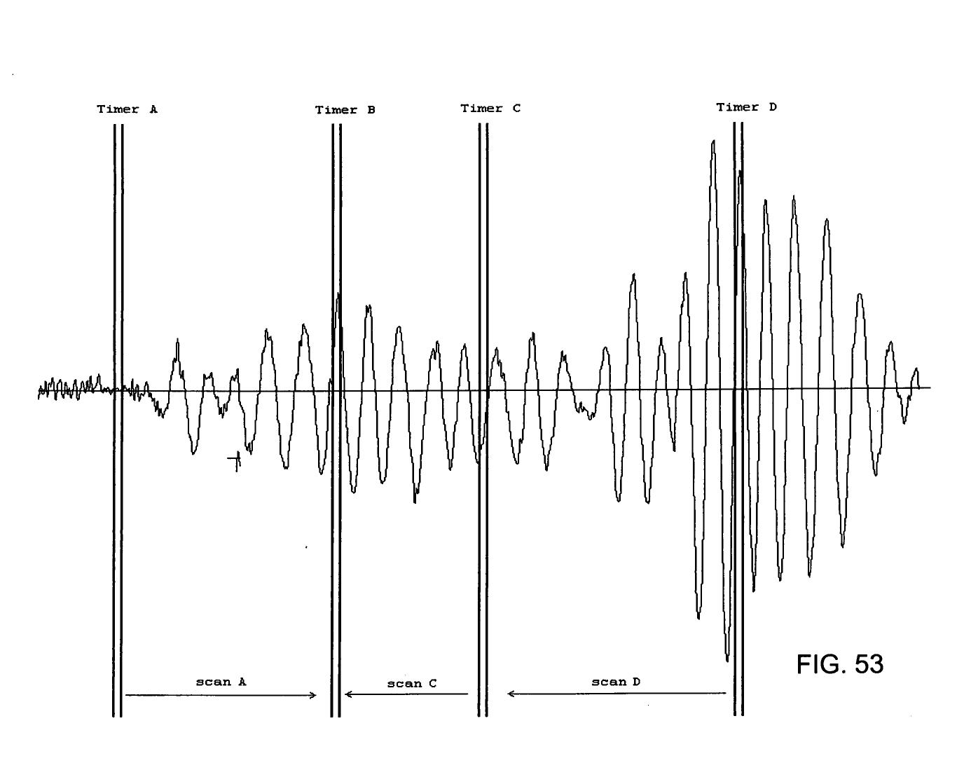

Since the receiver is now locked to the transmitter, it may now spend more time performing Signal Optimization without having the pulse drift away. After the OLDE stage, the Timer Scan Engine places the Timers around the lock point as shown in FIG. 53. While one Timer is used to maintain lock, the remaining three scan an area about the lock point. As each Timer scans a region, Signal Optimization observes the scan and saves the location in the region that the most energy was found. Signal Optimization measures the energy at a point by summing the squares of the ramp built at that point. At the completion of the scan, Signal Optimization restores the “best” from each region to its corresponding active context. The Scan Engine Timers are then moved to the nearest zero crossing. This new “zero offset” location is then saved to the corresponding Timer's context location zero. If one of the scan points best value is better than the acquire lock point, Signal Optimization activates the loop corresponding to the new best Timer. The freshly activated loop is allowed to settle for a configurable number of ramps prior to returning control of the radio to the Master Sequencer. This process is called Fine Lock.

Rake Tooth Placement and Signal Optimization

The Signal Optimization Logic is also employed when configuring the radio in rake mode. A rake receiver attempts to increases the SNR by sampling a pulse at multiple locations within a single frame. The Signal Optimization Logic assists in determining locations for these samples, also known as rake teeth. After the Signal Optimization process described above is complete, the Master Sequencer brings up the rake teeth by restoring all context location zeros to their active context and changing the Tracking Loop Select Mode to Independent Tracking.

When placing rake teeth on different reflections received at the multiple locations, it is desired that the teeth be placed on the strongest reflections. Conventional approaches use a time consuming serial process for finding the strongest reflections, i.e., find the strongest first, followed by the next strongest, etc. Another conventional approach uses a large number of teeth at regular intervals and discards those detecting weak or no reflections.

According to another aspect of the present invention, programmable search zones are used to reduce rake training time. More specifically, parallel running correlators are used to search each zone concurrently to find the best placement spot in each zone. Counters are used to keep track of how often a tooth representing a zone qualifies against the “Fussiness factor.”

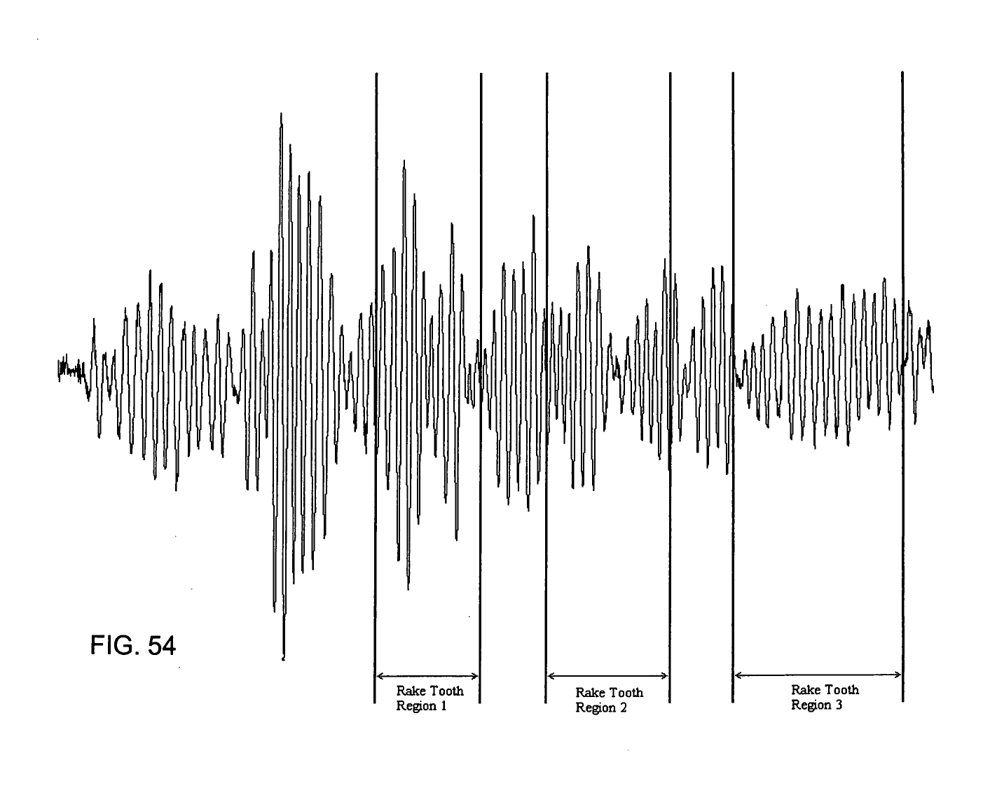

A zoning algorithm running on a control level processor can determine the zone boundaries empirically, based on multipath environment and link distances encountered in a particular application. Preferably, the zone boundaries are programmable, thereby allowing for dynamic dimensioning (or re-dimensioning) of a particular zone. For example, if the Fussiness factor for a particular zone rarely gets satisfied as determined from the counters, it is assumed that insignificant useful energy is present in that zone. Based on such determination, the zoning algorithm can update the zone boundaries. As such, this aspect of the invention relates to an apparatus and method that uses programmable placement zones to guide rake tooth placement. Rake tooth placement is depicted in FIG. 54.

To perform rake tooth placement, each Scan Engine is configured properly. A region is specified through two Scan Engine instructions. One instruction is needed to specify the start of the region relative to the acquisition lock point. The second instruction specifies the length of the region (step count), the integration count (dwell count), and the granularity of the search (step size).

For best results, the number of Signal Optimization ramps IS an integer multiple of the tracking integration length during each stage of Signal Optimization (pre-scan train, scan, post-scan train). For example, if Signal Optimization integration is 16 and tracking integration is 64, valid values for number of Signal Optimization ramps in each stage is 4, 8, 12, 16, etc. That is (# of SigOpt ramps in a stage) % ((Tracking Integration)/(SigOpt Integration))=0×0.

Demodulation

The demodulation logic operates in one of two modes: (1) acquire mode and (2) demodulation mode. During the acquire mode the demodulation logic's main function is providing signal processing support to the acquisition logic. During the demodulation mode the demodulation logic's primary task is extracting (demodulating) data from the received signal. There are various methods used for demodulating the data such as flip demodulation, dynamic rake demodulation and nulling demodulation just to name a few. The Demodulation Logic Mode is determined by the DemodAcquireMode Master Sequencer output as defined in Table 17.

TABLE 17
Demodulation Mode Definition

| DemodAcquireMode | Demodulation Logic Mode |
|---|---|
| 1b′0 | Demodulation Mode |
| 1b′1 | Acquire Mode |

Some functions of the demodulation logic are required regardless of the current mode of operation. These support functions include: (1) management of gain, (2) application of Digital Gain to the incoming analog to digital converter (ADC) samples and to supplied DC Offset values, (3) building ramps and calculating sample variances and (4) “packing” or arranging data prior to storage in the receive FIFOs. The demodulation logic can also be used to perform some Greenwich calibrations including: (1) calculation of ADC DC Offsets, (2) calculation of correlator channel-to-channel gain differences and (3) calculation of Timer channel-to-channel timing differences.

Support Functions

The following sections cover those demodulation logic functions that are necessary regardless of the mode.

Management of Gain

Demodulation controls the gain between the antenna and the signal processing logic in two sections: (1) VGA gain and (2) digital gain. Each section is also divided into two channels, A/B and C/D, corresponding to the two Correlator2 chips. The gain control logic controls both of these gain channels independently. The gain of the VGA in each of the two Correlator2 chips is controlled with DACs. If the VGA gain proves to be inadequate to reach the specified amplitude targets for the gain control engine, then additional “digital gain” is introduced by multiplying the numbers from the ADCs by numbers that are potentially as large as 224 (decimal). This additional 47 dB of amplitude gain switches in and out smoothly as the control loop asks for more or less gain than the maximum VGA Gain setting.

The management of gain takes into consideration the entire loop gain. This potentially includes contributions from the VGA circuitry on the Correlator2 chip as well as digital adjustment (amplification) of incoming ADC data. As mentioned above, the gain correction circuitry is driven by two separate gain values: (1) 5-bits of VGA DAC data and (2) 5-bits of digital gain data. When the 5-bit VGA gain value is less than the specified Maximum VGA Gain value, the VGA circuit accomplishes the full gain correction and the digital gain value is zero (or ×1). When the VGA Gain reaches the Maximum VGA Gain and more gain is required, the remainder of the gain correction is accomplished by the digital gain logic. For best performance the Maximum VGA Gain Value is set such that the VGA operates at the point of minimum noise figure. In an exemplary embodiment, the voltage gain is set to about 25 dB for minimum noise figure.

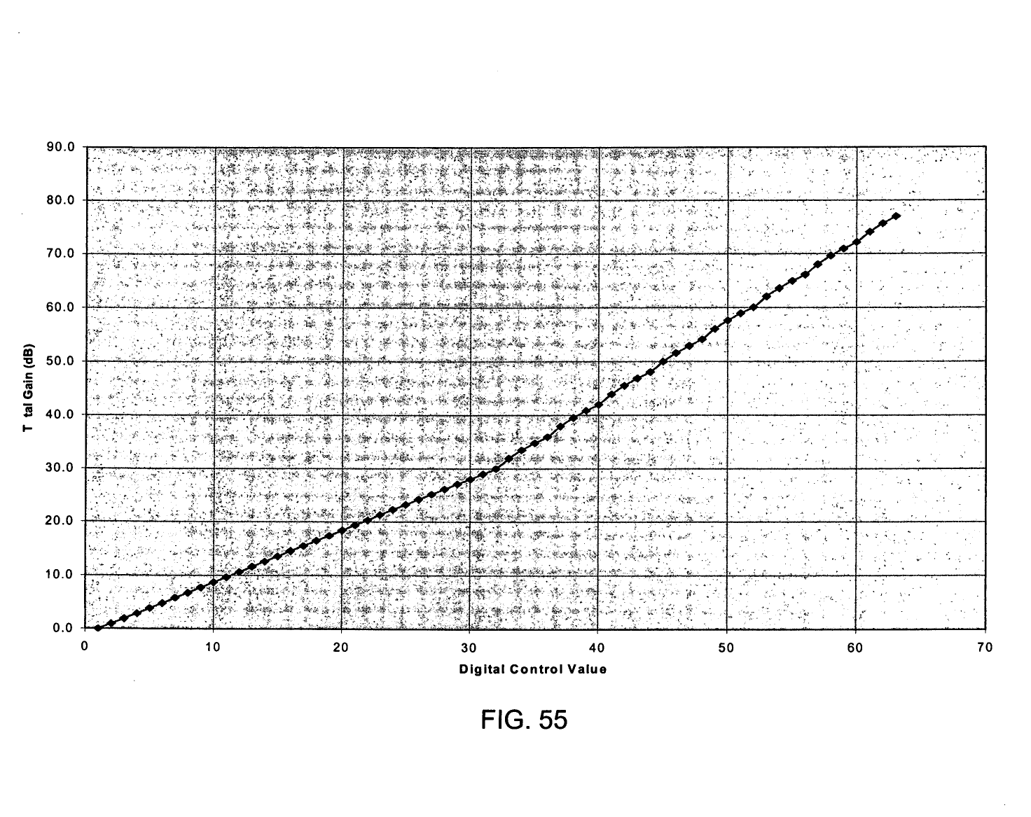

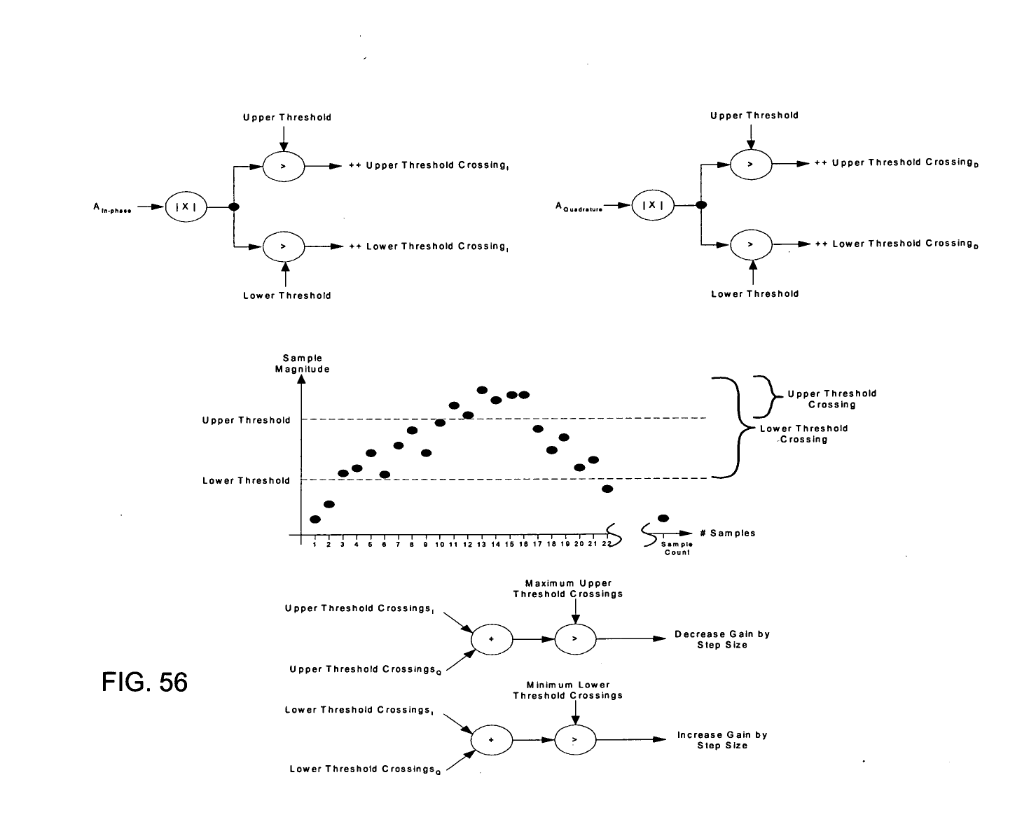

FIG. 55 presents the anticipated performance for total gain correction as a function of the digital control value. Notice the curve inflects at 30 dB, this is the point at which the VGA circuit is maximized and the digital gain adjustment kicks in.

Table 18, below, shows how the gain control is accomplished given the input and specified gain control parameters. The gain control parameters are specified with the Demodulation Registers in Table 18.

TABLE 18
Gain Control Logic Register Parameters

| Gain Control Parameter | Demodulation Register |
|---|---|
| Maximum VGA Gain (A/B and C/D) | MaxVgaGain |
| Initial AB VGA Gain | ABgain |
| Initial AB Digital Gain | ABgain |
| Initial CD VGA Gain | CDgain |
| Initial CD Digital Gain | CDgain |
| Gain added to calculated digital gain | DigitalGainAdjust |
| Step Size | VgaGainStepSize |
| Sample Count | VgaGainStepSize |
| Upper Threshold | UpperThreshold |
| Lower Threshold | LowerThreshold |
| Maximum Upper Threshold Crossings | MaxUpperCrossings |
| Minimum Lower Threshold Crossings | MinLowerCrossings |

FIG. 56 illustrates gain control logic. In FIG. 56 it can be seen that the inputs to the gain control loop are those from the Channel A In-phase/Quadrature correlator pair. The gain control logic collects Sample Count samples while counting the occurrences of the sample absolute value exceeding the Upper and Lower Threshold values. Once Sample Count samples have been gathered, the total number of Upper and Lower Threshold Crossings are compared against the Maximum Upper Threshold Crossing value and the Minimum Lower Threshold Crossing values respectively. If the total number of Upper Threshold Crossings is greater than the Maximum Upper Threshold Crossing value the gain control logic decreases the Gain by the Step Size amount. If the total number of Lower Threshold Crossings is less than the Minimum Lower Threshold Crossing value the gain control logic increases the Gain by the Step Size amount. The A/B & C/D VGA Gain registers are used to initialize the gain values. These registers can also be written at any time to override the current VGA and Digital gain values.

There are also two Master Sequencer outputs used by the gain control logic: (1) DemodGainRun and (2) DemodGainEnable. Both of these signals are active high. The DemodGainRun signal, when asserted, resets the Threshold and Sample Count counters and also loads the VGA and Digital gain values with the contents of the VGA Gain registers. As the name implies, the DemodGainEnable signal enables the gain control logic. If this bit is cleared, the Gain values are manually controlled through the use of the VGA Gain registers.

The gain control operation can be illustrated by walking through an example. Suppose the gain control parameters have been programmed as shown in Table 19.

TABLE 19
Gain Control Parameters for use in example

| Gain Control Parameter | Value |
|---|---|
| Maximum A/B VGA Gain | 25 |
| Maximum C/D VGA Gain | 27 |
| Initial AB VGA Gain | 23 |
| Initial AB Digital Gain | 0 |
| Initial CD VGA Gain | 23 |
| Initial CD Digital Gain | 0 |
| Step Size | 3 |
| Sample Count | 512 |
| Upper Threshold | 200 |
| Lower Threshold | 40 |
| Maximum Upper Threshold Crossings | 51 |
| Minimum Lower Threshold Crossings | 51 |

After collecting 512 samples from the A in-phase/quadrature correlator pair, the total Upper Threshold crossings is 33 while the total Lower Threshold crossings is 47. The Maximum Upper Threshold Crossing value has been programmed to 51, which is greater than 33 (total Upper Threshold crossings during the 512 samples) so there is no gain decrease. The Minimum Lower Threshold Crossing value has also been set to 51, which is greater than 47 (total Lower Threshold crossings during the 512 samples) so the gain control determines that the gain needs to be increased. The Step Size of 3 is added to both the A/B and C/D gain parameters. Adding 3 to the A/B VGA gain results in the A/B VGA gain value being 26, however the Maximum A/B VGA Gain is 25. The gain control logic sets the A/B VGA Gain to the maximum value of 25 and sets the A/B Digital Gain value to 1. Adding 3 to the C/D VGA gain results in the C/D VGA gain value being 26, which is less than the Maximum C/D VGA Gain value of 27 so the C/D Digital Gain value is left zero.

Digital Gain

As discussed above, the gain control logic provides 2 types of gain: (1) VGA gain and (2) digital gain. Just as there are two VGA DAC channels, A/B and C/D, there are also two corresponding digital gain channels. The implementation of the digital gain logic approximates the following equation:

Gained Output=Input×2^{Digital Gain}

As mentioned in the previous section, the gain control logic increases the digital gain only if the VGA gain has reached the Maximum VGA Gain value and the specified threshold targets are still not being achieved. From the above equation, a digital gain value of 0 would result in unity gain.

The 5-bit digital gain value supplied to the digital gain logic by the gain control loop has the format provided in Table 20.

TABLE 20
Digital Gain Value Format

| Digital Gain Bits | Digital Gain Operation |
|---|---|
| [4:2] | Shift Amount |
| [1] | Add ½ of Shifted Input |
| [0] | Add ¼ of Shitted Input |

The digital gain logic takes as inputs 8 ADC samples from the Sampler Logic and 16 specified DC Offset values. The discussion of DC Offset values are described later in the Demodulation Calibration section.

Logic downstream of the digital gain circuitry expects the output of the digital gain logic to be the same bit width as the sample input. Given a large sample, or a sufficiently high digital gain value, it is possible to have the output bit width overflow the input bit width. The digital gain logic, on detecting an overflow condition, actually “pegs” the output at the largest value given the sample input bit width. To demonstrate the digital gain operation, consider the following example. Suppose the ADC input is 25 (00_{—}0001_{—}1001) and the 5-bit digital gain value is 15 (011.11). From a digital gain value of 011.11, the input is shifted 3 places and both ½ and ¼ are added to the shifted input. Taking the input of 25 and shifting by 3 results in 200 (00_{—}1100_{—}1000). Half of the shifted input is 100 (00_{—}0110_{—}0100) and a quarter of the shifted input is 50 (00_{—}0011_{—}0010). Summing these three together results in an output of 350 (01_{—}0101_{—}1110). 350 is represented within 10-bits so an overflow has not occurred.

The demodulation logic contains 4 24-bit General Purpose Counter registers, one per correlator channel pair (A, B, C and D). These counters can be used to count the times a correlator input surpasses a programmable threshold value. To setup the counters to count sample threshold crossings, the Monitor Samples bit in the Demodulation Mode resister is set. The VGA Gain Step Size register contains the Gained Sample Threshold field. Each General Purpose Counter is incremented, if either of the corresponding in-phase or quadrature correlator's input absolute value is greater than the Gained Sample Threshold value. If the demodulation logic is operating the Dynamic Rake logic (discussed in the Dynamic Rake Demodulation section), the General Purpose Counters count rake tooth qualifications and the Monitor Samples bit is ignored.

Building Ramps and Calculating Sample Variances

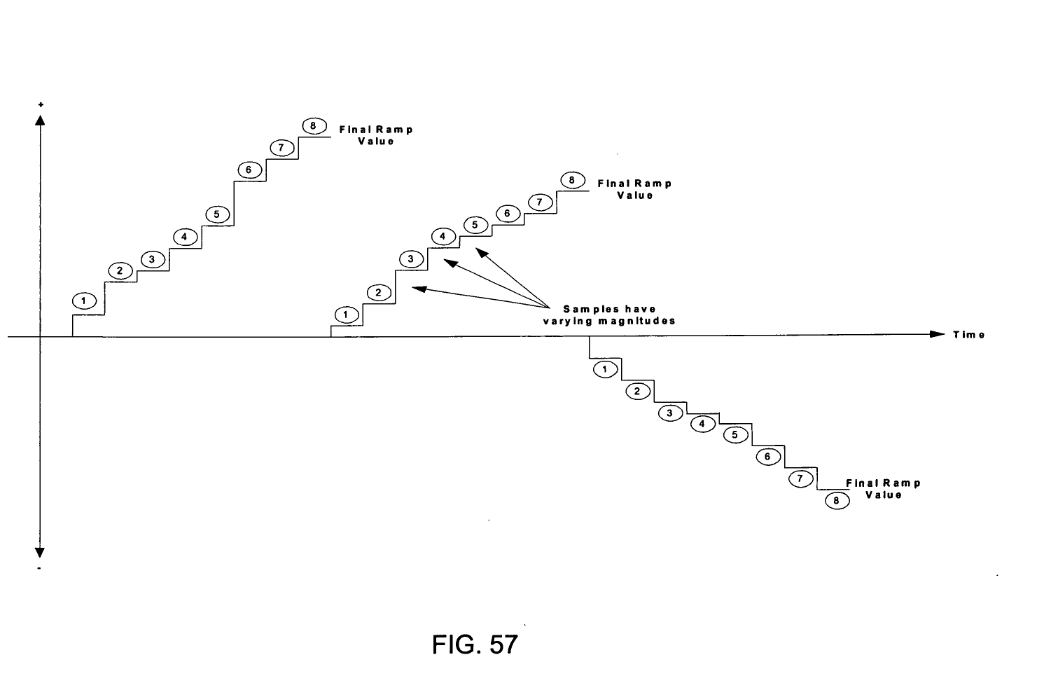

One method used to combat a noisy environment is the use of pulse integration, or put another way, ramp building. Ramp building involves summing (integrating) successive correlator samples and is illustrated in FIG. 57.

FIG. 57 shows three ramps building with a pulse integration of 8. The demodulation logic contains 8 ramp builders, one for each of the correlator inputs. In the demodulation logic there are 2 registers used to specify the pulse integration: (1) Demodulation Header Pulse Integration and (2) Demodulation Data Pulse Integration. These registers are used during the Demodulation Mode. During the Acquisition Mode, the Acquire Logic passes the pulse integration value to the demodulation logic. The demodulation logic supports pulse integration values ranging from 1 to 1024 in power of 2 increments. The final ramp values are used during the demodulation mode to demodulate data. The demodulation logic provides a DemodSymbolDone signal to the Master Sequencer. The DemodSymbolDone signal is asserted for one clock cycle upon the ramps completion.

As can be seen in FIG. 57, the samples that build the ramps have varying amplitudes. In addition to building ramps, the demodulation logic also calculates sample variance for each correlator input as given by the following formulae:

Variance=Σ(sample²)/N−(Σsample/N)² where N=total samples

The sample variance results are used by the Acquire Logic and are also used in several ways depending on the demodulation technique during the demodulation mode.

Data Packing

The demodulation logic's word packer module is used to pack data generated from the demodulation logic before it is stored in the receive FIFOs. The word packer takes in 3 forms of data: (1) ADC samples, (2) ramp/variance values and (3) demodulated bits. Each of these data inputs has differing widths. The word packer takes these inputs and arranges them into 32-bit words. The completed words are then handed to the receive FIFO. The Master Sequencer output, DemodOutputMode, controls what type of data (samples, ramps/variances or bits) the word packer outputs to the receive FIFOs as described in Table 21.

TABLE 21
DemodOutputMode Definition

| DemodOutputMode[1:0] | Word Packer Output |
|---|---|
| 2′b00 | None |
| 2′b01 | Ramps/Variance |
| 2′b10 | Samples |
| 2′b11 | Bits |

Another Master Sequencer output, DemodFifoSelect, is used to specify which receive Fifo the word packer interfaces with as given by Table 22.

TABLE 22
DemodFifoSelect Definition

| DemodFifoSelect | FIFO Selected |
|---|---|
| 1′b0 | Data FIFO |
| 1′b1 | Header FIFO |

When packing ADC samples, the word packer receives 8 10-bit ADC samples (one per correlator) after they have gone through the digital gain logic. The word packer logic assembles these 8 10-bit samples into 3 32-bit words as described in Table 23.

TABLE 23
Word Format When Packing ADC Samples

| Field3 | Field2 | Field1 | Field0 |
|---|---|---|---|
| 2′b10 | Aᵢ sample[9:0] | A_{q} sample[9:0] | Bᵢ sample[9:0] |
| 2′b00 | B_{q} sample[9:0] | Cᵢ sample[9:0] | C_{q} sample[9:0] |
| 2′b00 | 10′b00_0000_0000 | Dᵢ sample[9:0] | D_{q} sample[9:0] |

The order in the above table is also the order that the words are written into the receive FIFO. The 2′b10 in Field 3 of the first 32-bit word serves as a marker when reading sample data from the FIFO. To write 3 32-bit words into the receive FIFO takes 3 clock cycles. This puts a restriction on how fast the samples are coming in and the ability of the word packer/FIFO to be able to store the data. For instance, if the Timer Logic were firing triggers twice per 100 ns frame (double firing) there would on average be 4 clock cycles between successive triggers. This sample rate would push the limits of the word packer/FIFO to collect all of the data.

When packing ramps and variances the word packer receives 8 8-bit variance values along with 8 24-bit ramp values. The word packer assembles these inputs into 8 32-bit words before passing them off to the FIFO as shown in Table 24.

TABLE 24
Word Format When Packing Ramps and Variances Samples

| Field1 | Field0 |
|---|---|
| Aᵢ variance[7:0] | Aᵢ ramp[23:0] |
| A_{q} variance[7:0] | A_{q} ramp[23:0] |
| Bᵢ variance[7:0] | Bᵢ ramp[23:0] |
| B_{q} variance[7:0] | B_{q} ramp[23:0] |
| Cᵢ variance[7:0] | Cᵢ ramp[23:0] |
| C_{q} variance[7:0] | C_{q} ramp[23:0] |
| Dᵢ variance[7:0] | D₁ ramp[23:0] |
| D_{q} variance[7:0] | D_{q} ramp[23:0] |

The 8-bit variance value is a 5.3 floating point representation of the variance value. In the 5.3 floating point representation, the most significant 5 bits represent the exponent while the least significant 3 bits form the mantissa. Variance values are by definition always positive so a sign bit is not needed. With each ramp generated, the word packer/FIFO requires 8 clock cycles to get all of the ramp and variance data into the FIFO.

When packing demodulated bits the number of bits received at once by the word packer is 1, 2 or 4 bits depending on the type of demodulation being employed. The various demodulation techniques are discussed in the Demodulation Techniques section. The word packer collects the demodulated bits and arranges them into one 32-bit word. On completion of the 32-bit word, the word packer writes the word out to the receive FIFO in one clock cycle.

As mentioned above, the Master Sequencer specifies the word packer mode and which FIFO to talk to with the DemodOutputMode and DemodFifoSelect outputs respectively. Being outputs of the Master Sequencer, DemodOutputMode and DemodFifoSelect can be changed from state to state. It should be noted that the word packer does not switch to the new mode or to the new FIFO until it has completed the current operation. For example, suppose the word packer is currently packing bits to the Header FIFO. The Master Sequencer changes states and the new state has the DemodFifoSelect signal selecting the Data FIFO. The word packer completes the current word it is assembling and write that word out to the Header FIFO before it switches to the Data FIFO for the next word.

Demodulation Operation During Acquisition Preamble

The following sections cover those demodulation logic functions that are required to support the Acquire Logic during an acquisition preamble.

ADC Sample Rate Converter

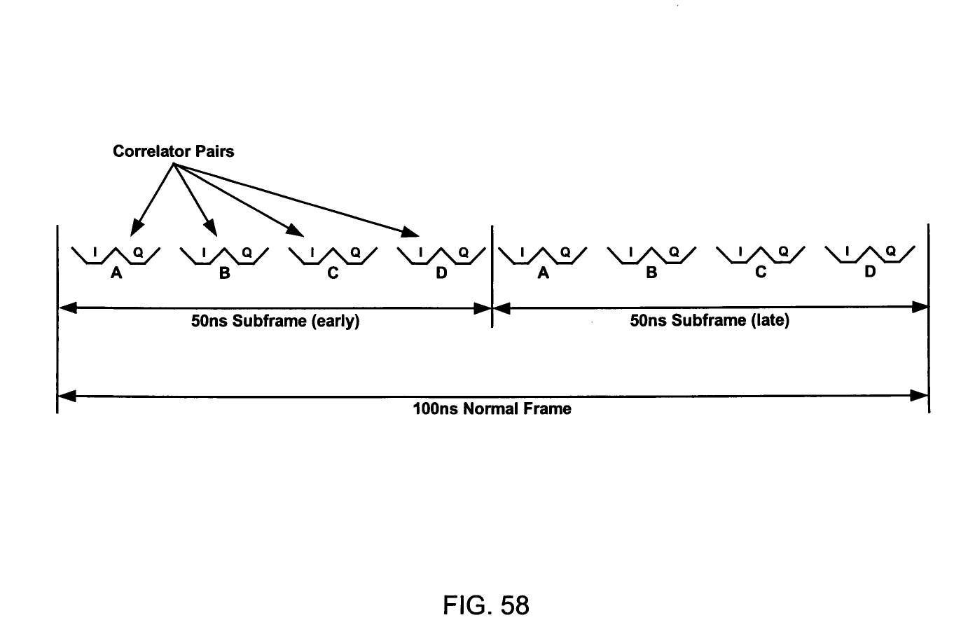

During First and Second Stage Short Code Acquisition, the frame format and correlator positioning is as shown in FIG. 58.

The normal 100 ns frame is split into two 50 ns subframes, an early and a late subframe. The correlator pairs are spread out as shown and fired once in each subframe. This double firing of the correlators results in 16 ADC samples per 100 ns frame. The demodulation logic collects the eight early samples and eight late samples and hands the resulting 16 samples in parallel to the Acquire Logic.

Variance Processing

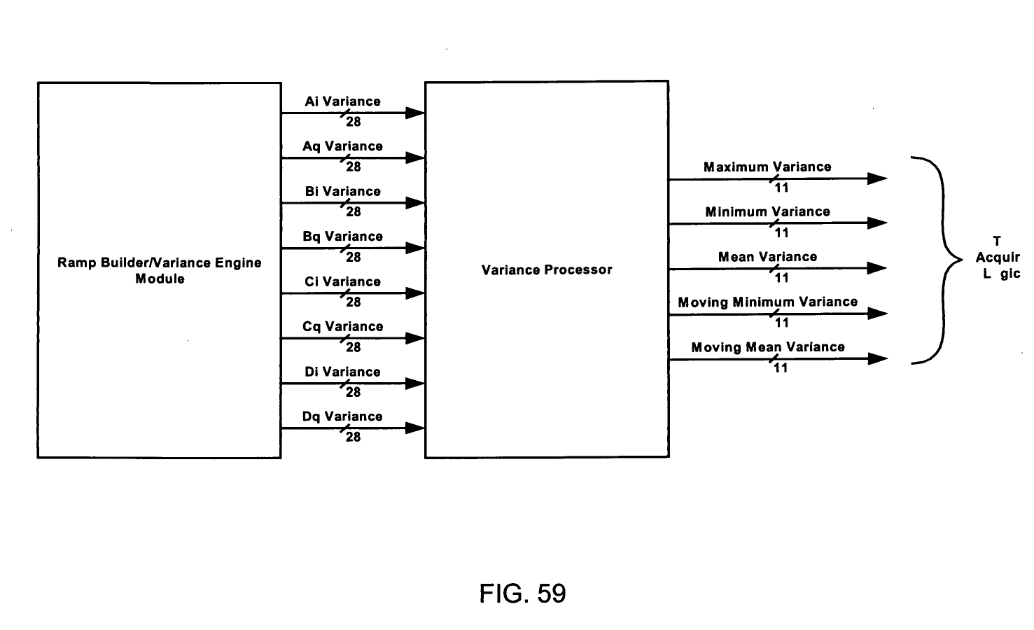

As previously discussed, while building ramps the demodulation logic also calculates a sample variance for each of the eight correlators. The resulting eight variance values are processed by the variance processor logic to generate five variance parameters used by the Acquire Logic: (1) Maximum Variance, (2) Minimum Variance, (3) Mean Variance, (4) Moving Minimum Variance and (5) Moving Mean Variance. FIG. 59 shows the dataflow from the ramp builder/variance engine through the variance processor module.

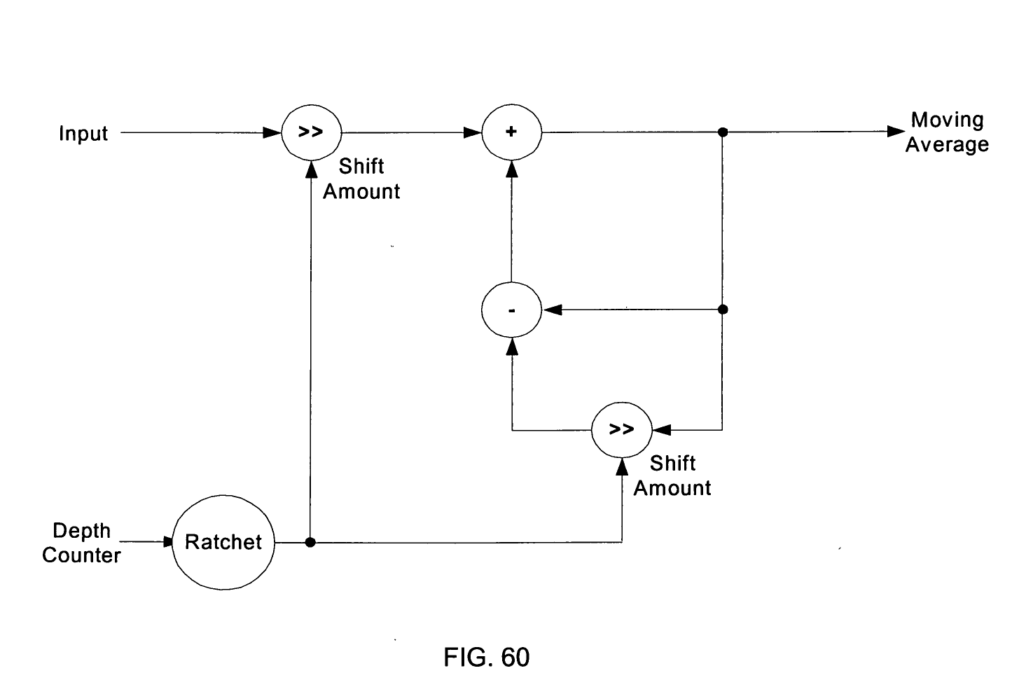

There are three registers used along with the moving mean and moving minimum variance parameters: the Variance Moving Average Control, Variance Moving Minimum and Variance Moving Mean registers. The currently calculated moving minimum and moving mean variance values can be read using the Variance Moving Minimum and Variance Moving Mean registers. These two registers are read only. The Variance Moving Average Control register allows the programming of the moving minimum and moving mean depth. This depth value specifies the window size, in powers of 2, over which the moving average is calculated. For example, if the moving mean depth value were set to 3 the moving mean would be calculated over the previous 8 mean variance inputs. FIG. 60 shows the moving average logic.

The Master Sequencer output DemodTrainMovAvg is used to start “training” the moving average logic. When the train bit is asserted the moving average logic begins incrementing the depth counter. As the depth counter increments, the shift amount value “ratchets” up in power of 2 increments to its final value. For example, lets suppose the depth counter was set to 4 which would result in a moving average window size of 16. On assertion of the DemodTrainMovAvg output the depth counter starts at 0 and the resulting shift amount is 0. As the depth counter continues incrementing, the shift amount increases in corresponding powers of 2. For example, when the depth counter is in the range 4-7 the resulting shift amount is 2. On reaching 8 the shift amount goes to 3 and remains 3 until the depth counter reaches its final value of 16, at which time the shift amount is 4.

The eight correlator variance values are 28-bit unsigned integers. After deriving the 5 variance parameters required by the Acquire Logic the variance processor converts them to 11-bit floating point values. To convert the 28-bit variance parameters to an 11-bit floating point representation required by the Acquire Logic, the following steps are taken. First the variance parameters are converted to a 5.3 floating point value with the most significant 5 bits representing the exponent and the least significant 3 bits representing the mantissa. The final 11-bit representation is an 8.3 floating point value. If the mantissa is non-zero the exponent is incremented by 128. If the mantissa is zero, both the 8-bit exponent and the 3-bit mantissa are set to zero.

Demodulation Operation During Payload

The following sections cover those functions that are necessary during the Payload portion of the packet.

Data De-Whitening

The demodulation logic contains logic to de-whiten the data. There are two demodulation registers involved in data de-whitening: (1) Demodulation Position Select 0 De-Whitener and (2) Demodulation Position Select 1 De-Whitener.

Data Combiners

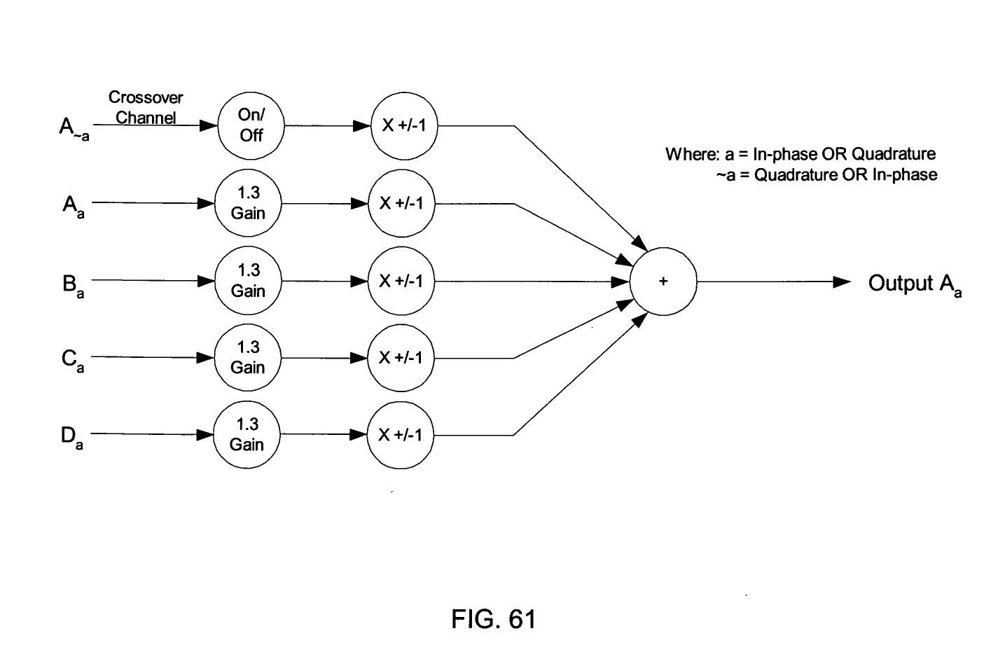

The data combiner module allows data from each of the eight correlators to be amplified and combined prior to going to the Ramp Builder/Variance Engine module. FIG. 61 shows the Aₐ data combiner channel.

There are eight combiner channels, one for each of the eight combiner inputs. Each combiner allows all of the in-phase or quadrature samples to be combined along with a crossover channel. So for instance, the B_{q} combiner channel takes as inputs all the other quadrature channels, A_{q}, C_{q} and D_{q} along with the crossover channel Bᵢ. Eight registers control the eight combiner channels: Ramp0 Combiner (Aᵢ), Ramp1 Combiner (A_{q}), . . . , Ramp7 Combiner (D_{q}). These registers specify the gains, positive or negative, and the crossover controls for on or off and positive or negative.

The gain of the 1.3 gain stage is specified with 4 bits in the combiner control registers. The 4-bit field definition is given in Table 25.

TABLE 25
Correlator 1.3 Gain Field Definition

| 1.3 Gain Field Bits | Combiner Gain Stage Operation |
|---|---|
| [3]] | Add Whole Input |
| [2] | Add ½ Input |
| [1] | Add ¼ Input |
| [0] | Add ⅛ Input |

As an example, the input to the 1.3 gain stage is 25 (00_{—}0001_{—}1001.000) and the 4-bit gain value is 1011. From the gain value, the whole input plus one quarter the input plus one eighth the input is added. So that is 25 (00_{—}0001_{—}1001.000) plus 6.25 (00_{—}0000_{—}0110.010) plus 3.125 (00_{—}0000_{—}0011.001), which equals 34.375 (00_{—}0010_{—}0010.011). The inputs to the combiner, which have gone through the digital gain module and the de_whitener module, are 10-bit values. To represent the maximum inputs with maximum gain values and carrying the fraction bits forward to the ramp builders, the output of the combiners are 14.3 bit values.

Figure of Merit

Along with each ramp that is built is a corresponding figure of merit (FOM). This value takes into account the final ramp magnitude and the sample variance calculated during the building of the ramp. In this way, the figure of merit is very similar to a signal to noise ratio where the ramp magnitude represents the signal and the variance the noise. To calculate the figure of merit, the ramp magnitude is squared. Then, the squared ramp and sample variance are both converted to 5.3 floating point values. The exponent of both the ramp squared and sample variance are used in the following equation to get the figure of merit:

Figure of Merit=32+Exp(ramp_squared)−Exp(variance)

The 32 is added just to keep the figure of merit values positive. A couple of special cases need to be covered: (1) signal is zero and (2) noise is zero. If the exponent of the ramp squared is zero (signal is zero) the figure of merit is also made zero. If the exponent of the variance is zero (noise is zero) then the figure of merit is set to the maximum value of 63 decimal (11_{—}1111).

Demodulation Techniques

The following sections discuss the various demodulation techniques used in the demodulation logic. These include: (1) Flip, (2) Shift, (3) QFTM, (4) 4-position MPM with QFTM, (5) Dynamic Rake and (6) Nulling Demodulation.

Flip, Shift and QFTM Demodulation

The Demodulation Mode register contains a Flip bit and a Shift bit. To enable QFTM demodulation, both the Flip and Shift bits are set. The other demodulation techniques discussed below, 4-position MPM with QFTM, Dynamic Rake and Nulling, generate a final ramp pair. This final ramp pair is demodulated using Flip, Shift or QFTM as determined by the Flip and Shift bits in the Demodulation Mode register.

4-Position MPM with QFTM

Setting the 4-position MPM bit in the Demodulation Mode register enables 4-position MPM with QFTM demodulation. Setting the 4-position MPM bit in the Demodulation Mode register also sets both the Flip and Shift bits. As the name suggests, when performing 4-position MPM, QFTM is used to demodulate the two least significant bits. The demodulation logic determines which correlator pair contains the largest ramp. The two most significant bits of demodulated data correspond to the winning correlator pair as shown in Table 26.

TABLE 26
Two Most Significant Demodulated Bits in 4-Position MPM

| Winning | 2 Most |
|---|---|
| Correlator | Significant |
| Pair | Bits |
| A | 00 |
| B | 01 |
| C | 10 |
| D | 11 |

This winning correlator pair of ramps is demodulated using QFTM to determine the two least significant bits.

Dynamic Rake Demodulation

As stated before, transmitted pulses arrive at the receiver over multiple paths. As such, the multiple arriving reflections of the transmitted pulses arrive at the receiver. A higher receiver performance can be achieved by capturing energy arriving from the multiple paths using a rake receiver. However, multi-path capturing of pulse energy at the receiver also results in capturing multiple copies of the environmental noise. In some instances, the rake receiver can actually perform worse than a non-rake (single path) receiver unless the received signals are appropriately processed.

Conventional approaches integrate or otherwise accumulate successive time samples of the captured pulse energy at each tooth to get a sum for each tooth. Each sum for a corresponding tooth is weighted by a weighing factor and the weighted sum of each tooth is added. The weighing factor for each rake tooth corresponds to an expected amplitude of reflection received by a particular tooth, as determined during a time consuming rake training period.

According to one aspect of the present invention, a highly responsive dynamic rake process is implemented that lessens the need for rake training. The dynamic rake process requires computing two values per tooth: 1) a correlator sum value derived from integrating or otherwise accumulating successive samples of the captured pulse energy at each tooth and 2) a sample variance value of the samples making up the sum. The sample variance is computed by the demodulation logic for each correlator input as given by the following formula, as described above:

Variance=Σ(sample²)/N−(Σsample/N)² where N=total samples.

The correlator sum and sample variance values are used to determine an FOM value for each tooth, as described above. The FOM is the ratio of the correlator sum divided by the sample variance, as described later in detail. The FOM value is essentially the signal to noise ratio of each tooth. The teeth determined to have little merit are excluded or otherwise disqualified from the final sum used for demodulation. Preferably, a minimum threshold associated with the correlator sum is used to disqualify taking into account a good FOM when the correlator sum and sample variance are both very low. The dynamic qualification (and disqualification) of individual rake teeth based on instantaneous sample variances results in a highly responsive rake receiver having a significantly reduced requirement for rake training after signal acquisition.

The determination of which teeth are to be included in the final sum for demodulation is determined based on a factor that is relative to a determined best tooth having the best FOM. Such factor in this specification is called the “Fussiness Factor,” which corresponds to a relative acceptance threshold. For example, all teeth within 75% of the merits of the best tooth can are included in the final sum for demodulation. Thus, the “Fussiness Factor” and FOM values are used to determine the qualification or disqualification of rake teeth. As such, this aspect of the invention relates to an apparatus or method that uses a merit value that is preferably computed at the same time as the tooth samples to qualify (or disqualify) each tooth one at a time in real time.

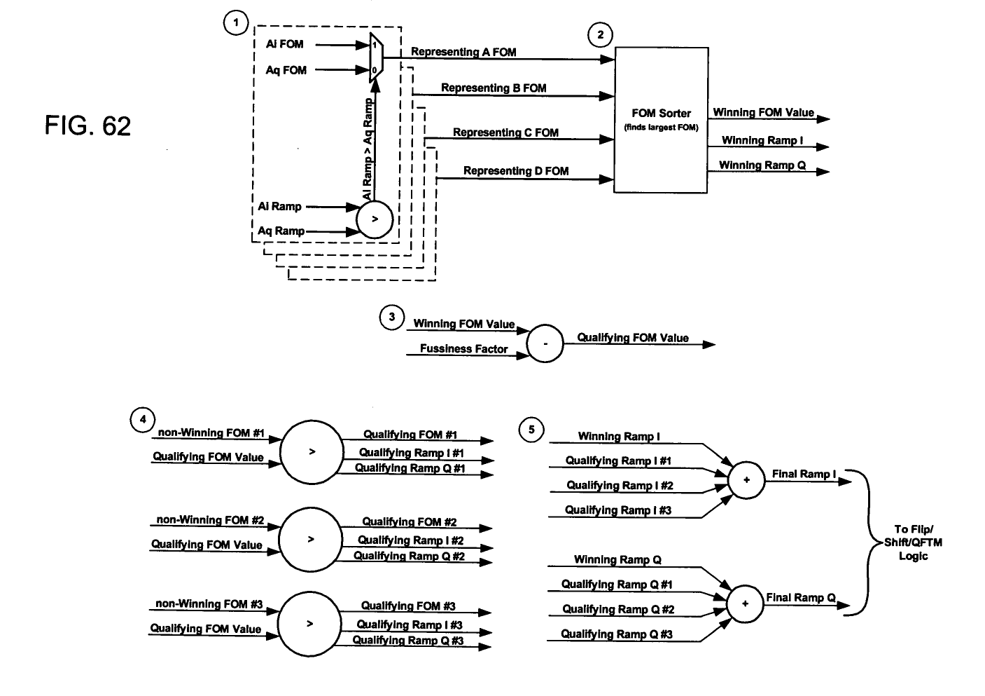

The Dynamic Rake operation is illustrated in FIG. 62. Setting the Dynamic Rake enable bit in the Demodulation Mode register enables dynamic rake operation. The Flip, Shift or both (QFTM mode) bits should also be configured to select the used demodulation mode once the dynamic rake logic has calculated the final ramps. It is important that during the Signal Optimization state the correlators are moved into their rake tooth positions. This allows the Signal Optimization logic to find the optimal energy in each tooth zone. On going into the payload portion of the packet, the correlators are moved back to their tooth positions and snapped to the exact location that was found during signal optimization.

All eight ramps and FOM values enter the dynamic rake module. The first thing that is done is to find the largest ramp from each in-phase/quadrature pair. Based on the largest ramp, the corresponding FOM is selected to represent the pair in the FOM sorter. The FOM sorter simply finds the largest FOM value given the 4 representing FOMs. The winning ramp pair is the ramp pair corresponding to this winning FOM value. Next the Qualifying FOM is calculated using the Winning FOM value and a Fussiness Factor. The Fussiness Factor is programmed in the Demodulation Mode register. Each of the non-winning FOM values is then compared against the Qualifying FOM value to find the qualifying ramp pairs. In order for a ramp pair to qualify, its representing FOM value should be greater than the Qualifying FOM. The last step is to generate the final ramp pair. This is accomplished by adding the winning and all qualifying ramp pairs together.

To illustrate this entire process with an example, suppose that the FOM sorter found the representing B FOM, with a value of 26, to be the largest of the 4 representing FOM values. The B in-phase/quadrature pair would then be the winning ramp pair. Suppose the Fussiness Factor was programmed to 2. This would result in a Qualifying FOM value of 24 (26-2). The non-winning representing FOM values (A, C and D) are then compared against the Qualifying FOM value of 24. The representing A FOM was 25, the representing C FOM was 24 and the representing D FOM was 20. Only the A ramp pair would be qualified since its representing FOM is 25. Neither of the other representing FOM values is greater than the Qualifying value of 24. So the final in-phase ramp would be the B in-phase ramp plus the A in-phase ramp. Likewise the final quadrature ramp value would be the B quadrature ramp plus the A quadrature ramp. This final ramp pair is demodulated given the demodulation technique being employed (Flip, Shift or QFTM).

The four General Purpose Counters (previously mentioned in the Digital Gain section) are used to count the number of times a correlator pair qualifies in the dynamic rake decision. When Dynamic Rake is enabled the General Purpose Counters always count rake tooth qualifications regardless of the Monitor Samples bit in the Demodulation Mode register.

Nulling Demodulation

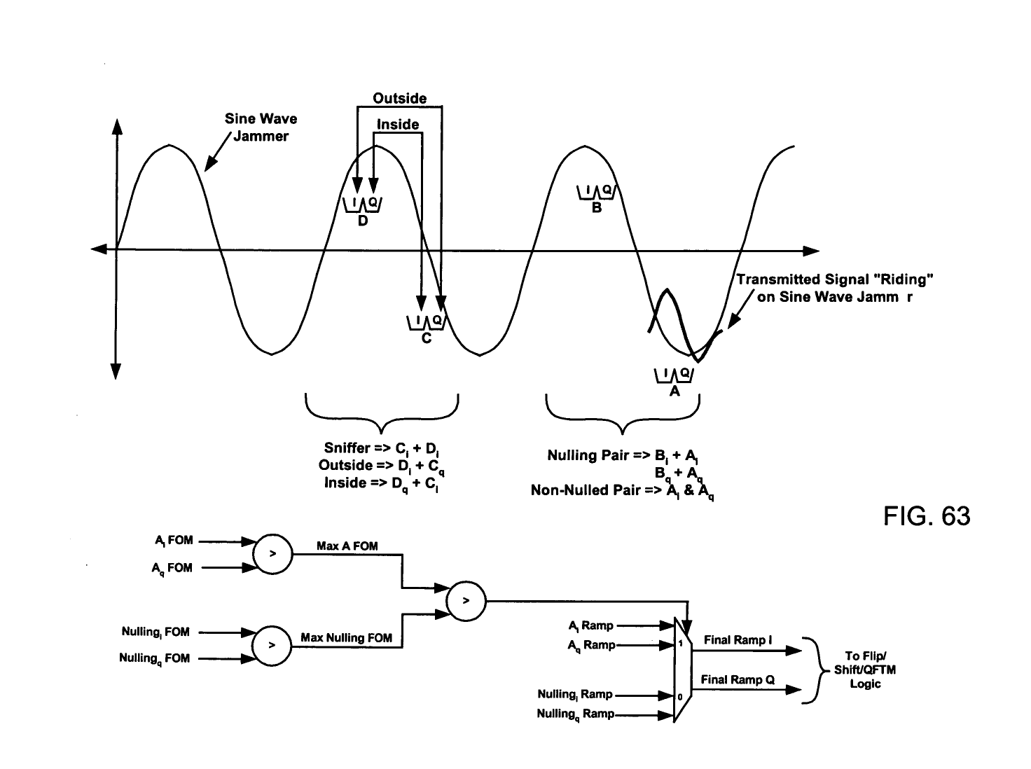

The purpose of nulling is to cancel out the detrimental effects of a Sine Wave Jammer. FIG. 63 illustrates the Nulling Logic operation.

As can be seen in the figure, nulling operation depends on many different combinations of correlator inputs. The combiners are used to achieve these correlator combinations. Table 27 shows how the combiner channels are setup for proper operation of nulling.

TABLE 27
Combiner Channels Setup for Nulling Operation

| | Correlator | Combiner Channel | Register |
|---|---|---|---|
| Nulling Input | Combination | (register) Used | Value |
| Ai (non-nulled) | Ai | Combiner Ch. 0 (Ai) | 0c0100_0000 |
| Aq (non-nulled) | Ad | Combiner Ch. 1 (Aq) | 0x0100_0000 |
| Nulling I | Ai + Bi | Combiner Ch. 2 (Bi) | 0x0102_0000 |
| Nulling Q | Aq + Bq | Combiner Ch. 3 (Bq) | 0x0102_0000 |
| Sniffer | Ci + Di | Combiner Ch. 4 (Ci) | 0x408 |
| Inside | Ci + Dq | Combiner Ch. 6 (Di) | 0x8000_0400 |
| Outside | Cq + Di | Combiner Ch. 7 (Dq) | 0x8000_0400 |

The nulling logic performs three separate functions: (1) determination of the final ramp pair, (2) controlling the A correlator to B correlator separation (the nulling pair) and (3) controlling the C correlator to D correlator separation (the sniffing pair). The separation control is accomplished by moving the B and D correlators while both the A and C correlators remain stationary. The demodulation logic interfaces to the Timer Control logic to move the B and D correlators.

The above figure shows the way the nulling logic determines the final ramp pair. The maximum FOM from the A pair (non-nulled) and the nulled pair is found. These two representing FOMs are then compared. The final ramp pair is then the pair, either the A (non-nulled) ramp pair or the nulled ramp pair, corresponding to the largest representing FOM value. This final ramp pair is then demodulated given the programmed technique, Flip, Shift or QFTM.

The main idea behind nulling is that through correlator separation and input combining, the effects of a sine wave jammer can be cancelled. The nulling logic is constantly attempting to find the optimal correlator separation that provides maximum sine wave jammer canceling. The “sniffing” correlator pair is constantly searching for this correlator separation “sweet spot”. Two input combinations are used to control the sniffer pair's separation: (1) the Inside input and (2) the Outside input. The Inside input is formed by adding the (inside) Dq and Ci correlator inputs. Likewise, by adding the outside correlator inputs, Dq and Ci, the Outside input is formed. The outside variance is compared against the inside variance. If the outside variance is less than the inside variance, the correlators are moved apart. On the other hand, if the outside variance is greater than or equal to the inside variance, the correlators are moved closer together. Again, moving the D correlator while the C correlator is left stationary controls the sniffer separation.

Combining the Ci and Di correlator samples generates the sniffer variance. Likewise, combining the Ai and Bi correlator inputs creates the nulling variance. To find the optimal nulling separation these two variance inputs are compared. If the sniffer variance is found to be less than or equal to the nulling variance, the A to B correlator spacing is made equal to the C to D correlator spacing. The fact that the sniffer variance is less than the nuller variance indicates that the sniffer correlator spacing is “better” than the nuller spacing.

The nulling range and nulling step size parameters are programmed using the Nulling Control register. The nulling range specifies how far, in either direction, the nulling logic can move the B and D correlators. The nulling step size specifies the amount the D correlator is moved at one time. The demodulation logic to Timer Control logic interface is very straightforward. The demodulation logic tells the Timer Control logic how much to move the B and D correlators. The Timer Control logic sends the demodulation logic a signal indicating that the correlator movements have taken place. The 4 24-bit General Purpose counters can be used to count Timer overflows. A timer overflow occurs anytime the sum of channel roll, tracking roll and scan roll exceed 0×1000. The demodulation logic is actually using the scan roll (as opposed to the scan engine) to tell the Timer Logic how much to move the B and D correlators. To use the counters in this way the Monitor Samples bit in the Demodulation Mode register is cleared.

NRZ

Setting the NRZ bit in the Demodulation Mode register enables the demodulation NRZ logic. The NRZ logic is initialized using the NRZ_Init bit in the Demodulation Mode register. For a complete discussion of NRZ see the Modulation NRZ section.

Forward Error Correction Support

The demodulation logic supports the Forward Error Correction (FEC) logic by generating two confidence bits along with each bit demodulated. Table 28 shows one demodulated bit along with its two confidence bits and how the three are interpreted by the FEC logic.

TABLE 28
Demodulated Bit & FEC Bits

| Demodulated | Confidence | |
|---|---|---|
| Bit | Bits | FEC Meaning |
| 1 | 11 | Strongest 1 |
| 1 | 10 | |
| 1 | 01 | |
| 1 | 00 | Weakest 1 |
| 0 | 11 | Weakest 0 |
| 0 | 10 | |
| 0 | 01 | |
| 0 | 00 | Strongest 0 |

Depending on the demodulation mode being employed, the demodulation logic can generate up to 4 bits of data per ramp. To generate the confidence bits for the two least significant bits of demodulated data the following equations are used:

Demod Bit#0 Confidence Bit#0=[.OR.(FOM.AND.FOM Bit#0 Mask)].XOR.(.INV. Demod Bit#0)

Demod Bit #0 Confidence Bit#1=[.OR.(FOM.AND.FOM Bit#1 Mask)].XOR.(.INV. Demod Bit#0)

Demod Bit #1 Confidence Bit#0=[.OR.(FOM.AND.FOM Bit#0 Mask)].XOR.(.INV. Demod Bit#1)

Demod Bit #1 Confidence Bit#1=[.OR.(FOM.AND.FOM Bit#1 Mask)].XOR.(.INV Demod Bit #1)

The FOM Bit Mask values are contained in the Demodulation Mode register. The OR operation results in a 1 if any of the bits in the product of the AND are a 1. Then the output of the OR operation is XOR'ed (exclusive OR'ed) with the INV (inverse) of the demodulated bit. This rather complicated procedure results in the demodulated bits and the confidence bits following the pattern shown in Table 28. To illustrate this with an example consider the following: FOM value is 35 (10_{—}0011 binary), the FOM Bit #1 Mask is 32 (10_{—}0000 binary) and the demodulated bit #1 is 0. The derivation of the confidence bit #1 is given below:

$$\begin{matrix}Confidence Bit \#1 = [ . OR . ( FOM . AND . FOM Bit Mask \#1 ) ] \\ . XOR . ( . INV . Bit \#1 ) \\ = [ . OR . ( 100011. AND .100000 ) ] . XOR . ( . INV . 0 ) \\ = [ . OR . ( 100000 ) ] . XOR . 1 \\ = 1 . XOR . 1 \\ = 0\end{matrix}$$

In MPM, there is no FOM value associated with the most significant two bits. So the confidence bits for the two most significant bits are simply copies of the demodulated bits. By duplicating the demodulated bits for these most significant two bits, the strongest can be represented by either 1 or 0. For the two least significant bits, there is always a representing FOM value to calculate the confidence bits.

Tracking Logic Interface

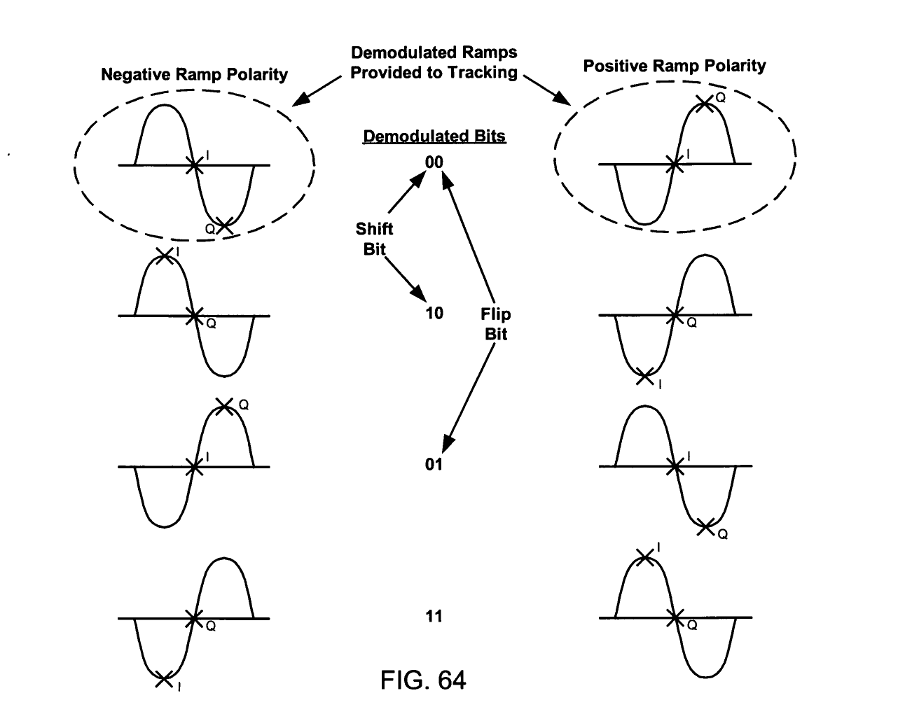

During the payload portion of the packet the demodulation, logic hands demodulated ramps, the integration value used in generating the ramps and a ramp valid signal to the Tracking Logic. The demodulation logic receives one ramp polarity signal per correlator pair from the Tracking Logic. During the signal optimization process, the Tracking Logic determines the ramp polarity as either positive or negative. FIG. 64 illustrates all the ramp combinations that the demodulation logic might receive given the Tracking Logic's ramp polarity signal and the resulting demodulated ramp that is handed to Tracking.

Demodulation Logic Calibration

The demodulation logic has resources that can be used to calculate DC Offset for each correlator channel, correlator channel-to-channel gain differences and any timer channel misalignment.

DC Offset Calibration

The demodulation logic contains 8 DC Level Shift registers and 8 Weighted DC Level Shift registers. One method used to calculate DC Offsets is to set all the gain values to zero and build one 1024 length ramp. The DC Offset is then the final ramp value times minus one. The DC Offset values are written into the corresponding DC Level Shift registers. The Weighted DC Level Shift registers are used during the payload portion of the packet. They take into account the DC Offset value and the combiner combinations. To illustrate the Weighted DC Offset value calculation, suppose that the Ai DC Offset was 20 and the Bi DC Offset was 30 and the Ai Combiner Control Channel was setup to add the Ai and Bi correlator inputs. The Ai Weighted DC Level Shift register would then be set to 50 (20+30). All of the DC Offset values pass through the digital gain module. From there they are used in the demodulation logic's ramp builders and are also passed to the Acquire and Tracking logic. All of the logic that receives DC Offset values operates under the assumption that the DC Offsets were calculated using a ramp of integration length 1024. As such, the logic normalizes the DC Offset value to whatever integration length is currently being used. For example, if the header integration has been set to 256, the DC Offset value is divided by 4 (1024/256) prior to being applied to the ramp.

Correlator Channel-to-Channel Gain Calibration

Gain subtleties in each of the 8 correlator channels exist. The Digital Gain Adjust register is used to make the effective gain of each correlator channel approximately equal. This register contains 8 4-bit fields, one for each correlator channel. The Gain Control logic calculates an A/B Digital Gain and a C/D Digital Gain value, corresponding to the 2 VGA Gain channels. The digital gain adjustment value is added to the appropriate Digital Gain value to form the total individual correlator channel digital gain value. For example, suppose the Gain Control logic has calculated an A/B Digital Gain of 3 and a C/D Digital Gain of 0 (all of C/D gain is established with the C/D VGA Gain). Suppose the Ai digital gain adjustment value is 2, while the Ci digital gain adjustment value is 5. The total Ai digital gain value is the sum of the A/B Digital Gain plus the Ai digital gain adjustment value: 3+2=5. Likewise, the total Ci digital gain value is the sum of the C/D Digital Gain plus the Ci digital gain adjustment value: 0+5=5.

Timer Bias Adjustment

Greenwich interfaces to 4 Timer2 channels. Many Greenwich operations depend on these 4 Timer channels to be precisely aligned. One method used to determine any Timer channel-to-channel offsets is to transmit using one of the four channels while receiving with the other three channels. The resulting waveforms can be analyzed to determine any timer channel misalignment. To facilitate this operation the Demodulation Mode register contains 4 Manual Sample Valid bits, one per Timer channel A, B, C and D. The channel used to transmit does not provide correlator inputs. In order for the demodulation logic to process the inputs from the three receiving channels, the transmitting channel's Manual Sample Valid bit is set.

Rx (FEC)

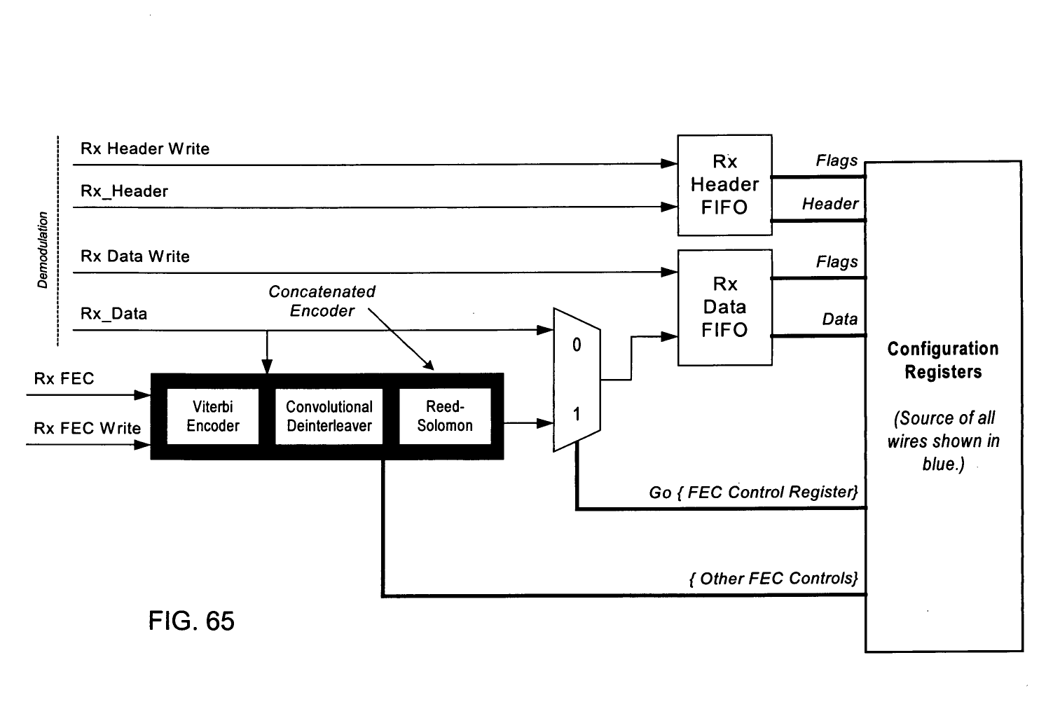

The Rx (FEC) logic module stores data that has been received as UWB pulses. There are two FIFOs in this design, one for the payload header (the Rx Header FIFO) and one for the payload data (the Rx Data FIFO). The Rx Header FIFO and Rx Data FIFO are 32 byte wide by 64 byte deep (2K total) and 32 byte wide by 1K byte deep (32K total), respectively. The external processor keeps the corresponding FIFOs sufficiently drained during the reception of a packet such that neither FIFO overflows (resulting in the loss of data). Data from the Rx Data FIFO can be configured to flow through zero or more FEC engines including Reed-Solomon, Convolutional Deinterleaving plus Viterbi, and a concatenated decoder as shown in FIG. 65. The data stored in the Rx Header FIFO and the Rx Data FIFO (potentially post-FEC) is received from the Demodulation logic module.

Assuming the transmitter sent an exact multiple of ‘K’ 32-bit words (see section on Tx FEC), then the receiver attempts to demod K+1 words. The last word is thrown away. Receiving an extra word (even if an extra word is not transmitted) causes the FEC logic to generate error statistics on the last Reed-Solomon block. The ‘tact’ parameter matches the corresponding value of the transmitter. The ‘blksel’ parameter corresponds to the ‘N’ value of the transmitter. The interleaver bypass parameter corresponds to that of the transmitter.

Rx Symbol Counts

A simple practice on the receive side is to use the DemodSymbolDone signal to cause the Master Sequencer to decrement a counter. When the counter reaches zero, then the packet is received. Without the FEC enabled, the following equation can be used:

numberOfBitsToDemod=numWordsSent*32

With the FEC enabled, the following equation can be used:

numberOfBitsToDemod=numWordsSent*32+Latency

Where Latency is determined according to the following Table 29.

TABLE 39
Rx (FEC) Latency Table

| | Latency | Latency |
|---|---|---|
| N | (Interleaver Off) | (Interleaver On) |
| 63 | 5284 | 37,012 |
| 127 | 3236 | 34,964 |
| 255 | 2212 | 33,940 |

The latency value accounts for the number of symbols that are output by the demodulation unit for the correct number of words to be appended to the Rx Data FIFO.

Rx Error Counts

In addition to the symbol counts above, various error counters are available to the receiver. All of the error counters give the number of errors encountered since the last clear signal was written. When it is desirable to clear the error counters, the Rx FecMode register is written with the appropriate clear bits asserted. The changes are applied to the counters when the register is written. The register does not have to be written again with these bits deasserted.

Sampler

Overview

The Sampler logic module contains all of the analog cores. These cores include eight ADCs and two DACs. The ADCs and DACs constitute the entirety of the Greenwich to Correlator interface. The Sampler logic can be divided into two sections; (1) data sampling and (2) VGA gain control. The Greenwich device uses the 10-bit A/D Converter and the 10-bit D/A Converter.

Data Sampling

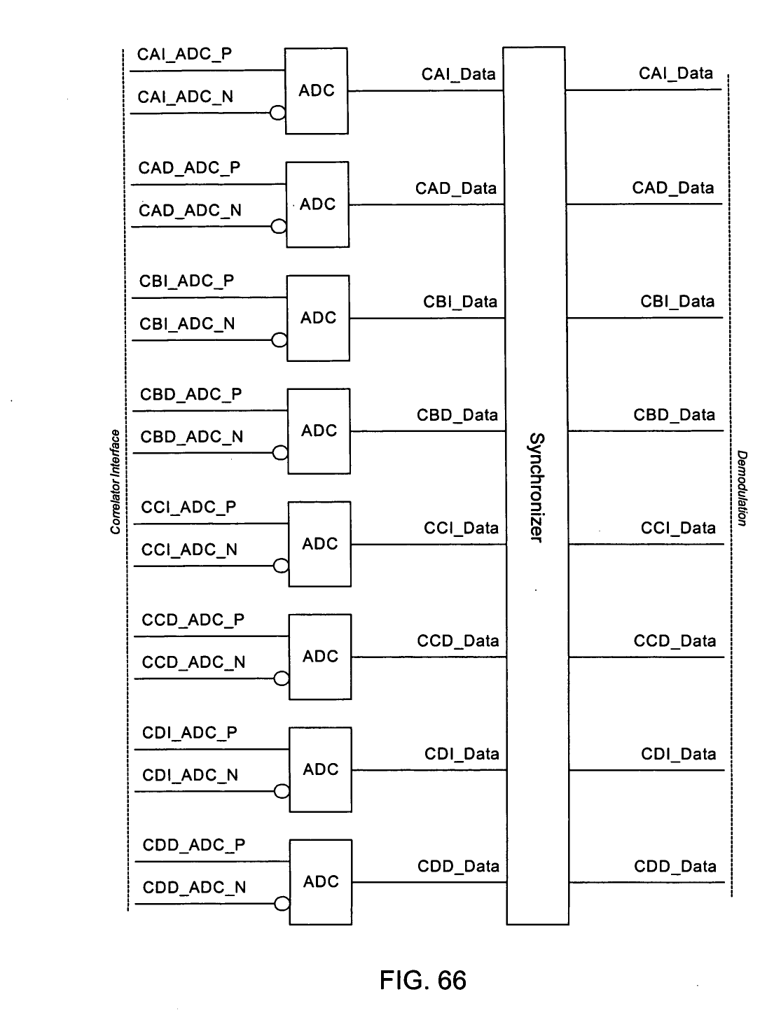

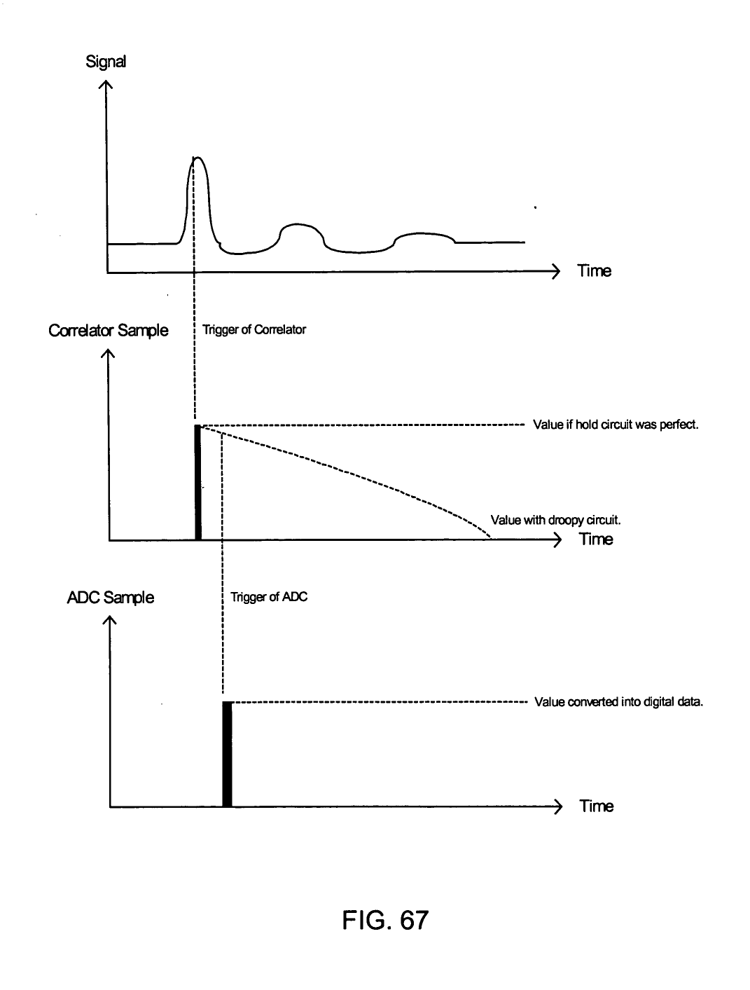

FIG. 66 shows the portion of the Sampler logic associated with data sampling. This is also the portion of the Sampler logic associated with the eight ADCs. Each ADC is capable of sampling at 80 MHz even though one sample is required in every 50 ns (period of 20 MHz). As shown in FIG. 67, pulses can be placed at various offsets within the frame. Under this arrangement, the ADC sampling is triggered right after the correlator sampling. Consequently, the correlator circuit has a low rate of change part of the droop curve. In addition, the droop is consistent, since the time between correlator and ADC sampling is constant, as shown in FIG. 67.

In order to get the data out as soon as possible and make it synchronous to an internal 80 MHz clock, the 80 MHz clock is injected into the ADC in addition to the trigger that fires right after the correlator. These extra 80 MHz clocks push the data out sooner and insure that the useful data comes out aligned with the internal 80 MHz clock domain. Since the ADC is rated for 80 MHz operation, it can be refired 13 ns after the previous firing. For a 50 ns frame this would correspond to a 75% code span. For a 100 ns frame this would be 87.5% code span.

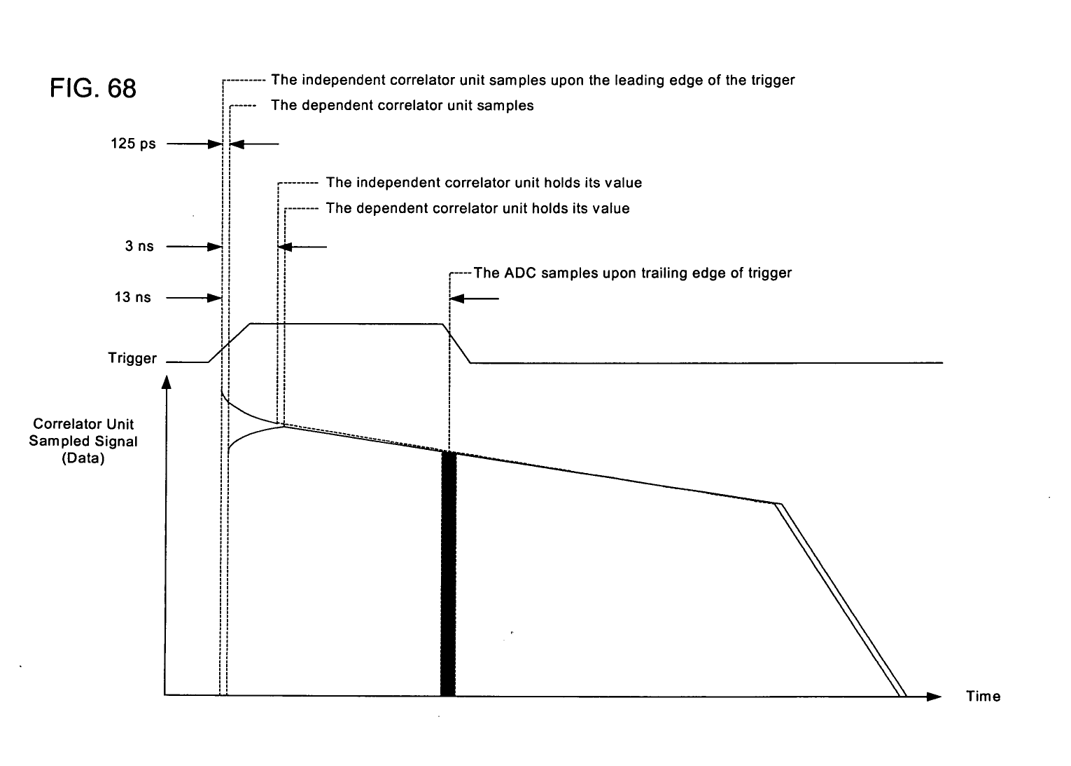

The following explains how the ADCs are driven. Each timer unit generates a differential trigger signal for the correlators as well as a single ended trigger signal for the Greenwich. This differential trigger's leading edge initiates the sampling phase of the corresponding independent correlator unit. The dependent correlator unit goes through the same process, but lags in time by roughly 125 ps. Each correlator unit goes into the hold phase roughly 3 ns after the sampling phase. The single ended trigger that drives the Greenwich ADCs is launched at the same time as the differential trigger signal, however the sense of the signal is reversed; i.e. the Greenwich ADCs trigger on the trailing edge of the signal. FIG. 68 reflects these timing relationships.

In summary, the ADC corresponding to the independent correlator unit samples roughly 9.5 ns later than optimal (13 ns-3 ns). The ADC corresponding to the dependent correlator unit samples roughly 9.375 ns later than optimal (13 ns-3 ns-125 ps). It should be noted that the 125 ps shift results in a slight difference in energy sampled between a demodulation signal with and without shift.

VGA Gain Control

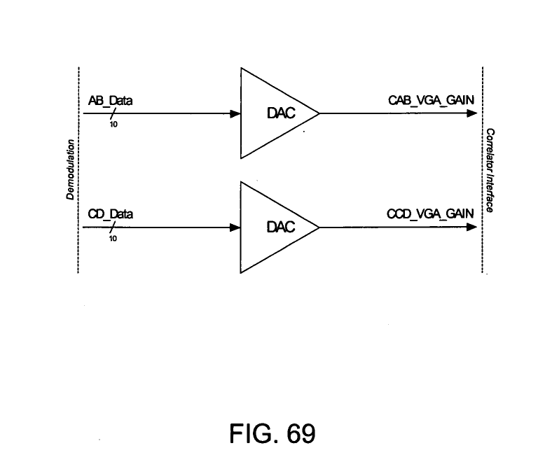

The VGA Gain Control is actually handled in the Demodulation logic. The Sampler logic simply conveys the digital data values from the Demodulation logic to the actual DAC devices, as illustrated in FIG. 69.

1. An integrated circuit, comprising at least one of:
circuitry that performs dynamic rake reception based on a figure of merit;
circuitry that provides rake reception within zones;
circuitry that uses table entries for setting tracking parameters;
circuitry that maintains digital control of gain based on dual thresholds; and
circuitry that controls a state machine by data addressing.

2. A method for demodulating data using a rake receiver having a plurality of rake teeth, comprising:
computing a correlator sum value derived from samples received by at least one rake tooth;
computing sample variance for the samples received by the at least one rake tooth;
determining a figure of merit (FOM) for each tooth based on the sample variance value; and
excluding a correlator sum associated with a rake tooth bases on the FOM value, when demodulating data.

3. A method for receiving signals using a rake receiver, comprising:
defining zone associated with the teeth of a rake receiver;
correlating the received signals at the zones concurrently to find the best rake teeth placement in each zone; and
keeping track of how often a tooth representing a zone qualifies a criteria.

4. A method for tracking received signals, comprising:
successively retrieving tracking parameters relating to at least one of a tracking gain and tracking bandwidth setting from a table; and
applying the retrieved parameters to a tracking process.

5. A method for controlling a state machine, comprising:
generating a memory address that corresponds to a current state of the state machine; and
retrieving the data content of the memory address to determine a next state of the state machine.
